(19) United States
(12) Patent Application Publication
(10) Pub. No.: US 2003/0143500 A1
(43) Pub. Date: Jul. 31, 2003

(54) Heat-developable photosensitive material

(75) Inventors: Takayoshi Oyamada, Kanagawa (JP); Kouta Fukui, Kanagawa (JP); Toyohisa Oya, Kanagawa (JP); Eiichi Okutsu, Kanagawa (JP); Yasuhiro Yoshioka, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/180,069

(22) Filed: Jun. 27, 2002

(30) Foreign Application Priority Data
Jun. 28, 2001 (JP) P.2001-196813
Jul. 26, 2001 (JP) P.2001-226071
Sep. 21, 2001 (JP) P.2001-288411

(51) Int. Cl. G03C 1/498

(52) U.S. Cl. 430/620; 430/350; 430/944

(57) ABSTRACT

A heat-developable photosensitive material comprises: a support; a light-sensitive silver halide; a reducing agent for a silver ion; a binder; and a light-insensitive organic silver salt grain, wherein the light-insensitive organic silver salt grain contains a silver behenate in an specific amount.

### FIELD OF THE INVENTION

The present invention relates to a heat-developable photosensitive material, and particularly to a heat-developable photosensitive material suitable for medical diagnosis, industrial photograph, printing and COM and an image formation method using the same. More particularly, the invention relates to an infrared-sensitized heat-developable photosensitive material suitably utilized for medical diagnosis and aphotomechanical process, and an image formation method using the same.

### BACKGROUND OF THE INVENTION

Recently, in the field of medical diagnosis films or photomechanical films, the reduction in weight of the processing waste solution is strongly demanded from the standpoint of environmental conservation or space saving. To satisfy this, the technology relating to heat-developable photosensitive materials is demanded to provide medical diagnosis films or photomechanical films which can be effectively exposed by means of a laser image setter or a laser imager and which can form a clear black image having high resolution and sharpness. These heat-developable photosensitive materials can offer to customers a simpler heat development processing system not requiring solution-type chemical agents and causing no impairment of the environment.

Although the same is required also in the field of general image-forming materials, fine depiction is required particularly for images for medical diagnosis, and therefore, high image quality with excellent sharpness and graininess is needed. Moreover, in view of diagnostic convenience, an image of cold black tone is preferred. At present, various hard copy systems using pigments or dyes are commercially available as general image-forming systems, such as ink jet printer and electrophotography. However, there is no satisfactory output system for the medical-use image.

On the other hand, thermographic systems using organic silver salts are described, for example, in U.S. Pat. Nos. 3,152,904 and 3,457,075, Kosterboer, Thermally Processed Silver Systems, and J. Sturge, V. Walworth and A. Shepp (compilers), Imaging Processes and Materials, 8th ed., Chap. 9, page 279, Neblette (1989). Inparticular, aheat-developable photosensitive material generally has a photosensitive layer comprising a binder matrix having dispersed therein a catalytic amount of a photocatalyst (for example, a silver halide), a reducing agent, a reducible silver salt (for example, an organic silver salt) and a color toning agent for controlling the color tone of silver as needed.

The heat-developable photosensitive material after image exposure is heated at a high temperature (for example, 80° C. or more) to bring about the oxidation-reduction reaction between the reducible silver salt (acting as an oxidizing agent) and the reducing agent and thereby form a black silver image. The oxidation-reduction reaction is accelerated by the catalytic action of a silver halide latent image produced by the exposure. The black silver image is therefore formed in the exposed area. This is disclosed in many publications including U.S. Pat. No. 2,910,377 and Japanese Patent Publication No. 4924/1968.

In the heat-developable photosensitive material, it is preferred that the oxidation-reduction reaction between the reducible silver salt and the reducing agent proceeds at practical reaction temperature and time to obtain sufficient image density. In the present circumstances, therefore, the further development of a heat-developable photosensitive material high in sensitivity, high in development activity, rapidly reactable and low in fog has been desired.

In the heat-developable photosensitive material using an organic silver salt, a silver image may come out under light/heat even after a silver image is thermally formed, because the organic silver salt is not fixed. Of course, such a phenomenon does not occur in the normal use range, but when the processed film is stored under very severe conditions for the heat-developable photosensitive material, for example, when the film is placed in a car in summer season for the purpose of transportation, there may arise a trouble such as discoloration throughout the film or transfer of letters of the bag in which the film is stored, onto the film, that is to say, there is the problem of occurrence of fog.

In the thermographic systems using organic silver salts, which have been used as the output systems for the medical-use images with the recent trend of technical innovation and digitalization, laser beams are used as exposure light sources. As for the kind of laser beam, an infrared-wavelength semiconductor laser is generally used, because the laser power is obtained at low cost.

In the images for medical diagnosis, a pure black color tone has been desired. However, the thermographic systems using organic silver salts are difficult to provide the pure black color tone. Accordingly, the color tone is controlled by the above-mentioned color toning agents. However, the color tone control is insufficient, so that improvement thereof has been desired.

Furthermore, in the above-mentioned infrared-sensitized heat-developable photosensitive materials, heteroaromatic mercapto compounds or heteroaromatic disulfide compounds are used as supersensitizers for increasing sensitivity. However, these mercapto and disulfide compounds have the problem that although the sensitivity increases with an increase in an amount thereof added, the color tone of images is changed to cause difficulty in obtaining the pure black color tone. Accordingly, improvement thereof has been desired.

In the above-mentioned heat-developable photosensitive material, it is preferred that the oxidation-reduction reaction between the reducible silver salt and the reducing agent proceeds at practical reaction temperature and time to obtain sufficient image density. In the present circumstances, therefore, the further development of a heat-developable photosensitive material high in sensitivity, high in development activity, rapidly reactable and low in fog has been desired.

In the heat-developable photosensitive material using an organic silver salt, a silver image may come out under light/heat even after a silver image is thermally formed, because the organic silver salt is not fixed. Of course, such a phenomenon does not occur in the normal use range, but when the processed film is stored under very severe conditions for the heat-developable photosensitive material, for example, when the film is placed in a car in summer season for the purpose of transportation, there may arise a trouble such as discoloration throughout the film or transfer of letters of the bag in which the film is stored, onto the film, that is to say, there is the problem of occurrence of fog.

### SUMMARY OF THE INVENTION

In view of the above-mentioned various problems, a first object of the present invention is to provide a heat-developable photosensitive material having high sensitivity and low fog, and also excellent in keeping quality of images obtained.

A second object of the invention is to provide a heat-developable photosensitive material high in sensitivity, excellent in development processing stability and excellent in photo image keeping quality

A third object of the invention is to provide a heat-developable photosensitive material giving an image good in image keeping quality and good in the color tone (approaching a pure black tone), even when it is subjected to infrared sensitization.

Another object of the invention is to provide an image formation method using the same.

The above mentioned objects is attained by the following heat-developable photosensitive materials.

(1) A heat-developable photosensitive material (a first embodiment) comprising:

a support;

a light-sensitive silver halide;

a reducing agent for a silver ion;

a binder; and

a light-insensitive organic silver salt grain,

wherein the light-insensitive organic silver salt grain contains a silver behenate in an amount of 53 mol % to 85 mol %, and the reducing agent is a compound represented by the following general formula (R):

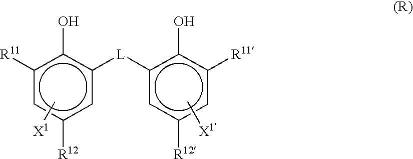

wherein R¹¹ and R¹¹′ each independently represents an alkyl group having from 1 to 20 carbon atoms; R¹² and R¹²′ each independently represents a hydrogen atom or a substituent group that can substitute on a benzene ring; L represents an —S— group or a —CHR¹³— group; R¹³ represents a hydrogen atom or an alkyl group having from 1 to 20 carbon atoms; and X¹ and X¹′ each independently represents a hydrogen atom or a group that can substitute on a benzene ring.

(2) The heat-developable photosensitive material according to the item (1), wherein in the general formula (R), R¹¹ and R¹¹′ are each independently a secondary or tertiary alkyl group having from 3 to 8 carbon atoms, R¹² and R¹²′ are each independently a an alkyl group, L is a —CHR¹³— group, R¹³ is a hydrogen atom or an alkyl group having from 1 to 12 carbon atoms, and X¹ and X¹′ are each a hydrogen atom.

(3) The heat-developable photosensitive material according to the item (1), wherein in the general formula (R), R¹¹, R¹¹′, R¹² and R¹²′ are each a methyl group, L is a —CHR¹³— group group, R¹³ is a secondary alkyl group having from 3 to 12 carbon atoms, and X¹ and X¹′ are each a hydrogen atom.

(4) The heat-developable photosensitive material according to the item (1), wherein the light-insensitive organic silver salt grain contains a silver behenate in an amount of 55 mol % to 75 mol %.

(5) The heat-developable photosensitive material according to the item (1), wherein the light-insensitive organic silver salt grain includes a light-insensitive organic silver salt grain prepared by drying in an atmosphere of an oxygen partial pressure of 15 vol % or less.

(6) The heat-developable photosensitive material according to the item (1), wherein the binder includes a polyvinyl butyral in an amount of from 50% to 100% by weight.

(7) A method for developing a heat-developable photosensitive material, comprising developing the heat-developable photosensitive material according to the item (1) with a heat drum type developing apparatus.

(8) A method for preparing an organic silver salt, comprising preparing the light-insensitive organic silver salt grain according to the item (1) by drying in an atmosphere of an oxygen partial pressure of 15 vol % or less.

(9) A heat-developable photosensitive material (a second embodiment) comprising:

a support;

a light-sensitive silver halide;

a reducing agent for a silver ion;

a binder;

a light-insensitive organic silver salt grain; and

a development accelerator,

wherein the light-insensitive organic silver salt grain contains a silver behenate in an amount of 40 mol % to 90 mol %.

(10) The heat-developable photosensitive material according to the item (9), wherein the development accelerator includes at least one of compounds represented by the following general formulae (1), (2), (3) and (4):

Q¹—NHNH—R¹ General Formula (1)

wherein Q¹ represents a 5-, 6- or 7-membered unsaturated ring combining with NHNH—R¹; and R¹ represents a carbamoyl group, an acyl group, an alkoxycarbonyl group, an aryloxycarbonyl group, a sulfonyl group or a sulfamoyl group,

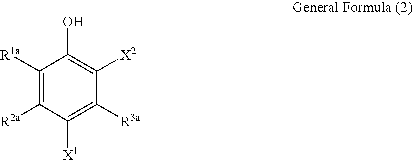

wherein R^{1a}, R^{2a}, R^{3a}, X¹ and X² each independently represents a hydrogen atom, a halogen atom or a substituent group linked by a carbon atom, an oxygen atom, a nitrogen atom, a sulfur atom or a phosphorus atom to the benzene ring, at least one of X¹ and X² is a group represented by —NR⁴R⁵, R⁴ and R⁵ are each independently a hydrogen atom, analkyl group, analkenyl group, an alkynyl group, an aryl group, a heterocyclic group or a group represented by —C(═O)—R, —C(═O)—C(═O)—R, —SO₂—R, —SO—R, —P(═O)(R)₂ or —C(═NR′)—R, R and R′ are each independently a group selected from the group consisting of a hydrogen atom, an alkyl group, an aryl group, a heterocyclic group, an amino group, an alkoxyl group and an aryloxy group, and these substituent groups may each combine with an adjacent group to form a ring,

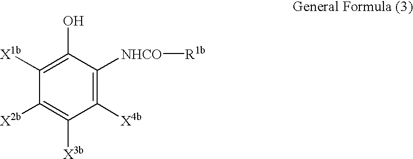

wherein X^{1b} represents a substituent group, and X^{2b} to X^{4b} each independently represents a hydrogen atom or a substituent group, X^{1b} to X^{4b} do not represent a hydroxyl group, and X^{3b} does not represent a sulfonamido group, the substituent groups represented by X^{1b} to X^{4b} may combine with each other to form a ring, R^{1b} represents a hydrogen atom, an alkyl group, an aryl group, a heterocyclic group, an amino group or an alkoxyl group,

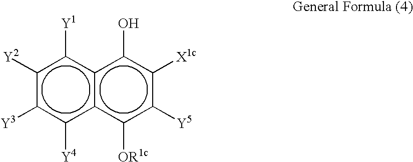

wherein R^{1c} represents an alkyl group, an aryl group, an alkenyl group or an alkynyl group, and X^{1c} represents an alkoxycarbonyl group, a carbamoyl group, a sulfonyl group or a sulfamoyl group, Y¹ to Y⁵ each independently represents a hydrogen atom or a substituent group.

(11) The heat-developable photosensitive material according to the item (9), wherein the binder includes a polyvinyl butyral in an amount of from 50% to 100% by weight.

(12) The heat-developable photosensitive material according to the item (9), wherein the binder has the Tg of from 40° C. to 90 ° C.

(13) A heat-developable photosensitive material (a second embodiment)comprising:

a support;

a light-sensitive silver halide;

a light-insensitive organic silver salt grain;

a reducing agent for a silver ion; and

a binder,

wherein the light-insensitive organic silver salt grain contains a silver behenate in an amount of 53 mol % to 80 mol %, the reducing agent contains at least one polyphenol compound represented by the following general formula (R), and the light-sensitive silver halide is subjected to an infrared sensitization:

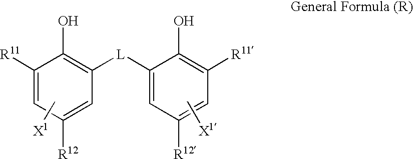

wherein R¹¹ and R¹¹′ each independently represents an alkyl group having from 1 to 20 carbon atoms; R¹² and R¹²′ each independently represents a hydrogen atom or a substituent group that can substitute on a benzene ring; L represents an —S— group or a —CHR¹³— group; R¹³ represents a hydrogen atom or an alkyl group having from 1 to 20 carbon atoms; and X¹ and X¹′ each independently represents a hydrogen atom or a group that can substitute on a benzene ring.

(14) The heat-developable photosensitive material according to the item (13), wherein in the general formula (R), R¹¹ and R¹¹′ are each independently a secondary or tertiary alkyl group having from 3 to 8 carbon atoms, R¹² and R¹²′ are each independently a an alkyl group, L is a —CHR¹³— group, R¹³ is a hydrogen atom or an alkyl group having from 1 to 12 carbon atoms, and X¹ and X¹′ are each a hydrogen atom.

(15) The heat-developable photosensitive material according to the item (13), wherein in the general formula (R), R¹¹, R¹¹′, R¹² and R¹²′ are each a methyl group, L is a —CHR¹³— group, R¹³ is a secondary alkyl group having from 3 to 12 carbon atoms, and X¹ and X¹′ are each a hydrogen atom.

(16) The heat-developable photosensitive material according to the item (13), which comprises at least one hindered phenol compound represented by the following general formula (2) on the side containing the light-sensitive silver halide on the support, wherein the added amount ratio of the compound represented by general formula (2) to the compound represented by general formula (R): the compound represented by general formula (2) (mol)/the compound represented by general formula (R) (mol) is from 0.001 to 0.2.

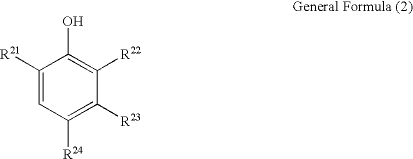

wherein R²¹ and R²² each independently represents a hydrogen atom, an alkyl group or an acylamino group, R²¹ and R²² each do not represent a 2-hydroxyphenylmethyl group, and do not represent a hydrogen atom at the same time, R²³ represents a hydrogen atom or an alkyl group, and R²⁴ represents a substituent group that can substitute on a benzene ring.

(17) The heat-developable photosensitive material according to the item (13), wherein the light-insensitive organic silver salt grain contains a silver behenate in an amount of 55 mol % to 75 mol %.

(18) The heat-developable photosensitive material according to the item (13), wherein the light-insensitive organic silver salt grain is a light-insensitive organic silver salt grain prepared by drying in an atmosphere of an oxygen partial pressure of 15 vol % or less.

(19) The heat-developable photosensitive material according to the item (13), which comprises a light-sensitive layer containing the light-sensitive silver halide, the light-insensitive organic silver salt grain, the reducing agent for a silver ion and the binder.

(20) The heat-developable photosensitive material according to the item (19), wherein the light-sensitive layer contains a polyvinyl butyral in an amount of 50% to 100% by weight based on the total content of the binder in the light-sensitive layer.

(21) The heat-developable photosensitive material according to the item (13), which comprises at least one compound selected from the group consisting of a heteroaromatic mercapto compound and a heteroaromatic disulfide compound on the side containing the light-sensitive silver halide on the support.

(22) An image formation method comprising: exposing the heat-developable photosensitive material according to the item (13) to a laser beam having an exposure wavelength of 750 nm to 1400 nm; and heat-developing the exposed material.

(23) The image formation method according to the item (22), wherein the heat development is conducted with a heat drum.

### DETAILED DESCRIPTION OF THE INVENTION

Methods for carrying out the invention and embodiments will be described in detail below.

The development accelerator in the heat-developable photosensitive material of the second embodiment of the invention is a compound in which an exposure necessary for giving a density of 1.0 when it is added in an amount of 10% by molar ratio based on a main reducing agent is 90% or less of that when it is not added.

The development accelerator is a compound in which an exposure necessary for giving a density of 1.0 when it is added preferably in an amount of 5%, and more preferably in an amount of 2%, by molar ratio based on a main reducing agent is 90% or less of that when it is not added.

Any compound can be used as the development accelerator as long as it is a compound which can accelerate development. A so-called reducing agent can be used.

Specific examples of the compounds include compounds such as p-aminophenol compounds, p-phenylenediamine compounds, sulfonamidophenol compounds, phenidone compounds, ascorbic acid, hydrazine compounds, phenol compounds and naphthol compounds. The sulfonamidophenol compounds (for example, compounds represented by general formula (1) described in Japanese Patent Laid-Open No. 221806/1998, and compounds represented by general formula (A) described in Japanese Patent Laid-Open No. 267222/2000) and the hydrazine compounds are preferred among others.

In the invention, the compounds represented by the above-mentioned general formula (1), (2), (3) or (4) are particularly preferred.

The development accelerator of general formula (1) has the following structure:

Q¹—NHNH—R¹ General Formula (1)

General formula (1) will be described in detail.

The reductive compound represented by general formula (1) is the development accelerator generically named a hydrazine developing agent. In the formula, Q¹ represents a 5-, 6- or 7-membered unsaturated ring combining with NHNH—R¹; and R¹ represents a carbamoyl group, an acyl group, an alkoxycarbonyl group, an aryl group, an oxycarbonyl group, a sulfonyl group or a sulfamoyl group.

Preferred examples of the 5- to 7-membered unsaturated rings represented by Q¹ include a benzene ring, a pydine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, atetrazole ring, al,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring and a thiophene ring. A condensed ring in which these rings are condensed with each other is also preferred.

These rings may have substituent groups. When the ring has two or more substituent groups, these substituent groups may be the same or different.

Examples of the substituent groups include a halogen atom, an alkyl group, an aryl group, a carbonamido group, an alkylsulfonamido group, an arylsulfonamido group, an alkoxyl group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group.

When these substituent groups are substitutable groups, they may further have substituent groups. Preferred examples of the substituent groups include a halogen atom, an alkyl group, an aryl group, a carbonamido group, an alkylsulfonamido group, an arylsulfonamido group, an alkoxyl group, an aryloxy group, an alkylthio group, an arylthio group, an acyl group, an alkoxycarbonyl group, an aryloxycarbonyl group, a carbamoyl group, a cyano group, a sulfamoyl group, analkylsulfonyl group, an arylsulfonyl group and an acyloxy group.

The carbamoyl group represented by R¹ has preferably from 1 to 50 carbon atoms, and more preferably from 6 to 40 carbon atoms. Specific examples thereof include an unsubstituted carbamoyl group, a methylcarbamoyl group, an N-ethylcarbamoyl group, an N-propylcarbamoyl group, an N-sec-butylcarbamoyl group, an N-octylcarbamoyl group, an N-cyclohexylcarbamoyl group, an N-tert-butylcarbamoyl group, an N-dodecylcarbamoyl group, an N-(3-dodecyloxypropyl)carbamoyl group, an N-octadecylcarbamoyl group, an N-{3-(2,4-tert-pentyl-phenoxy)propyl}carbamoyl group, an N-(2-hexyldecyl) carbamoyl group, an N-phenylcarbamoyl group, an N-(4-dodecyloxy-phenyl)carbamoyl group, an N-(2-chloro-5-dodecyloxycarbonyl-phenyl)carbamoyl group, an N-naphthylcarbamoyl group, an N-3-pyridylcarbamoyl group and an N-benzylcarbamoyl group.

The acyl group represented by R¹ has preferably from 1 to 50 carbon atoms, and more preferably from 6 to 40 carbon atoms. Specific examples thereof include a formyl group, an acetyl group, a 2-methylpropanoyl group, a cyclohexylcarbonyl group, anoctanoylgroup, a 2-hexyldecanoyl group, adodecanoyl, a chloroacetyl group, a trifluoroacetyl group, a benzoyl group, a 4-dodecyloxybenzoyl group and a 2-hydroxymethylbenzoyl group.

The alkoxycarbonyl group represented by R¹ has preferably from 2 to 50 carbon atoms, and more preferably from 6 to 40 carbon atoms. Specific examples thereof include a methoxycarbonyl group, an ethoxycarbonyl group, an isobutyloxycarbonyl group, a cyclohexyloxycarbonyl group, a dodecyloxycarbonyl group and a benzyloxycarbonyl group.

The aryloxycarbonyl group represented by R¹ has preferably from 7 to 50 carbon atoms, and more preferably from 7 to 40 carbon atoms. Specific examples thereof include a phenoxycarbonyl group, a 4-octyloxyphenoxycarbonyl group, a 2-hydroxymethylphenoxycarbonyl group and a 4-dodecyloxy-phenoxycarbonyl group.

The sulfonyl group represented by R¹ has preferably from 1 to 50 carbon atoms, and more preferably from 6 to 40 carbon atoms. Specific examples thereof include a methylsulfonyl group, a butylsulfonyl group, an octylsulfonyl group, a 2-hexa-decylsulfonyl group, a 3-dodecyloxypropylsulfonyl group, a 2-octyloxy-5-tert-octylphenylsulfonyl group and a 4-dodecyl-oxyphenylsulfonyl group.

The sulfamoyl group represented by R¹ has preferably from 0 to 50 carbon atoms, and more preferably from 6 to 40 carbon atoms. Specific examples thereof include an unsubstituted sulfamoyl group, an N-ethylsulfamoyl group, an N-(2-ethyl-hexyl)sulfamoyl group, an N-decylsulfamoyl group, an N-hexa-decylsulfamoyl group, an N-{3-(2-ethylhexyloxy)propyl}-sulfamoyl group, an N-(2-chloro-5-dodecyloxycarbonylphenyl) -sulfamoyl group and an N-(2-tetradecyloxyphenyl)sulfamoyl group.

The groups represented by R¹ may have the groups mentioned as the examples of the substituent groups for the 5-to 7-membered unsaturated rings represented by Q¹ at substitutable positions thereof. When the group has two or more substituent groups, these substituent groups may be the same or different. of the compounds represented by general formula (1), Q¹ is preferably a 5- or 6-membered unsaturated ring, and more preferably abenzene ring, a pyrimidine group, a 1,2,3-triazole ring, a 1,2,4-triazole ring, a tetrazole ring, a 1,3,4-thiadiazole ring a 1,2,4-thiadiazole ring, a 1,3,4-oxadiazole ring, a 1,2,4-oxadiazole ring, athiazole ring, anoxazole ring, an isothiazole ring, an isoxazole ring or a ring in which these rings are each condensed with a benzene ring or a unsaturated heterocycle. It is particularly preferred that Q¹ is a quinazoline ring.

Further, it is preferred that Q¹ has at least one electron attractive substituent group. Preferred examples of the substituent groups include a fluoroalkyl group (for example, trifluoromethyl, pentafluoroethyl, 1,1-difluoroethyl, difluoromethyl, fluoromethyl, heptafluoropropyl or pentafulorophenyl), acyano group, ahalogen atom (fluorine, chlorine, bromine or iodine), an acyl group, an alkoxycarbonyl group, a carbamoyl group, an alkylsulfonyl group, an aryl group and a sulfonyl group. Trifluoromethyl is particularly preferred.

R¹ is preferably a carbamoyl group, and it is particularly preferred that R¹ is a substituted carbamoyl group represented by —CO—NH—R¹, wherein R¹ represents an alkyl group having from 1 to 10 carbon atoms or an aryl group.

Specific examples of the reductive compounds represented by general formula (1) are shown below, but the compounds used in the invention are not limited by these specific examples.

| | |
|---|---|
| 1-1 | 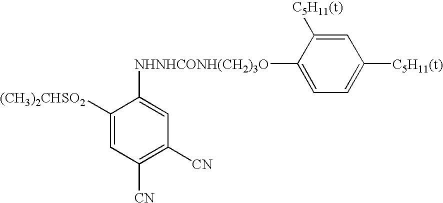 |
| 1-2 | 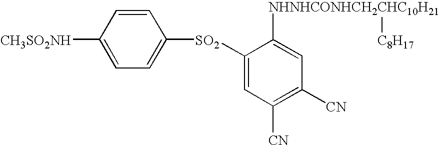 |
| 1-3 | 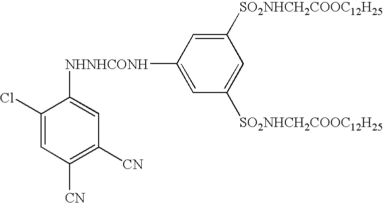 |
| 1-4 | 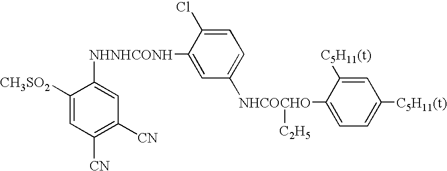 |
| 1-5 | 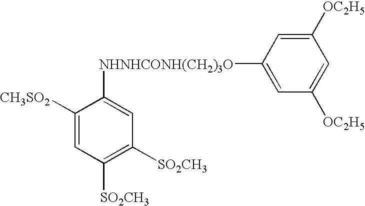 |
| 1-6 | 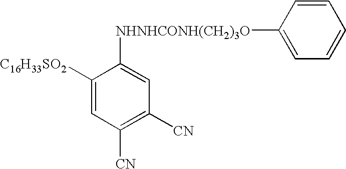 |
| 1-7 | 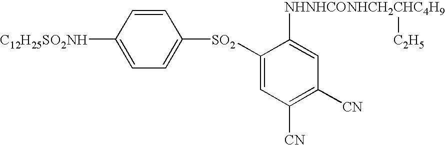 |
| 1-8 | 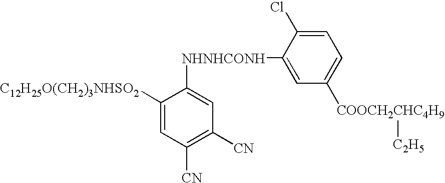 |
| 1-9 | 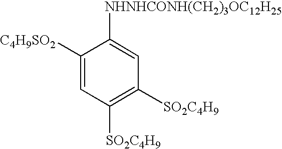 |
| 1-10 | 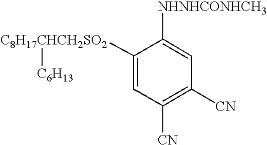 |
| 1-11 | 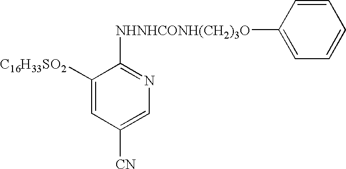 |
| 1-12 | 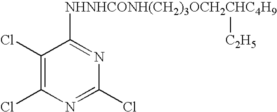 |
| 1-13 | 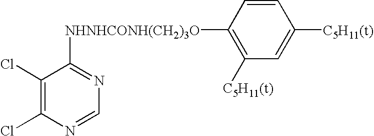 |
| 1-14 | 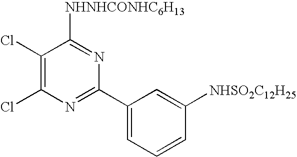 |
| 1-15 | 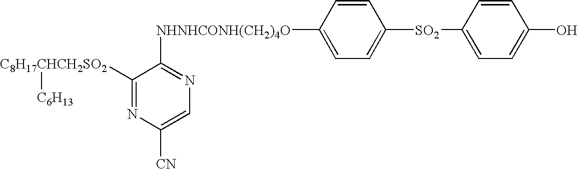 |
| 1-16 | 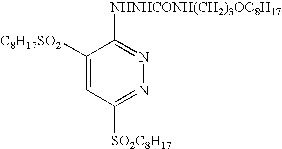 |
| 1-17 | 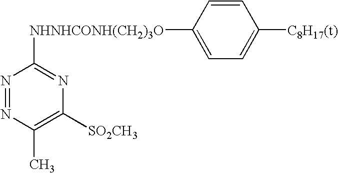 |
| 1-18 | 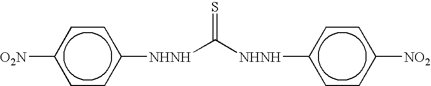 |
| 1-19 | 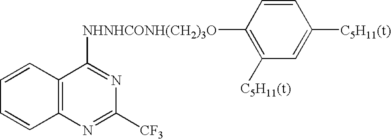 |
| 1-20 | 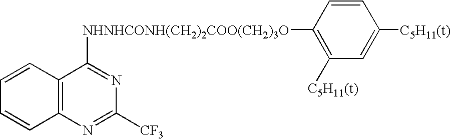 |
| 1-21 | 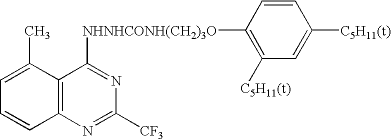 |
| 1-22 | 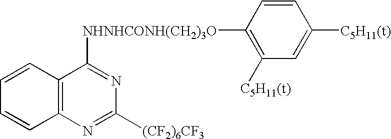 |
| 1-23 | 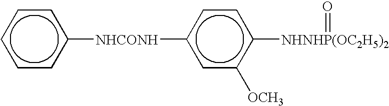 |
| 1-24 | 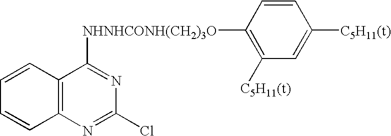 |
| 1-25 | 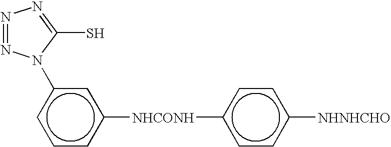 |
| 1-26 | 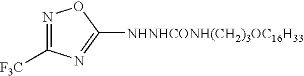 |
| 1-27 | 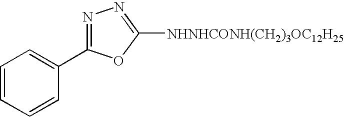 |
| 1-28 | 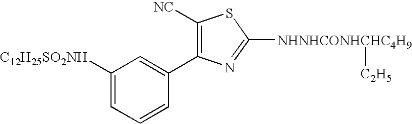 |
| 1-29 | 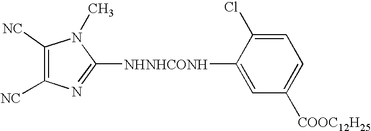 |
| 1-30 | 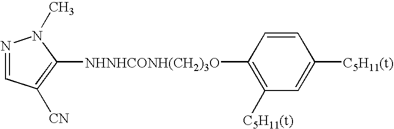 |
| 1-31 | 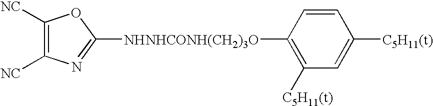 |
| 1-32 | 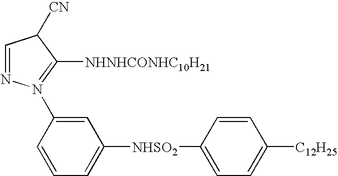 |
| 1-33 | 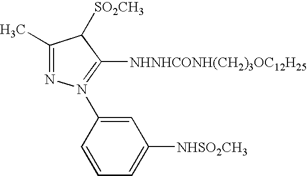 |
| 1-34 | 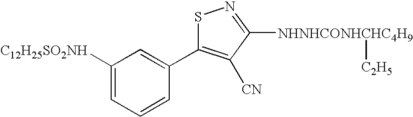 |
| 1-35 | 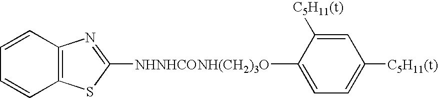 |
| 1-36 | 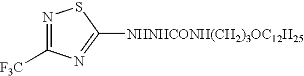 |
| 1-37 | 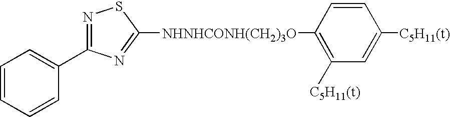 |
| 1-38 | 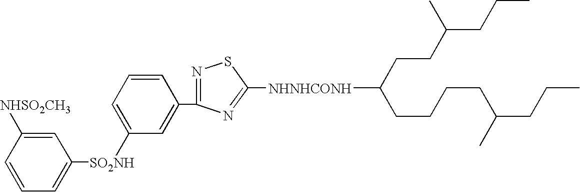 |
| 1-39 | 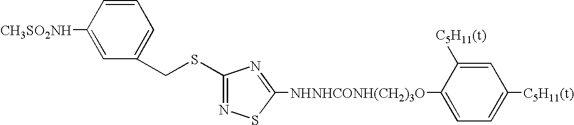 |
| 1-40 | 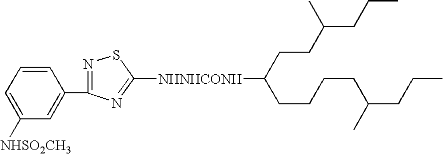 |
| 1-41 | 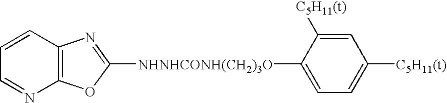 |
| 1-42 | 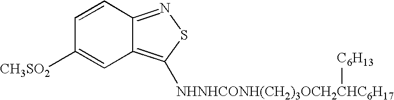 |
| 1-43 | 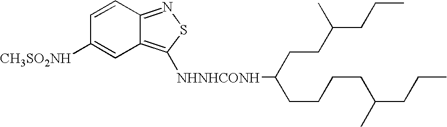 |
| 1-44 | 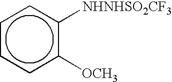 |
| 1-45 | 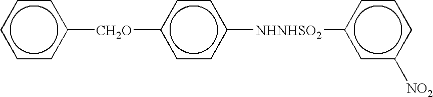 |
| 1-46 | 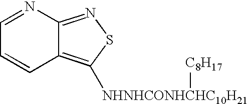 |
| 1-47 | 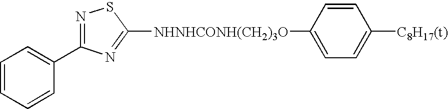 |
| 1-48 | 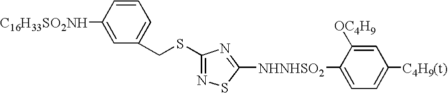 |
| 1-49 | 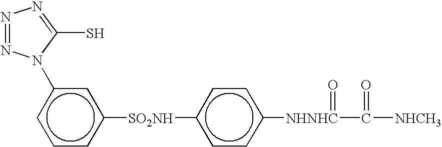 |
| 1-50 | 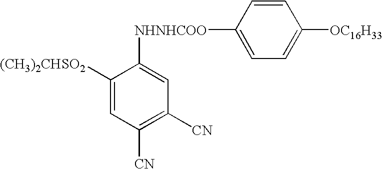 |
| 1-51 | 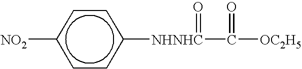 |
| 1-52 | 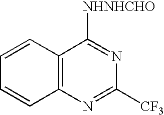 |
| 1-53 | 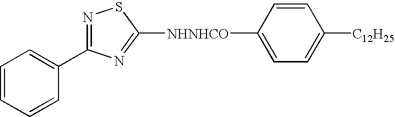 |
| 1-54 | 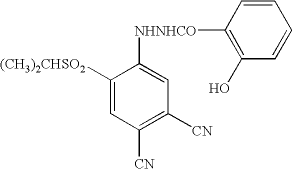 |

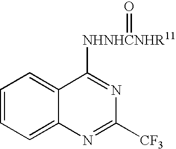

| Compound | R¹¹ |
|---|---|
| 1-55 | CH₃ |
| 1-56 | C₂H₅ |
| 1-57 | (n)C₃H₇ |
| 1-58 | (i)C₃H₇ |
| 1-59 | (n)C₄H₉ |
| 1-60 | (i)C₄H₉ |
| 1-61 | (sec)C₄H₉ |
| 1-62 | (t)C₄H₉ |
| 1-63 | (n)C₅H₁₁ |
| 1-64 | (t)C₅H₁₁ |
| 1-65 | (n)C₅H₁₃ |
| 1-66 | 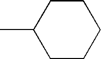 |
| 1-67 | (n)C₈H₁₇ |
| 1-68 | (t)C₈H₁₇ |
| 1-69 | 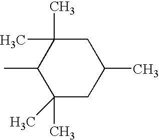 |
| 1-70 | 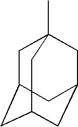 |
| 1-71 | 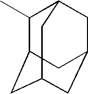 |
| 1-72 | 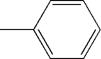 |
| 1-73 | 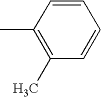 |
| 1-74 | 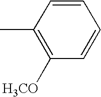 |
| 1-75 | 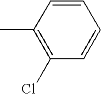 |
| 1-76 | 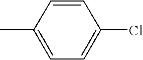 |
| 1-77 | 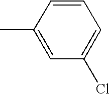 |
| 1-78 | 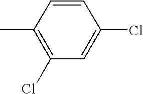 |
| 1-79 | 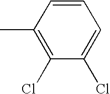 |
| 1-80 | 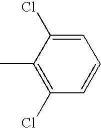 |
| 1-81 | 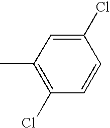 |
| 1-82 | 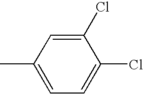 |
| 1-83 | 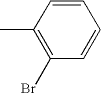 |
| 1-84 | 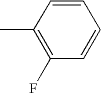 |
| 1-85 | 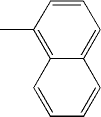 |
| 1-86 | 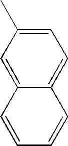 |
| 1-87 | 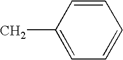 |
| 1-88 | 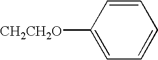 |
| 1-89 | CH₂CH₂OCH₂CH₃ |
| 1-90 | CH₂CH₂OCH₃ |

| | |
|---|---|
| 1-91 | 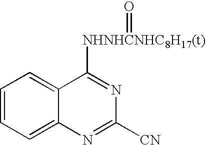 |
| 1-92 | 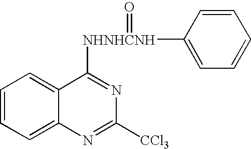 |
| 1-93 | 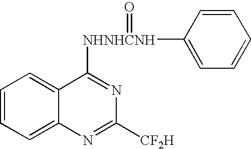 |
| 1-94 | 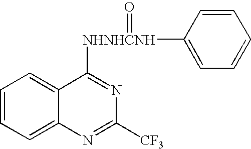 |
| D-95 | 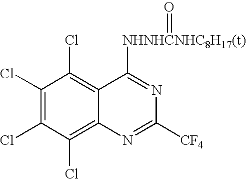 |
| D-96 | 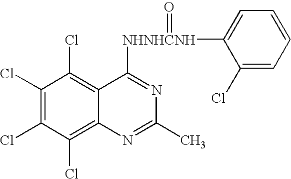 |
| 1-97 | 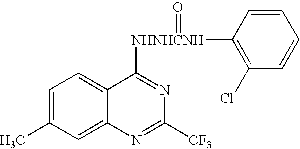 |
| 1-98 | 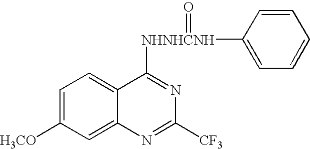 |
| 1-99 | 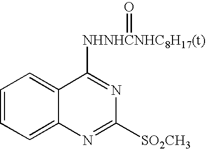 |
| 1-100 | 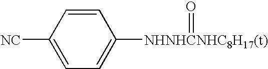 |
| 1-101 | 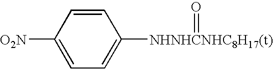 |
| 1-102 | 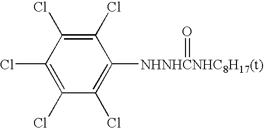 |
| 1-103 | 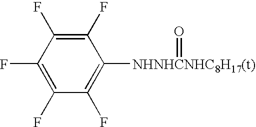 |
| 1-104 | 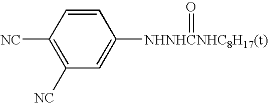 |
| 1-105 | 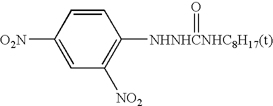 |
| 1-106 | 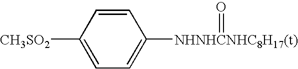 |

The reductive compounds represented by general formula (1) can be synthesized according to methods described in Japanese Patent Laid-Open Nos. 152702/1997, 286340/1996, 152700/1997, 152701/1997, 152703/1997 and 152704/1997.

Then, the development accelerator of general formula (2) has the following structure:

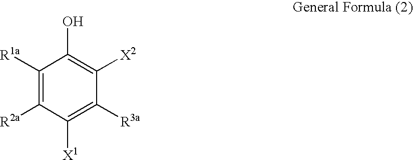

R^{1a}, R^{2a} and R^{3a} each independently represents a hydrogen atom, a halogen atom or a substituent group linked by a carbon atom, an oxygen atom, a nitrogen atom, a sulfur atom or a phosphorus atom to a benzene ring.

Unlimited specific examples of the substituent groups each linked by a carbon atom to a benzene ring include a straight chain, branched or cyclic alkyl group (for example, methyl, ethyl, isopropyl, tert-butyl, n-octyl, tert-amyl, 1,3-tetramethylbutyl orcyclohexyl), analkenyl group (for example, vinyl, allyl, 2-butenyl or 3-pentenyl), an alkynyl group (for example, propargyl or 3-pentynyl), an aryl group (for example, phenyl, p-methylphenylornaphthyl), an acyl group (for example, acetyl, benzoyl, formyl or pivaloyl), an alkoxycarbonyl group (for example, methoxycarbonyl or ethoxycarbonyl), an aryloxycarbonyl group (for example, phenoxycarbonyl), a carbamoyl group (for example, carbamoyl, diethylcarbamoyl or phenylcarbamoyl), a cyano group, a carboxyl group and a heterocyclic group (for example, 3-pyrazolyl).

Unlimited specific examples of the substituent groups each linked by an oxygen atom to a benzene ring include a hydroxyl group, an alkoxyl group (for example, methoxy, ethoxy or butoxy), an aryloxy group (for example, phenyloxy or 2-naphthyloxy), a heterocyclic oxy group (for example, 4-pyridyloxy) and an acyloxy group (for example, acetoxy or benzoyloxy).

Unlimited specific examples of the substituent groups each linked by a nitrogen atom to a benzene ring include an amino group (for example, amino, methylamino, dimethylamino, diethylamino or dibenzylamino), anitro group, a hydrazino group, a heterocyclic group (for example, 1-imidazolyl ormorpholyl), an acylamino group (for example, acetylamino or benzoylamino), an alkoxycarbonylamino group (for example, methoxycarbonylamino), an aryloxycarbonylamino group (for example, phenyloxycarbonylamino), a sulfonylamino group (for example, methanesulfonylamino or benzenesulfonylamino), a sulfamoyl group (for example, sulfamoyl, methylsulfamoyl, dimethylsulfamoyl or phenylsulfamoyl), a ureido group (for example, ureido, methylureido or phenylureido), a phosphorylamino group (for example, diethylphosphorylamino) and an imido group (for example, succinimido, phthalimido or trifluoromethanesulfonimido).

Unlimited specific examples of the substituent groups each linked by a sulfur atom to a benzene ring include a mercapto group, a disulfido group, a sulfo group, a sulfino group, a sulfonylthio group, a thiosulfonyl group, an alkylthio group (for example, methylthio or ethylthio), an arylthio group (for example, phenylthio), a sulfonyl group (for example, mesyl, tosyl or phenylsulfonyl), a sulfinyl group (for example, methanesulfinyl or benzenesulfinyl) and a heterocyclic thio group (for example, 2-imidazolylthio). Unlimited specific examples of the substituent groups each linked by a phosphorus atom to a benzene ring include a phosphate group (for example, diethyl phosphate or diphenyl phosphate).

R^{1a}, R^{2a} and R^{3a} are each preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, a heterocyclic group, a hydroxyl group, an alkoxyl group, an aryloxy group, a heterocyclic oxy group, an acyloxy group, an amino group, a nitro group, an acylamino group, an alkoxycarbonylamino group, an aryloxycarbonylamino group, a sulfonylamino group, an imido group, a sulfamoyl group, a carbamoyl group, a ureido group, a mercapto group, a disulfido group, a sulfo group, a sulfino group, an alkylthio group, an arylthio group, a sulfonyl group, a sulfinyl group or a heterocyclic thio group.

R^{1a}, R^{2a} and R^{3a} are each more preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, a heterocyclic group, a hydroxyl group, an alkoxyl group, an aryloxy group, an acyloxy group, an amino group, a nitro group, an acylamino group, an alkoxycarbonylamino group, an aryl-oxycarbonylamino group, a sulfonylamino group, an imido group, a carbamoyl group, a mercapto group, a sulfo group, an alkylthio group, an arylthio group or a sulfonyl group.

R^{1a}, R^{2a} and R^{3a} are each particularly preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, an aryloxy group, an acyloxy group, an acylamino group, an alkoxycarbonylamino group, an aryloxycarbonylamino group, a sulfonylamino group, a carbamoyl group, a sulfo group, an alkylsulfonyl group or an arylsulfonyl group.

X¹ and X² each independently represents a hydrogen atom, a halogen atom or a substituent group linked by a carbon atom, an oxygen atom, a nitrogen atom, a sulfur atom or a phosphorus atom to a benzene ring.

Unlimited specific examples of the substituent groups each linked by a carbon atom to a benzene ring include a straight chain, branched or cyclic alkyl group (for example, methyl, ethyl, isopropyl, tert-butyl, n-octyl, tert-amyl, 1,3-tetramethylbutyl or cyclohexyl), analkenyl group (for example, vinyl, allyl, 2-butenyl or 3-pentenyl), an alkynyl group (for example, propargyl or 3-pentynyl), an aryl group (for example, phenyl, p-methylphenylornaphthyl), an acyl group (for example, acetyl, benzoyl, formyl or pivaloyl), an alkoxycarbonyl group (for example, methoxycarbonyl or ethoxycarbonyl), an aryloxycarbonyl group (for example, phenoxycarbonyl), a cyano group, a carboxyl group, a heterocyclic group (for example, 3-pyrazolyl) and a carbamoyl group (for example, carbamoyl, diethylcarbamoyl or phenylcarbamoyl).

Unlimited specific examples of the substituent groups each linked by an oxygen atom to abenzene ring include ahydroxyl group, analkoxyl group (for example, methoxy, ethoxyorbutoxy), an aryloxy group (for example, phenyloxy or 2-naphthyloxy), a heterocyclic oxy group (for example, 4-pyridyloxy) and an acyloxy group (for example, acetoxy or benzoyloxy).

Unlimited specific examples of the substituent groups each linked by a nitrogen atom to a benzene ring include an amino group (for example, amino, methylamino, dimethylamino, diethylamino or dibenzylamino), a nitro group, a hydroxam group, a hydrazino group, a heterocyclic group (for example, 1-imidazolyl or morpholyl), an acylamino group (for example, acetylamino or benzoylamino), an alkoxycarbonylamino group (for example, methoxycarbonylamino), an aryloxycarbonylamino group (for example, phenyloxycarbonylamino), a sulfonylamino group (for example, methanesulfonylamino or benzenesulfonylamino), a sulfamoyl group (for example, sulfamoyl, methylsulfamoyl, dimethylsulfamoyl or phenylsulfamoyl) and a phosphorylamino group (for example, diethylphosphorylamino).

Unlimited specific examples of the substituent groups each linked by a sulfur atom to a benzene ring include a mercapto group, a disulfido group, a sulfo group, a sulfino group, a sulfonylthio group, a thiosulfonyl group, an alkylthio group (for example, methylthio or ethylthio), an arylthio group (for example, phenylthio), a sulfonyl group (for example, mesyl, tosyl or phenylsulfonyl), a sulfinyl group (for example, methanesulfinyl or benzenesulfinyl) and a heterocyclic thio group (for example, 2-imidazolylthio).

Unlimited specific examples of the substituent groups each linked by a phosphorus atom to a benzene ring include a phosphate group (for example, diethyl phosphate or diphenyl phosphate).

X¹ and X² are each preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, a heterocyclic group, a hydroxyl group, an alkoxyl group, an aryloxy group, a heterocyclic oxy group, an acyloxy group, an amino group, a nitro group, an acylamino group, an alkoxycarbonylamino group, an aryloxycarbonylamino group, a sulfonylamino group, an imido group, a sulfamoyl group, a carbamoyl group, a ureido group, a mercapto group, a disulfido group, a sulfo group, an alkylthio group, an arylthio group, a sulfonyl group or a heterocyclic thio group.

X¹ and X² are each more preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, a hydroxyl group, an alkoxyl group, an aryloxy group, an acyloxy group, an amino group, an acylamino group, an alkoxycarbonylamino group, an aryloxycarbonylamino group, a sulfonylamino group, an imido group, a carbamoyl group, a sulfo group or an arylsulfonyl group.

X¹ and X² are each particularly preferably a hydrogen atom, a halogen atom, a straight chain, branched or cyclic alkyl group, an aryl group, an acyl group, an alkoxycarbonyl group, an aryloxycarbonyl group, a cyano group, a carboxyl group, an alkoxyl group, an aryloxy group, an acyloxy group, an acylamino group, an alkoxycarbonylamino group, an aryloxycarbonylamino group, a sulfonylamino group, a carbamoyl group, a mercapto group or an alkylthio group.

At least one of X¹ and X² is a group represented by —NR⁴R⁵.

R⁴ and R⁵ are each independently a hydrogen atom, an alkyl group, an alkenyl group, an alkynyl group, an aryl group, a heterocyclic group or a group represented by —C(═O)—R, —C(═O)—C(═O)—R, —SO₂—R, —SO—R, —P(═O)(R)₂ or —C(═NR′)—R.

R and R′ are each independently a group selected from the group consisting of a hydrogen atom, an alkyl group, an aryl group, a heterocyclic group, an amino group, an alkoxyl group and an aryloxy group.

When R⁴ and R⁵ each represents a hydrogen atom, an alkyl group, an alkenyl group, an alkynyl group, an aryl group or a heterocyclic group, they each represents, for example, a straight chain, branched or cyclic alkyl group (for example, methyl, ethyl, isopropyl, tert-butyl, n-octyl, tert-amyl, 1,3-tetramethylbutyl or cyclohexyl), an alkenyl group (for example, vinyl, allyl, 2-butenyl or 3-pentenyl), an alkynyl group (for example, propargyl or 3-pentynyl), an aryl group (for example, phenyl, p-methylphenyl or naphthyl) or a heterocyclic group (for example, 2-imidazolyl or 1-pyrazolyl).

When R⁴ and R⁵ are each a group represented by —C(═O)—R, —C (═O)—C(═O)—R, —SO₂—R, —SO—R, —P(═O)(R)₂ or —C(═NR′)—R, R and R′ each independently represents an alkyl group (for example, methyl, ethyl, isopropyl, tert-butyl, n-octyl, tert-amyl, 1, 3-tetramethylbutyl or cyclohexyl), anaryl group (for example, phenyl, p-methylphenyl or naphthyl), a heterocyclic group (for example, 4-pyridyl, 2-thienyl or 1-methyl-2-pyrrolyl), an amino group (for example, amino, dimethylamino, diphenylamino, phenylamino or 2-pyridylamino), an alkoxyl group (for example, methoxy, ethoxy or cyclohexyloxy) or an aryloxy group (for example, phenoxy or 2-naphthoxy).

R⁴ and R⁵are each preferably a hydrogen atom, a straight chain, branched or cyclic alkyl group, an aryl group, an acyl group, an alkoxycarbonyl group, an aryloxycarbonyl group, a sulfamoyl group, a carbamoyl group, a sulfonyl group or a sulfinyl group.

R⁴ and R⁵ are each more preferably a hydrogen atom, a straight chain, branched or cyclic alkyl group, an aryl group, an acyl group or a sulfonyl group. As a particularly preferred combination of R⁴ and R⁵, one of them is a hydrogen atom, and the other is an alkylsulfonyl group or an arylsulfonyl group.

These substituent groups may further be substituted with substituent groups as described above. When these substituent groups have hydrogen atoms high in acidity, protons thereof may be dissociated to form salts. As counter ions thereof, there are used metal ions, ammonium ions and phosphonium ions. Such a state in which active hydrogen is dissociated can be an effective measure in the case that a problem arises with regard to volatility of compounds in development. R^{1a}, R^{2a}, R^{3a}, X¹ and X² may each combine with an adjacent group to form a ring.

Specific examples of the compounds represented by general formula (2) of the invention are shown below, but the compounds used in the invention are not limited to these.

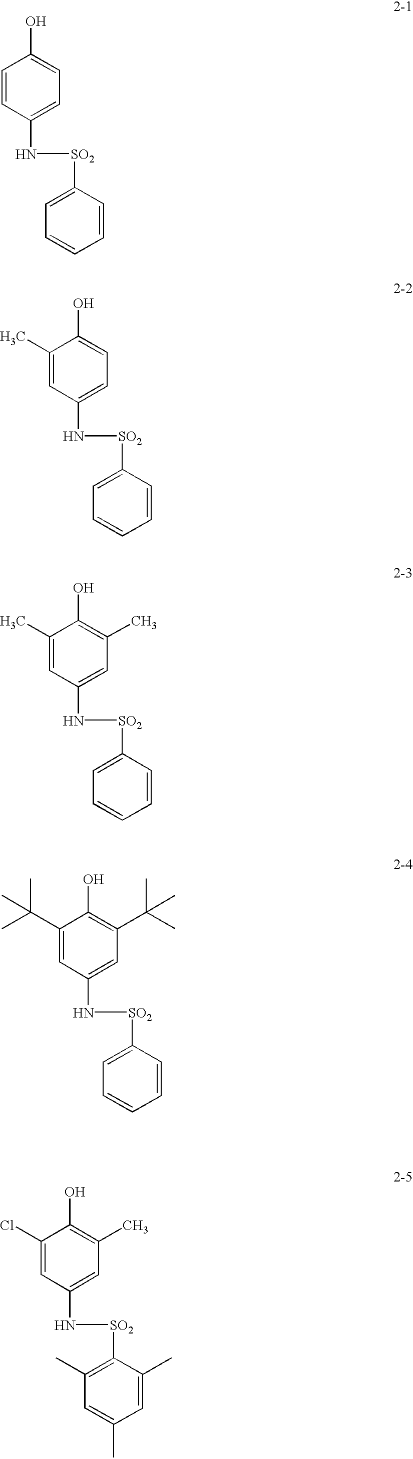

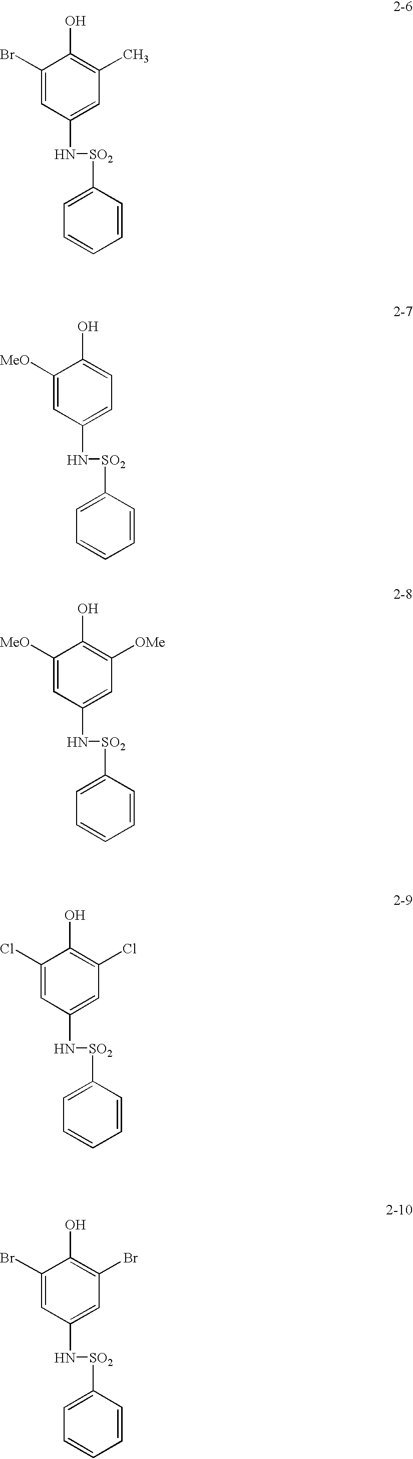

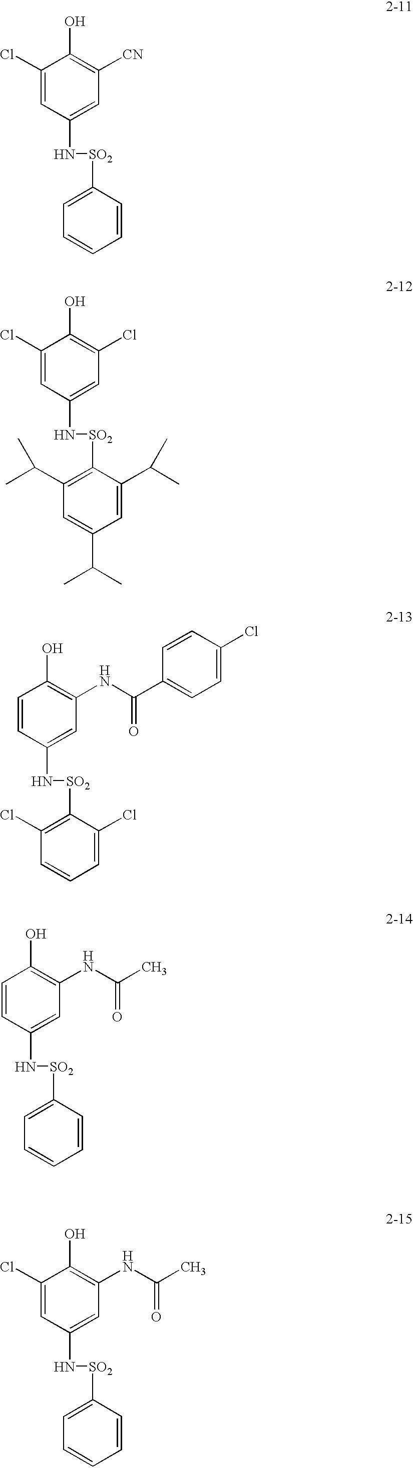

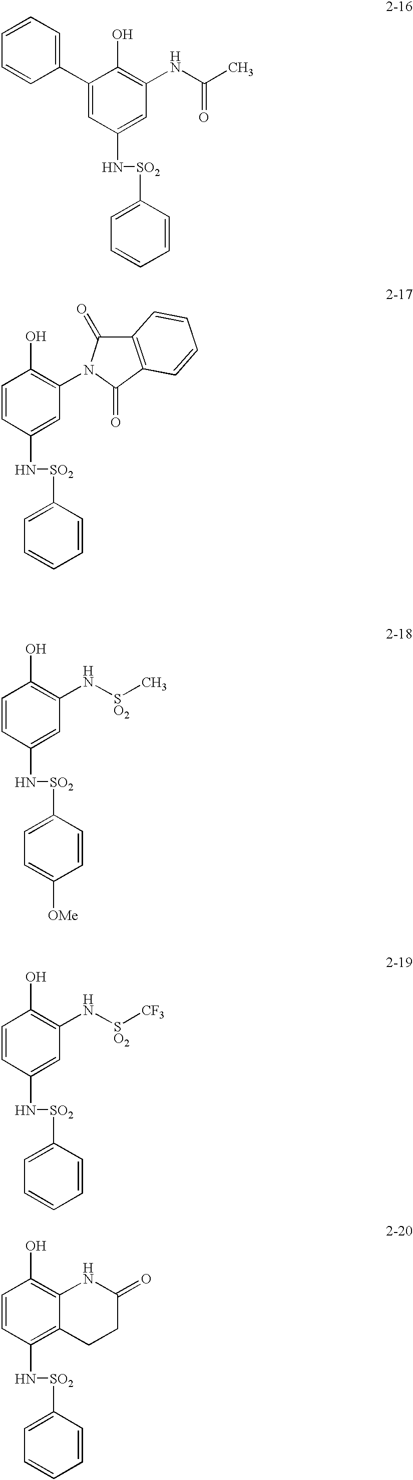

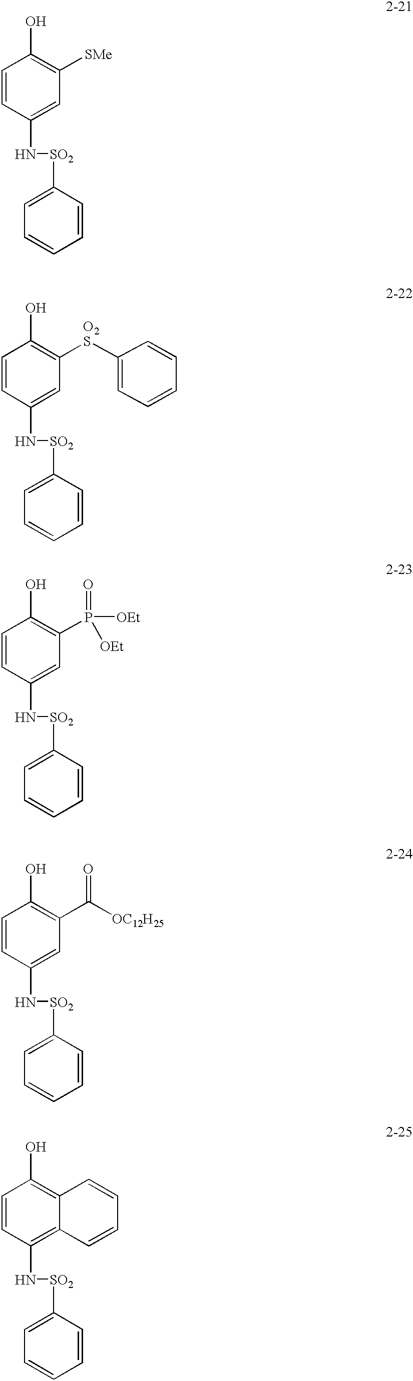

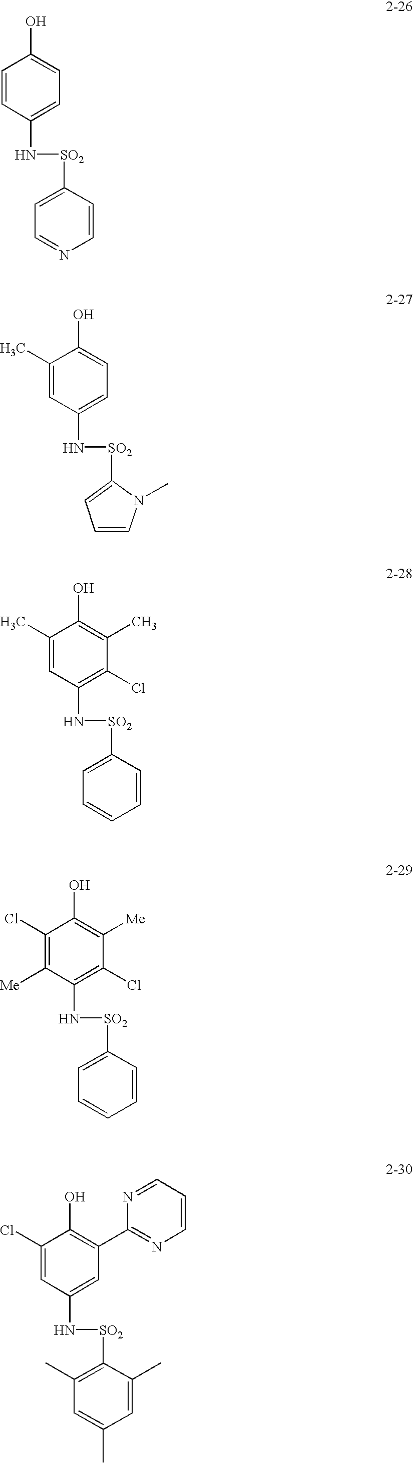

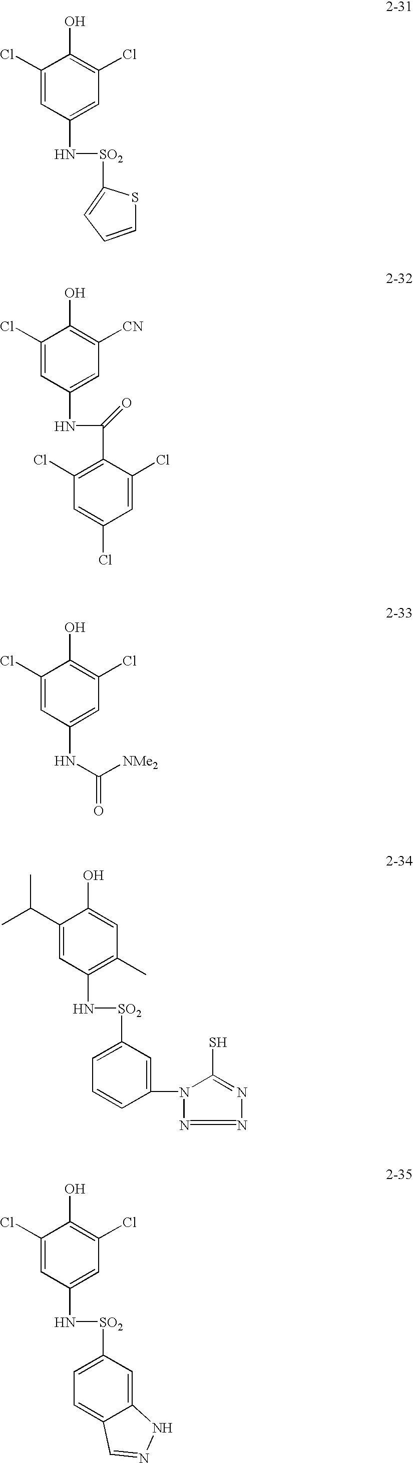

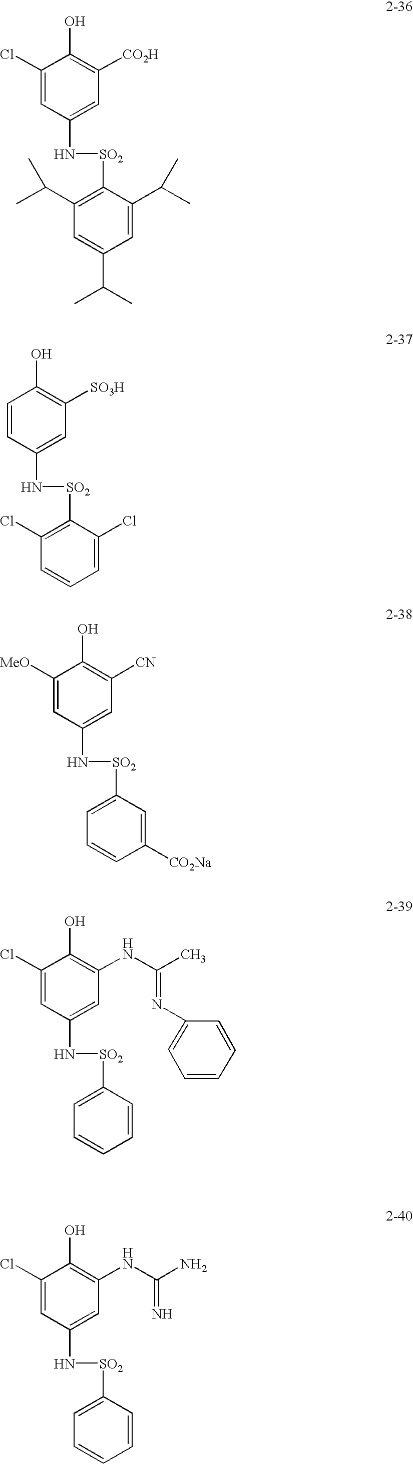

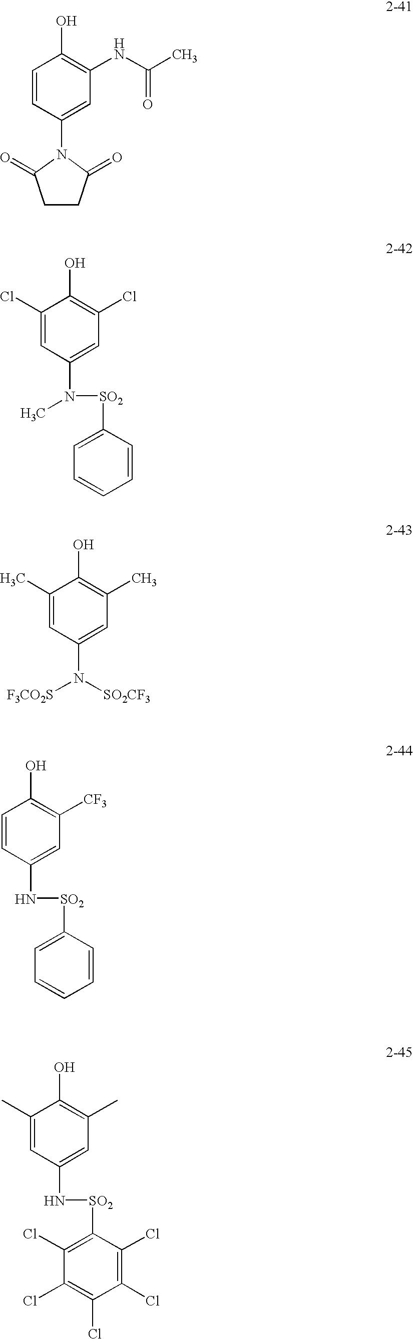

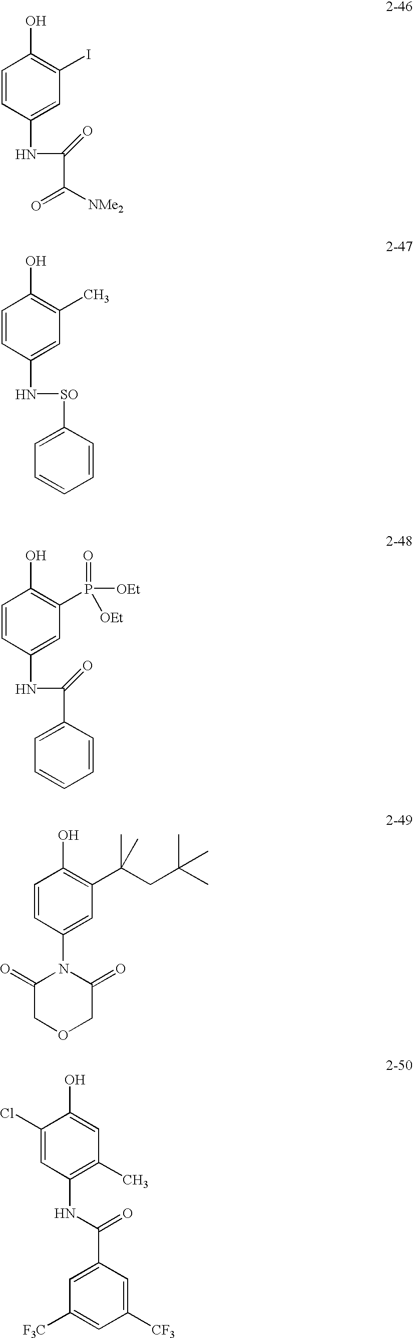

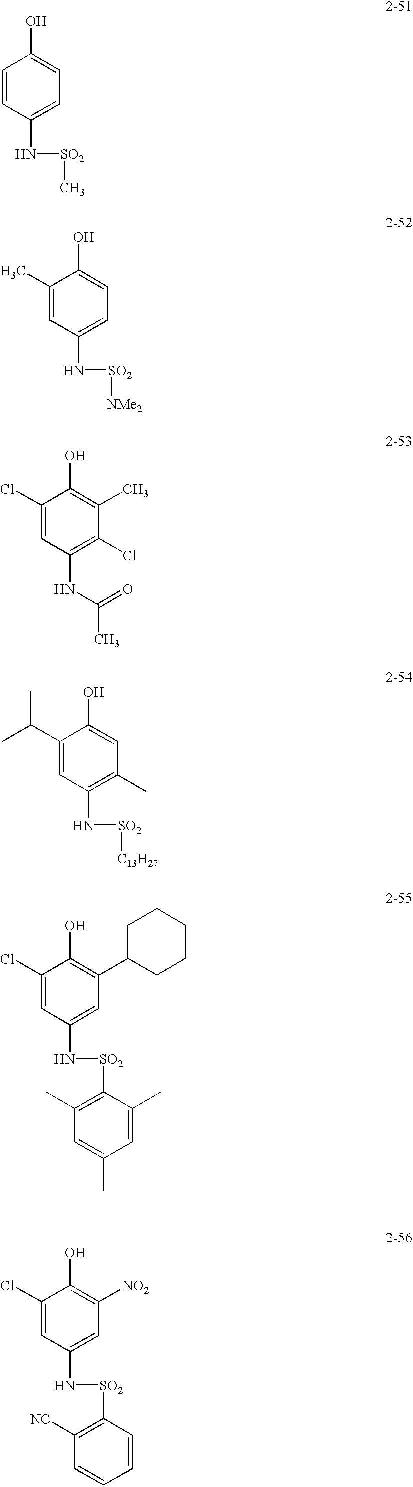

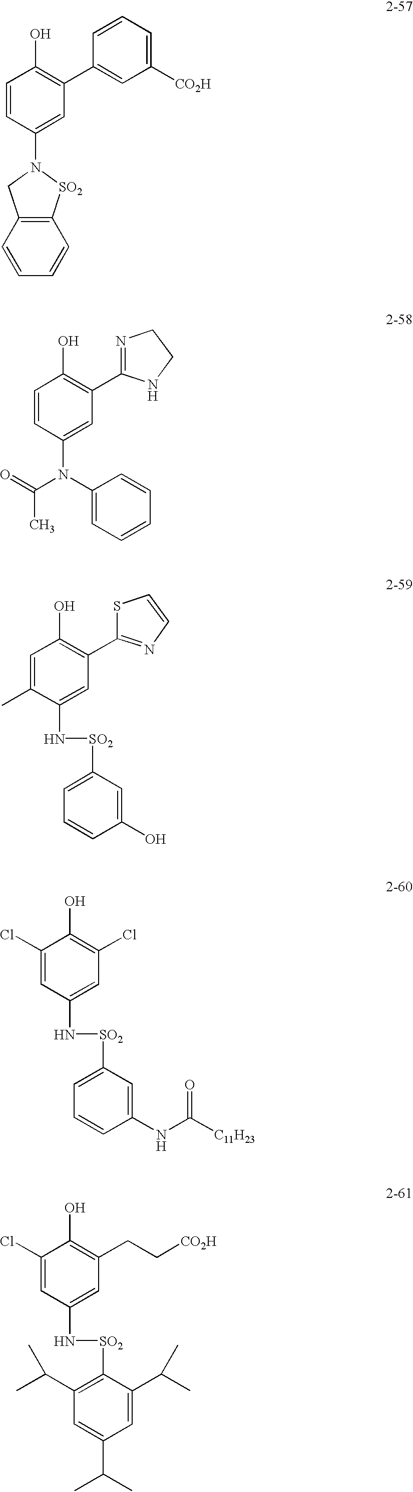

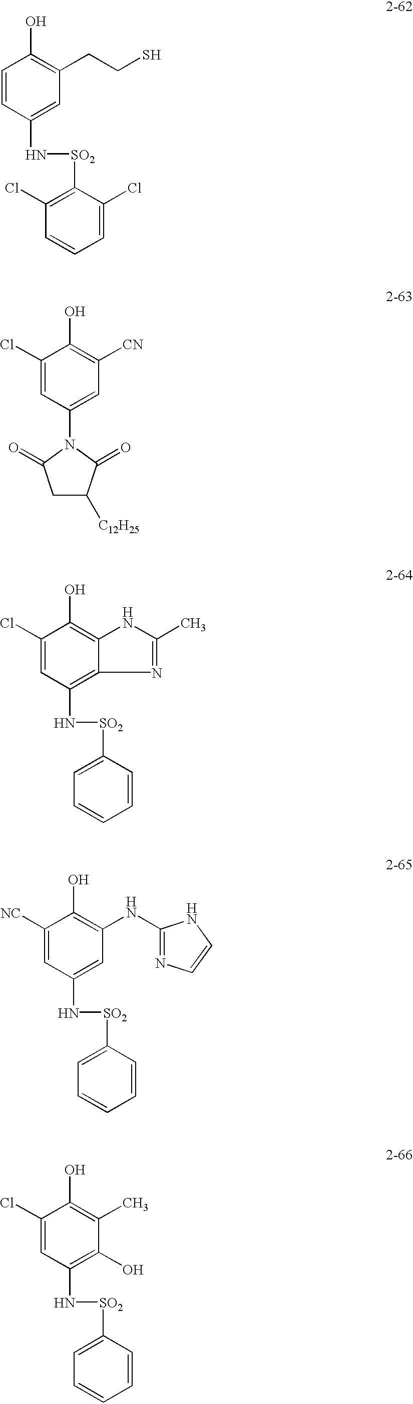

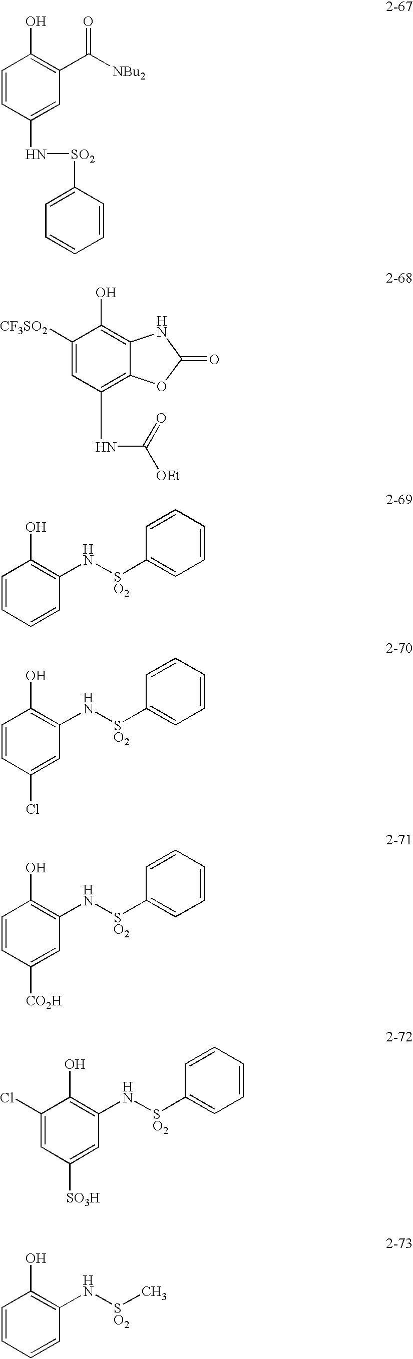

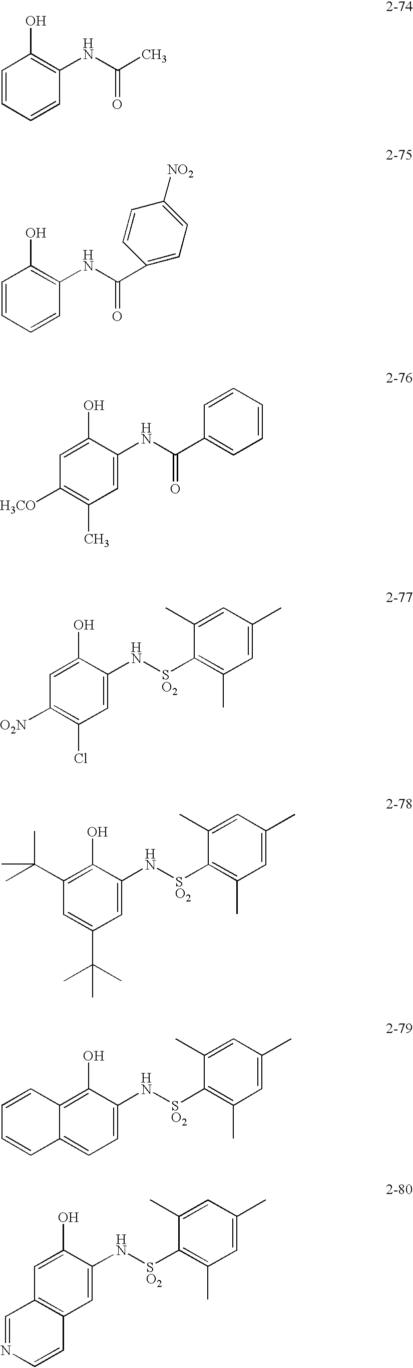

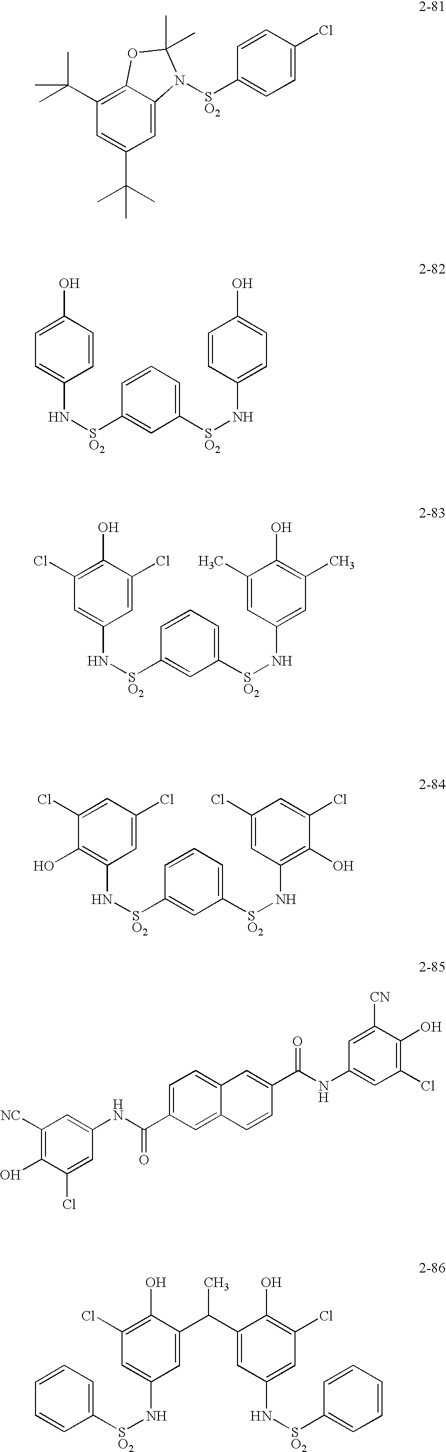

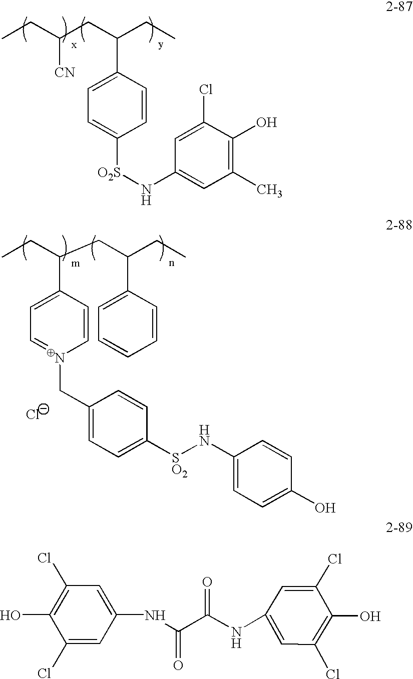

The development accelerator of general formula (3) has the following structure:

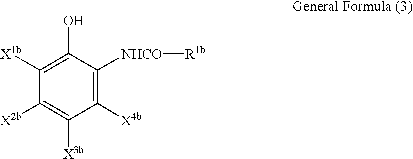

In general formula (3), X^{1b} represents a substituent group substitutable on a benzene ring (X^{1b} is not a hydrogen atom). However, X^{1b} is not a hydroxyl group.

Specific examples of the substituent groups include a halogen atom, an alkyl group (including a cycloalkyl group and bicycloalkyl group), analkenyl group (including a cycloalkenyl group and bicycloalkenyl group), analkynyl group, an aryl group, a heterocyclic group, a cyano group, a nitro group, a carboxyl group, an alkoxyl group, an aryloxy group, a silyloxy group, a heterocyclic oxy group, an acyloxy group, a carbamoyloxy group, an alkoxycarbonyloxy group, an aryloxycarbonyloxy group, an acylamino group, an aminocarbonylamino group, alkoxylcarbonylamino group, an aryloxycarbonylamino group, a sulfamoylamino group, alkylsulfonylamino and arylsulfonylamino groups, a mercapto group, an alkylthio group, an arylthio group, a heterocyclic thio group, a sulfamoyl group, a sulfo group, alkylsulfinyl and arylsulfinyl groups, alkylsulfonyl and arylsulfonyl groups, an acyl group, an aryloxycarbonyl group, an alkoxycarbonyl group, a carbamoyl group, arylazo and heterocyclic azo groups, an imido group, a phosphino group, a phosphinyl group, a phosphinyloxy group, a phosphinylamino group and a silyl group.

More particularly, the substituent groups include a halogen atom (fluorine, chlorine, bromine or iodine), an alkyl group [which indicates a substituted or unsubstituted straight chain, branched or cyclic alkyl group including an alkyl group (preferably an alkyl group having from 1 to 30 carbon atoms, for example, methyl, ethyl, n-propyl, isopropyl, tert-butyl, n-octyl, eicosyl, 2-chloroethyl, 2-cyanoethyl or 2-ethylhexyl), a cycloalkyl group (preferably a cycloalkyl group having from 3 to 30 carbon atoms, for example, cyclohexyl, cyclopentyl or 4-n-dodecylcyclohexyl), a bicycloalkyl group (preferably a substituted or unsubstituted bicycloalkyl group having from 5 to 30 carbon atoms, that is to say, a monovalent group in which one hydrogen atom is removed from an alkane having from 5 to 30 carbon atoms, for example, bicyclo[1,2,2]heptane-2-yl or bicyclo[2,2,2]octane-3-yl), and further a tricyclo structure having many ring structures, an alkyl group in a substituent group described below (for example, an alkyl group in an alkylthio group) also indicates an alkyl group having such a concept], analkenyl group [which indicates a substituted or unsubstituted straight chain, branched or cyclic alkenyl group including an alkenyl group (preferably a substituted or unsubstituted alkenyl group having from 2 to 30 carbon atoms, for example, vinyl, allyl, prenyl, geranyl or oleyl), a cycloalkenyl group (preferably a substituted or unsubstituted cycloalkyl group having from 3 to 30 carbon atoms, that is to say, a monovalent group in which one hydrogen atom is removed from a cycloalkene having from3 to 30 carbon atoms, for example, 2-cyclopentene-1-yl or 2-cyclohexene-1-yl), and a bicycloalkenyl group (a substituted or unsubstituted bicycloalkenyl group, preferably a substituted or unsubstituted bicycloalkyl group having from 5to 30 carbon atoms, that is to say, a monovalent group in which one hydrogen atom is removed from a bicycloalkene having one double bond, for example, bicyclo[2,2,1]hepto-2-ene-1yl or bicyclo[2,2,2]octo-2-ene-4-yl)], an alkynyl group (preferably a substituted or unsubstituted alkynyl group having from 2 to 30 carbon atoms, for example, ethynyl, propargyl or trimethylsilylethynyl), an aryl group (preferably a substituted or unsubstituted aryl group having from 6 to 30 carbon atoms, for example, phenyl, p-tolyl, naphthyl, m-chlorophenyl or o-hexadecanoylaminophenyl), a heterocyclic group (preferably a monovalent group in which one hydrogen atom is removed from a substituted or unsubstituted 5- or 6-membered aromatic or non-aromatic heterocyclic compound, and more preferably a 5- or 6-membered aromatic heterocyclic group having from 3 to 30 carbon atoms, for example, 2-furyl, 2-thienyl, 2-pyrimidinyl or 2-benzothiazolyl), a cyano group, a carboxyl group, an alkoxyl group (preferably a substituted or unsubstituted alkoxyl group having from 1 to 30 carbon atoms, for example, methoxy, ethoxy, isopropoxy, tert-butoxy, n-octyloxy or 2-methoxyethoxy), an aryloxy group (preferably a substituted or unsubstituted aryloxy group having from 6 to 30 carbon atoms, for example, phenoxy, 2-methylphenoxy, 4-tert-butylphenoxy, 3-nitrophenoxy or 2-tetradecanoylaminophenoxy), a silyloxy group (preferably a substituted or unsubstituted silyloxy group having from 3 to 20 carbon atoms, for example, trimethylsilyloxy or tert-butyldimethylsilyloxy), a heterocyclic oxy group (preferably a substituted or unsubstituted heterocyclic oxy group having from 2 to 30 carbon atoms, for example, 1-phenyltetrazole-5-oxy or 2-tetrahydropyranyloxy), an acyloxy group (preferably a formyloxy group, a substituted or unsubstituted alkylcarbonyloxy group having from 2 to 30 carbon atoms or a substituted or unsubstituted arylcarbonyloxy group having from 6 to 30 carbon atoms, for example, formyloxy, acetyloxy, pivaloyloxy, stearoyloxy, benzoyloxy or p-methoxyphenylcarbonyloxy), a carbamoyloxy group (preferably a substituted or unsubstituted carbamoyloxy group having from 1 to 30 carbon atoms, for example, N,N-dimethylcarbamoyloxy, N,N-diethylcarbamoyloxy, morpholinocarbonyloxy, N,N-di-n-octylaminocarbonyloxy or N-n-octylcarbamoyloxy), an alkoxycarbonyloxy group (preferably a substituted or unsubstituted alkoxycarbonyloxy group having from 2 to 30 carbon atoms, for example, methoxycarbonyloxy, ethoxycarbonyloxy, tert-butoxycarbonyloxy or n-octylcarbonyloxy), an aryloxycarbonyloxy group (preferably a substituted or unsubstituted aryloxycarbonyloxy group having from 7 to 30 carbon atoms, for example, phenoxycarbonyloxy, p-methoxyphenoxycarbonyloxy or p-n-hexadecyloxyphenoxycarbonyloxy), an acylamino group (preferably a formylamino group, a substituted or unsubstituted alkylcarbonylamino group having from 1 to 30 carbon atoms or a substituted or unsubstituted arylcarbonylamino group having from 6 to 30 carbon atoms, for example, formylamino, acetylamino, pivaloylamino, lauroylamino, benzoylamino or 3,4,5-tri-n-octyloxyphenylcarbonylamino), an aminocarbonylamino group (preferably a substituted or unsubstituted aminocarbonylamino group having from 1 to 30 carbon atoms, for example, carbamoylamino, N,N-dimethylaminocarbonylamino, N,N-diethylaminocarbonylamino or morpholinocarbonylamino), an alkoxycarbonylamino group (preferably a substituted or unsubstituted alkoxycarbonylamino group having from 2 to 30 carbon atoms, for example, methoxycarbonylamino, ethoxycarbonylamino, tert-butoxycarbonylamino, n-octadecyloxycarbonylamino or N-methyl-methoxycarbonylamino), an aryloxycarbonylamino group (preferably a substituted or unsubstituted aryloxycarbonylamino group having from 7 to 30 carbon atoms, for example, phenoxycarbonylamino, p-chlorophenoxycarbonylamino or m-n-octyloxyphenoxycarbonylamino), a sulfamoylamino group (preferably a substituted or unsubstituted sulfamoylamino group having from 0 to 30 carbon atoms, for example, sulfamoylamino, N,N-dimethylaminosulfonylamino or N-n-octylaminosulfonylamino), alkylsulfonylamino and arylsulfonylamino groups (preferably a substituted or unsubstituted alkylsulfonylamino group having from 1 to 30 carbon atoms and a substituted or unsubstituted arylsulfonylamino group having 6to30 carbon atoms, for example, methylsulfonylamino, butylsulfonylamino, phenylsulfonylamino, 2,3,5-trichlorophenylsulfonylamino or p-methylphenylsulfonylamino), a mercapto group, an alkylthio group (preferably a substituted or unsubstituted alkylthio group having from 1 to 30 carbon atoms, for example, methylthio, ethylthio or n-hexadecylthio), an arylthio group (preferably a substituted or unsubstituted arylthio group having from 6 to 30 carbon atoms, for example, phenylthio, p-chlorophenylthio orm-methoxyphenylthio), a heterocyclic thio group (preferably a substituted or unsubstituted heterocyclic thio group having from 2 to 30 carbon atoms, for example, 2-benzothiazolylthio or 1-phenyltetrazole-5-ylthio), a sulfamoyl group (preferably a substituted or unsubstituted sulfamoyl group having from 0 to 30 carbon atoms, for example, N-ethylsulfamoyl, N-(3-dodecyloxypropyl)sulfamoyl, N,N-dimethylsulfamoyl, N-acetylsulfamoyl, N-benzoylsulfamoyl or N-(N′-phenylcarbamoylsulfamoyl), a sulfo group, alkylsulfinyl and arylsulfinyl groups (preferably a substituted or unsubstituted alkylsulfinyl group having from 1 to 30 carbon atoms and a substituted or unsubstituted arylsulfinyl group having from 6to30carbon atoms, for example, methylsulfinyl, ethylsulfinyl, phenylsulfinyl or p-methylphenylsulfinyl), alkylsulfonyl and arylsulfonyl groups (preferably a substituted or unsubstituted alkylsulfonyl group having from 1 to 30 carbon atoms and a substituted or unsubstituted arylsulfonyl group having from 6to 30 carbon atoms, for example, methylsulfonyl, ethylsulfonyl, phenylsulfonyl or p-methylphenylsulfonyl), an acyl group (preferably a formyl group, a substituted or unsubstituted alkylcarbonyl group having from 2 to 30 carbon atoms, a substituted or unsubstituted arylcarbonyl group having from 7 to 30 carbon atoms or a substituted or unsubstituted heterocyclic carbonyl group of from 4 to 30 carbon atoms linked by a carbon atom to a carbonyl group, for example, acetyl, pivaloyl, 2-chloroacetyl, stearoyl, benzoyl, p-n-octyloxyphenylcarbonyl, 2-pyridylcarbonyl or 2-furylcarbonyl), an aryloxycarbonyl group (preferably a substituted or unsubstituted aryloxycarbonyl group having from 7 to 30 carbon atoms, for example, phenoxycarbonyl, o-chlorophenoxycarbonyl, m-nitrophenoxycarbonyl or p-tert-butylphenoxycarbonyl), an alkoxycarbonyl group (preferably a substituted or unsubstituted alkoxycarbonyl group having from 2 to 30 carbon atoms, for example, methoxycarbonyl, ethoxycarbonyl, tert-butoxycarbonyl orn-octadecylcarbonyl), a carbamoyl group (preferably a substituted or unsubstituted carbamoyl group having from 1 to 30 carbon atoms, for example, carbamoyl, N-methylcarbamoyl, N,N-dimethylcarbamoyl, N,N-di-n-octylcarbamoyl or N-(methylsulfonyl)carbamoyl), arylazo and heterocyclic azo groups (preferably a substituted or unsubstituted arylazo group having from 6 to 30 carbon atoms and a substituted or unsubstituted heterocyclic azo group having from 3 to 30 carbon atoms, for example, phenylazo, p-chloro-phenylazoor 5-ethylthio-l,3,4-thiadiazole-2-ylazo), an imido group (preferably N-succinimido or N-phthalimido), a phosphino group (preferably a substituted or unsubstituted phosphino group having from 2 to 30 carbon atoms, for example, dimethylphosphino, diphenylphosphino or methylphenoxyphosphino), a phosphinyl group (preferably a substituted or unsubstituted phosphinyl group (preferably a substituted or unsubstituted phosphinyl group having from 2 to 30 carbon atoms, for example, phosphinyl, dioctyloxyphosphinyl or diethoxyphosphinyl), a phosphinyloxy group (preferably a substituted or unsubstituted phosphinyloxy group having from 2 to 30 carbon atoms, for example, diphenoxyphosphinyloxy or dioctyloxyphosphinyloxy), a phosphinylamino group (preferably a substituted or unsubstituted phosphinylamino group having from 2 to 30 carbon atoms, for example, dimethoxyphosphinylamino or dimethylaminophosphinylamino) and a silyl group (preferably a substituted or unsubstituted silyl group having from 3 to 30 carbon atoms, for example, trimethylsilyl, tert-butyldimethylsilyl or phenyldimethylsilyl).

The substituent group represented by X^{1b} is preferably a halogen atom (fluorine, chlorine, bromine or iodine, preferably chlorine or bromine), an acylamino group (having preferably from 1 to 20 carbon atoms, more preferably from 1 to 14 carbon atoms, and particularly preferably from 1 to 8 carbon atoms, for example, formylamino, acetylamino or benzoylamino), an alkyl group (having preferably from 1 to 20 carbon atoms, more preferably from 1 to 14 carbon atoms, and particularly preferably from 1 to 8 carbon atoms, for example, methyl, ethyl, isopropyl or cyclohexyl), an aryl group (having preferably from 6 to 20 carbon atoms, more preferably from 6 to 14 carbon atoms, and particularly preferably from 6 to 8 carbon atoms, for example, phenyl, naphthyl or p-methylphenyl), an alkoxyl group (having preferably from 1 to 20 carbon atoms, more preferably from 1 to 14 carbon atoms, and particularly preferably from 1 to 8 carbon atoms, for example, methoxy or ethoxy), an aryloxy group(having preferably from 6 to 20 carbon atoms, more preferably from 6 to 14 carbon atoms, and particularly preferably from 6 to 8 carbon atoms, for example, phenoxy or 2-naphthyloxy), an acyloxy group (having preferably from 1 to 20 carbon atoms, more preferably from 1 to 14 carbon atoms, and particularly preferably from 1 to 8 carbon atoms, for example, acetoxy or benzoyloxy), a sulfonylamino group (having preferably from 1 to 20 carbon atoms, more preferably from 1 to 14 carbon atoms, and particularly preferably from 1 to 8 carbon atoms, for example, methanesulfonylamino or benzenesulfonylamino), a carbamoyl group (having preferably from 1 to 20 carbon atoms, more preferably from 1 to 14 carbon atoms, and particularly preferably from 1 to 8 carbon atoms, for example, carbamoyl, N,N-dimethylcarbamoyl or N-phenylcarbamoyl), carbamoyl), an acyl group (having preferably from 1 to 20 carbon atoms, more preferably from 1 to 14 carbon atoms, and particularly preferably from 1 to 8 carbon atoms, for example, formyl, acetyl or benzoyl), an alkoxycarbonyl group (having preferably from 2 to 20 carbon atoms, more preferably from 2 to 16 carbon atoms, and particularly preferably from 2 to 12 carbon atoms, for example, methoxycarbonyl, ethoxycarbonyl or buthoxycarbonyl), an aryloxycarbonyl group (having preferably from 6 to 20 carbon atoms, more preferably from 6 to 16 carbon atoms, and particularly preferably from 6 to 12 carbon atoms, for example, phenoxycarbonyl or 2-naphthyloxycarbonyl), a cyano group or a nitro group. More preferred is a halogen atom, an acylamino group or an alkyl group, and particularly preferred is chlorine or bromine.

In general formula (3), X^{3b} represents a hydrogen atom or a substituent group. However, X^{3b} is neither a hydroxyl group nor a sulfonamido group. Specific examples of the substituent groups include the substituent groups (excluding a sulfonamido group) mentioned as the examples of X^{1b} of general formula (3).

X^{3b} is preferably a hydrogen atom, a halogen atom (fluorine, chlorine, bromine or iodine, preferably chlorine or bromine), an acylamino group (having preferably from 1 to 20 carbon atoms, more preferably from 1 to 14 carbon atoms, and particularly preferably from 1 to 8 carbon atoms, for example, formylamino, acetylaminoorbenzoylamino), an alkyl group (having preferably from 1 to 20 carbon atoms, more preferably from 1 to 14 carbon atoms, and particularly preferably from 1 to 8 carbon atoms, for example, methyl, ethyl, isopropyl or cyclohexyl), an aryl group (having preferably from 6 to 20 carbon atoms, more preferably from 6 to 14 carbon atoms, and particularly preferably from 6 to 8 carbon atoms, for example, phenyl, naphthyl or p-methylphenyl), an alkoxyl group (having preferably from 1 to 20 carbon atoms, more preferably from 1 to 14 carbon atoms, and particularly preferably from 1 to 8 carbon atoms, for example, methoxy or ethoxy), an aryloxy group (having preferably from 6 to 20 carbon atoms, more preferably from 6 to 14 carbon atoms, and particularly preferably from 6 to 8 carbon atoms, for example, phenoxy or 2-naphthyloxy), an acyloxy group (having preferably from 1 to 20 carbon atoms, more preferably from 1 to 14 carbon atoms, and particularly preferably from 1 to 8 carbon atoms, for example, acetoxy or benzoyloxy), a carbamoyl group (having preferably from 1 to 20 carbon atoms, more preferably from 1 to 14 carbon atoms, and particularly preferably from 1 to 8 carbon atoms, for example, carbamoyl, N,N-dimethylcarbamoyl or N-phenylcarbamoyl), an acyl group (having preferably from 1 to 20 carbon atoms, more preferably from 1 to 14 carbon atoms, and particularly preferably from 1 to 8 carbon atoms, for example, formyl, acetyl or benzoyl), an alkoxycarbonyl group (having preferably from 2 to 20 carbon atoms, more preferably from 2 to 16 carbon atoms, and particularly preferably from 2 to 12 carbon atoms, for example, methoxycarbonyl, ethoxycarbonyl or buthoxycarbonyl), an aryloxycarbonyl group (having preferably from 6 to 20 carbon atoms, more preferably from 6 to 16 carbon atoms, and particularly preferably from 6 to 12 carbon atoms, for example, phenoxycarbonyl or 2-naphthyloxycarbonyl), a cyano group or a nitro group. More preferred is a halogen atom, an acylamino group or an alkyl group, and particularly preferred is chlorine or bromine.

It is preferred that at least one of the substituent groups represented by X^{1b} and X^{3b} is an electron attractive group. The electron attractive group is a substituent group having a positive Hammett substituent constant σₚ. Specific examples thereof include a halogen atom, a cyano group, a nitro group, an alkoxycarbonyl group, aryloxycarbonyl group, an imino group, an imino group substituted by an N atom, a thiocarbonyl group, a perfluoroalkyl group, a sulfonamido group, a formyl group, a phosphoryl group, a carboxyl group, a carbamoyl group, an acyl group, a sulfo group (or a salt thereof), an alkylsulfonyl group, an arylsulfonyl group, a sulfamoyl group, an acyloxy group, an acylthio group, a sulfonyloxy group, a heterocyclic group and an aryl group substituted by each of these electron attractive groups.

X^{1b} and X^{3b} are more preferably electron attractive groups. Still more preferably, both are halogen atoms, and particularly preferably, both are chlorine or fluorine.

In general formula (3), X^{2b} and X^{4b} each represents a hydrogen atom or a substituent group. However, X^{2b} and X^{4b} are not hydroxyl groups. Specific examples of the substituent groups include the substituent groups mentioned as the examples of X^{1b} of general formula (3).

X^{2b} and X^{4b} are each preferably a hydrogen atom, a halogen atom (fluorine, chlorine, bromine or iodine, preferably chlorine or bromine), an acylamino group (having preferably from 1 to 20 carbon atoms, more preferably from 1 to 14 carbon atoms, and particularly preferably from 1 to 8 carbon atoms, for example, formylamino, acetylamino or benzoylamino), an alkyl group (having preferably from 1 to 20 carbon atoms, more preferably from 1 to 14 carbon atoms, and particularly preferably from 1 to 8 carbon atoms, for example, methyl, ethyl, isopropyl or cyclohexyl), an aryl group (having preferably from 6 to 20 carbon atoms, more preferably from 6 to 14 carbon atoms, and particularly preferably from 6 to 8 carbon atoms, for example, phenyl, naphthyl or p-methylphenyl), an alkoxyl group (having preferably from 1 to 20 carbon atoms, more preferably from 1 to 14 carbon atoms, and particularly preferably from 1 to 8 carbon atoms, for example, methoxy or ethoxy), an aryloxy group (having preferably from 6 to 20 carbon atoms, more preferably from 6to 14 carbon atoms, and particularly preferably from 6to 8 carbon atoms, for example, phenoxy or 2-naphthyloxy), an acyloxy group (having preferably from 1 to 20 carbon atoms, more preferably from 1 to 14 carbon atoms, and particularly preferably from 1 to 8 carbon atoms, for example, acetoxy or benzoyloxy), a sulfonylamino group (having preferably from 1 to 20 carbon atoms, more preferably from 1 to 14 carbon atoms, and particularly preferably from 1 to 8 carbon atoms, for example, methanesulfonylamino or benzenesulfonylamino), a carbamoyl group (having preferably from 1 to 20 carbon atoms, more preferably from 1 to 14 carbon atoms, and particularly preferably from 1 to 8 carbon atoms, for example, carbamoyl, N,N-dimethylcarbamoyl or N-phenylcarbamoyl), an acyl group (having preferably from 1 to 20 carbon atoms, more preferably from 1 to 14 carbon atoms, and particularly preferably from 1 to 8 carbon atoms, for example, formyl, acetyl or benzoyl), an alkoxycarbonyl group (having preferably from 2 to 20 carbon atoms, more preferably from 2 to 16 carbon atoms, and particularly preferably from 2 to 12 carbon atoms, for example, methoxycarbonyl, ethoxycarbonyl or buthoxycarbonyl), an aryloxycarbonyl group (having preferably from 6 to 20 carbon atoms, more preferably from 6 to 16 carbon atoms, and particularly preferably from 6 to 12 carbon atoms, for example, phenoxycarbonyl or 2-naphthyloxycarbonyl), a cyano group or a nitro group. More preferred is a hydrogen atom, an alkyl group, an aryl group, a halogen atom or an acyl group, and particularly preferred is hydrogen, methyl or ethyl.

X^{1b} to X^{4b} may further be substituted, and specific examples of the substituent groups include the substituent groups mentioned as the examples of X^{1b} of general formula (3). Further, X^{1b} to X^{4b} may combine with each other to form a ring.

In general formula (3), R^{1b} is a hydrogen atom, an alkyl group (having preferably from 1 to 20 carbon atoms, more preferably from 1 to 14 carbon atoms, and particularly preferably from 1 to 7 carbon atoms, for example, methyl, ethyl, isopropyl or cyclohexyl), an aryl group (having preferably from 6 to 20 carbon atoms, more preferably from 6 to 14 carbon atoms, and particularly preferably from 6 to 8 carbon atoms, for example, phenyl, naphthyl or p-methylphenyl), a heterocyclic group (for example, pyridyl, imidazolyl or pyrrolidyl), an amino group (having preferably from 0 to 20 carbon atoms, more preferably from 0 to 14 carbon atoms, and particularly preferably from 0 to 8 carbon atoms, for example, amino, methylamino, N,N-dimethylamino or N-phenylamino) or an alkoxyl group (having preferably from 1 to 20 carbon atoms, more preferably from 1 to 14 carbon atoms, and particularly preferably from 1 to 8 carbon atoms, for example, methoxy or ethoxy). Preferred is a hydrogen atom, an aryl group, a heterocyclic group, an amino group, an alkoxyl group or an alkyl group having from 1 to 7 carbon atoms, and particularly preferred is an aryl group. R^{1b} may further be substituted, and specific examples of the substituent groups include the substituent groups mentioned as the examples of X^{1b} of general formula (3).

As a preferred combination of X^{1b} to X^{4b} and R^{1b}, at least one of X^{1b} and X^{3b} is a halogen atom, X^{2b} and X^{4b} are hydrogen atoms or alkyl groups, and R^{1b} is an aryl group or an alkyl group having from 1 to 7 carbon atoms.

As a more preferred combination thereof, X^{1b} and X^{3b} are both chlorine or bromine atoms, X^{2b} is a hydrogen atom or an alkyl group, X^{4b} is a hydrogen atom, and R^{1b} is an aryl group.

The range of the total molecular weight of the compound represented by general formula (3) is preferably from 170 to 800, more preferably from 220 to 650, and particularly preferably from 220 to 500.

Specific examples of the compounds represented by general formula (3) are enumerated below, but the compounds of general formula (3) which can be used in the invention are not limited to these specific examples.

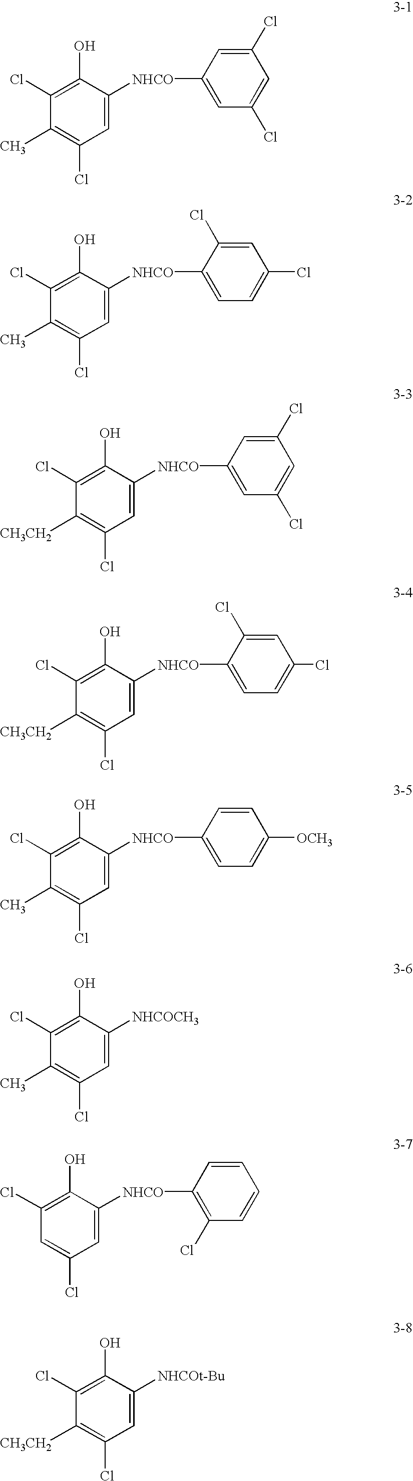

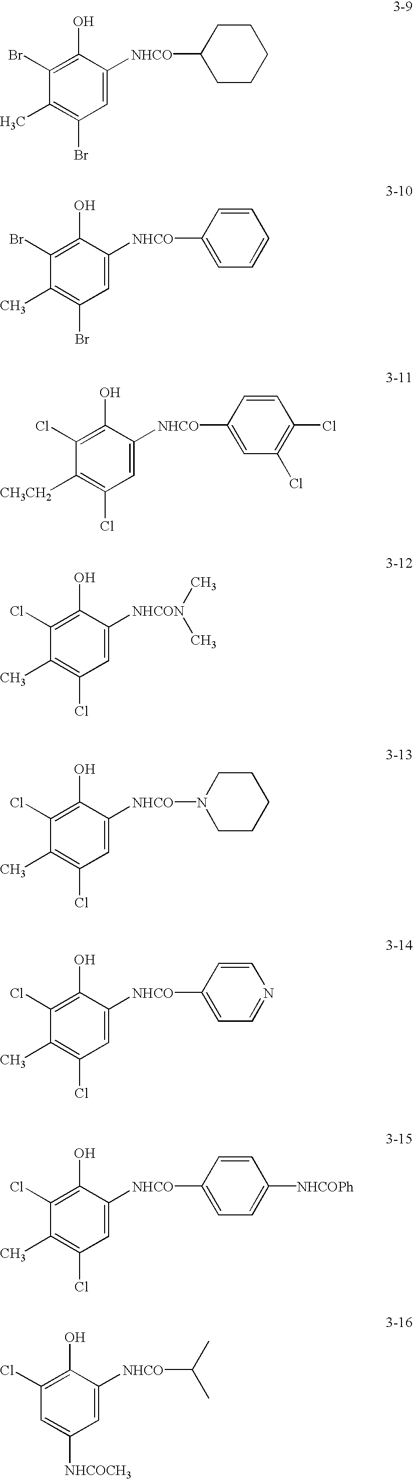

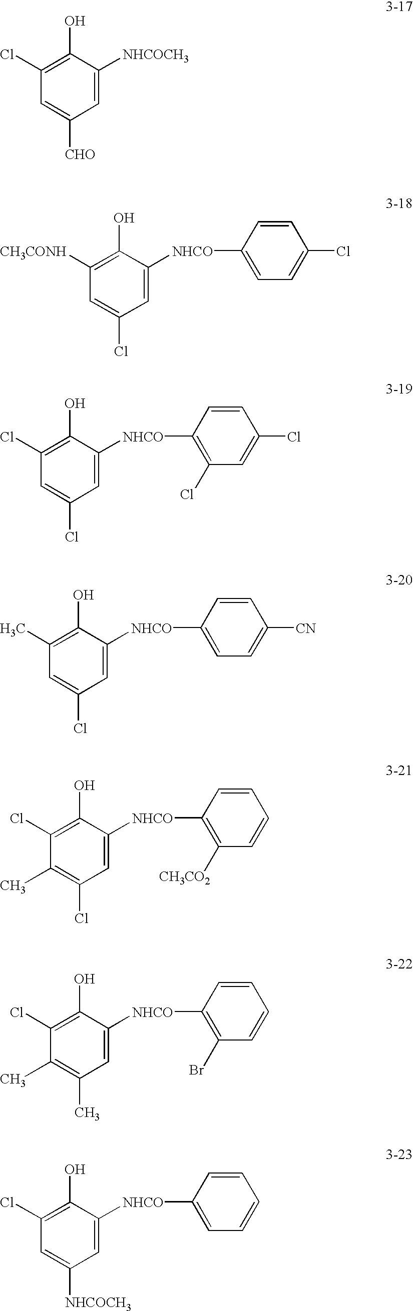

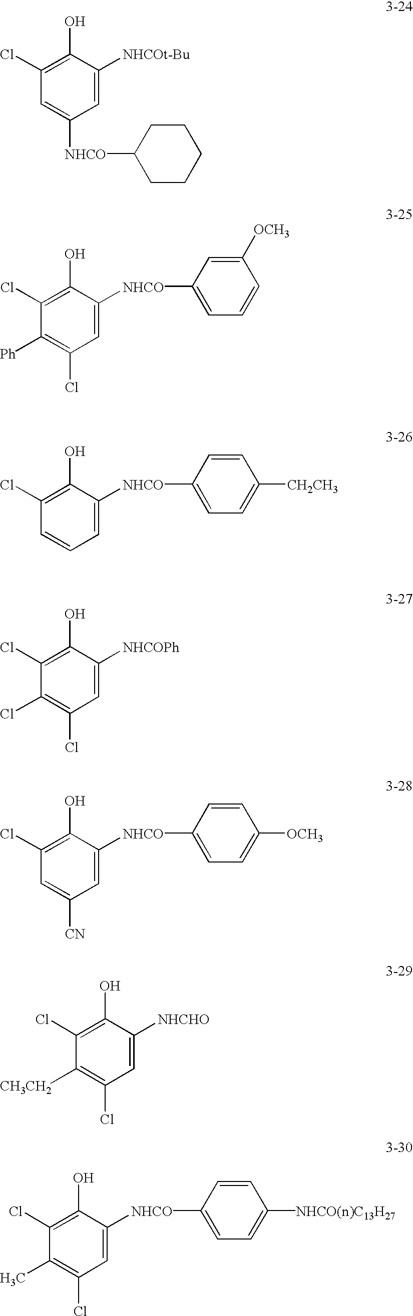

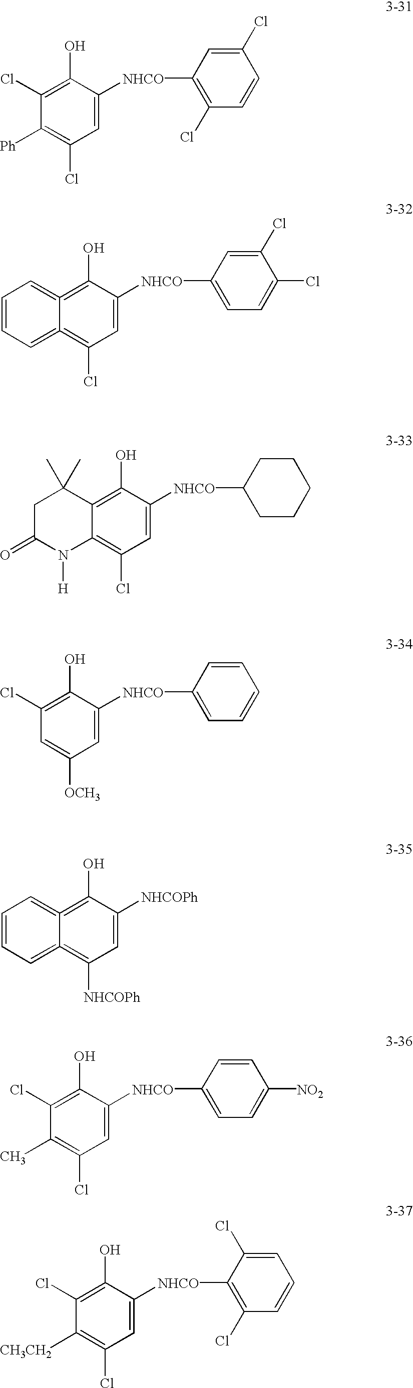

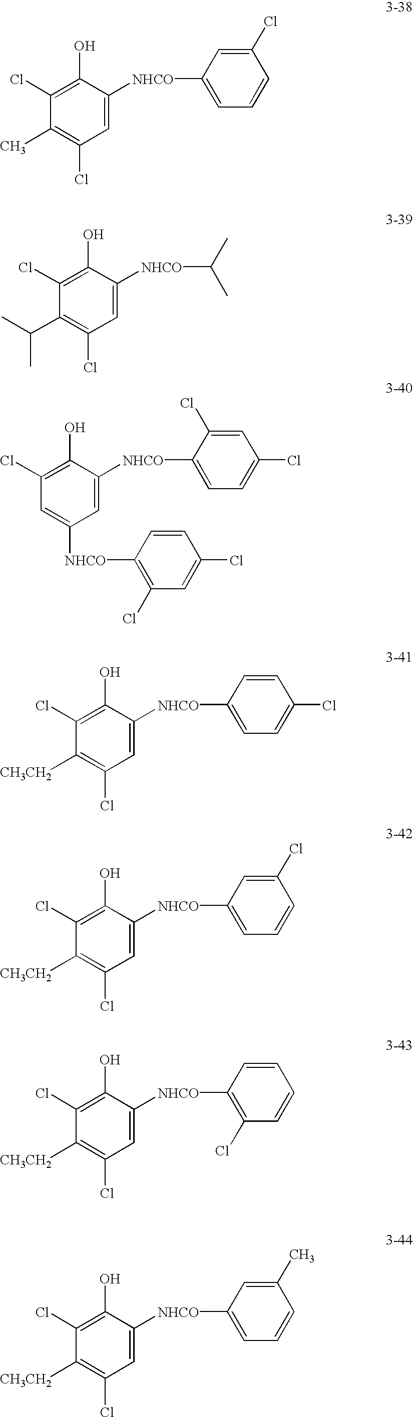

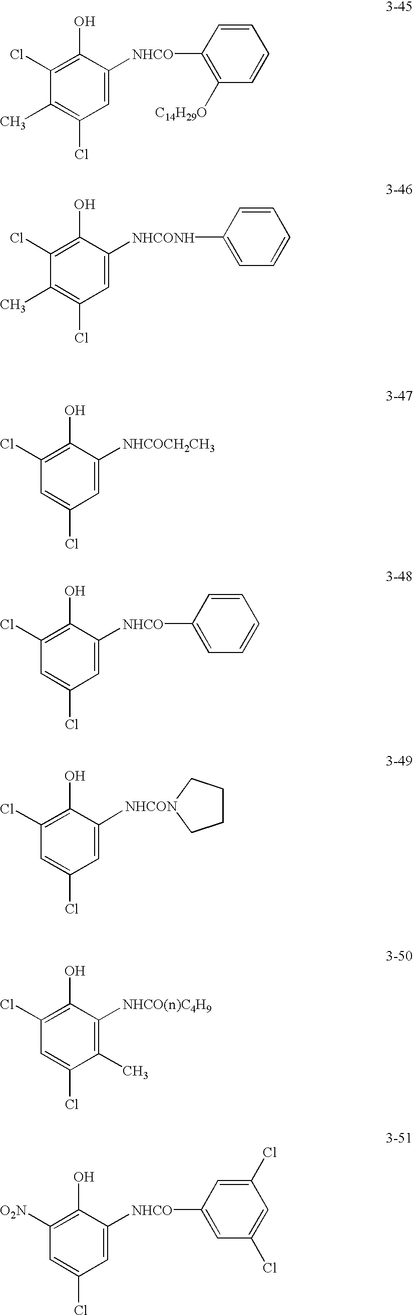

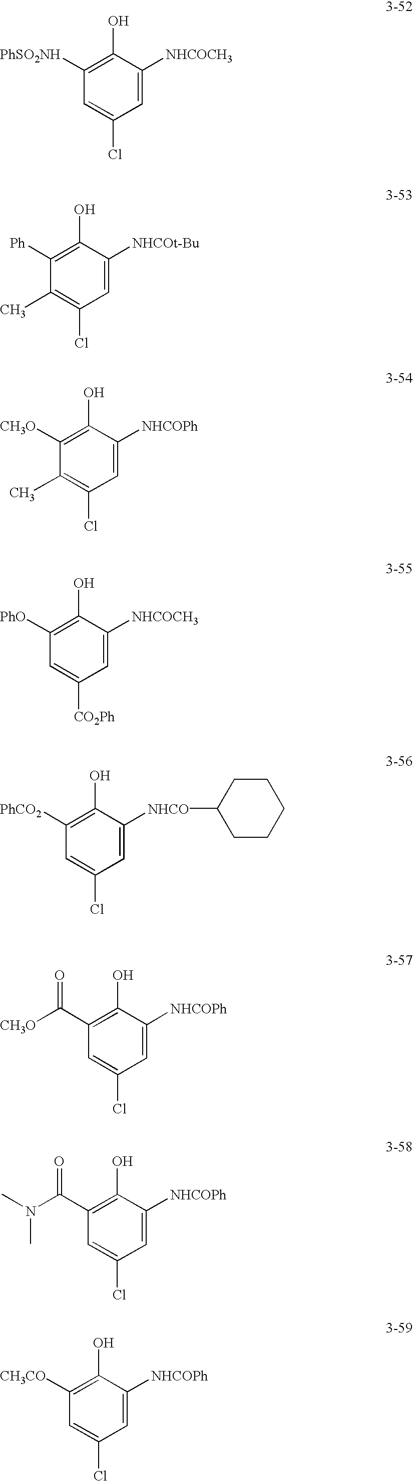

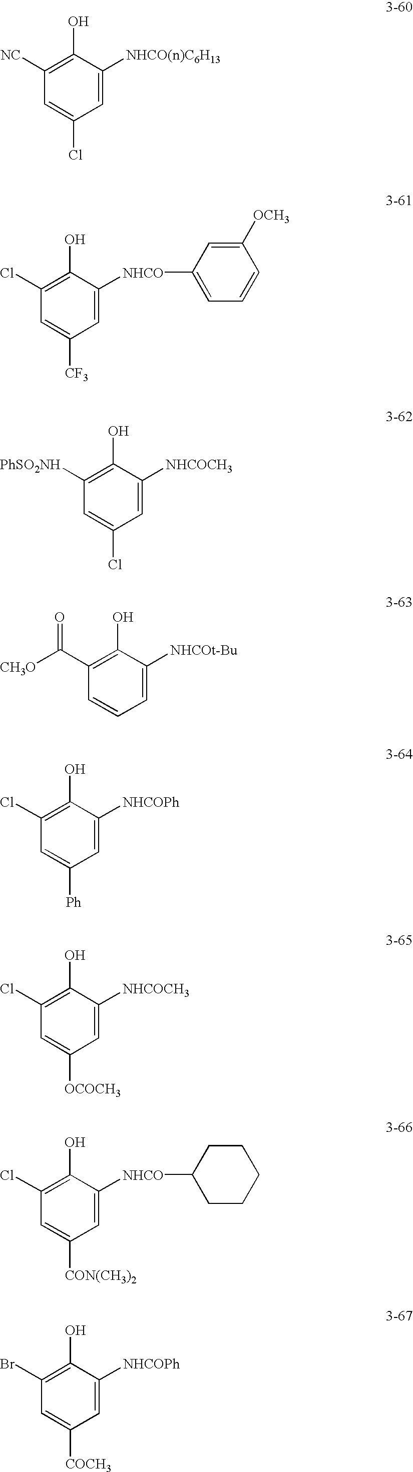

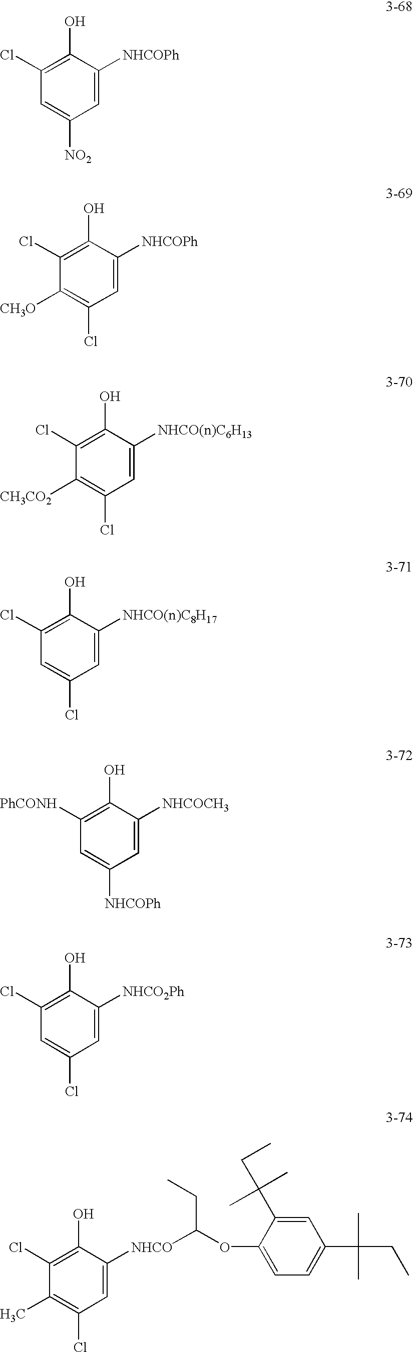

The compounds represented by general formula (3), which are used in the invention, can be easily synthesized by synthesis methods of phenol couplers known in the photographic industry, for example, the reaction of orthoaminophenols with acid halides.

The development accelerator of general formula (4) has the following structure:

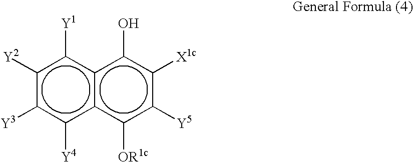

R^{1c} represents an alkyl group, an alkenyl group or alkynyl group.

The alkyl group represented by R^{1c} is a straight chain, branched, cyclic or combined alkyl group having preferably from 1 to 30 carbon atoms, more preferably from 1 to 16 carbon atoms and still more preferably from 1 to 13 carbon atoms, and examples thereof include methyl, ethyl, n-propyl, isopropyl, n-butyl, sec-butyl, t-butyl, n-hexyl, cyclohexyl, n-octyl, i-octyl, n-amyl, t-amyl, n-decyl, n-dodecyl, n-tridecyl, benzyl and phenetyl.

The aryl group represented by R^{1c} has preferably from 6 to 30 carbon atoms, more preferably from 6 to 20 carbon atoms, and still more preferably from 6 to 12 carbon atoms, and examples thereof include phenyl, 4-methylphenyl, 2-chlorophenyl, 4-chlorophenyl, 2,4-dichlorophenyl, 3,4-dichlorophenyl, 2-methoxyphenyl, 4-methoxyphenyl, 4-hexyloxyphenyl, 2-dodecyloxyphenyl and naphthyl.

The alkenyl group represented by R^{1c} has preferably from 2 to 30 carbon atoms, more preferably from 2 to 20 carbon atoms, and still more preferably from 2 to 12 carbon atoms, and examples thereof include vinyl, allyl, isopropenyl, butenyl and cyclohexenyl.

The alkynyl group represented by R^{1c} has preferably from 2 to 30 carbon atoms, more preferably from 2 to 20 carbon atoms, and still more preferably from 2 to 12 carbon atoms, and examples thereof include ethynyl and propynyl.

R^{1c} may further have a substituent group, and preferred examples thereof include groups represented by Y¹ to Y⁵ of the compound of general formula (4), which are described later.

R^{1c} represents more preferably an alkyl group or an aryl group, and particularly preferably an alkyl group.

In the compound of general formula (4), X^{1c} represents an acyl group, an alkoxycarbonyl group, a carbamoyl group, a sulfonyl group or a sulfamoyl group.

The acyl group represented by X^{1c} has preferably from 2 to 20 carbon atoms, more preferably from 2 to 16 carbon atoms, and still more preferably from 2 to 12 carbon atoms, and examples thereof include acetyl, propionyl, butyryl, valeryl, hexanoyl, myristyl, palmitoyl, stearyl, oleyl, acryloyl, cyclohexanecarbonyl, benzoyl, formyl and pivaloyl.

The alkoxycarbonyl group represented by X^{1c} has preferably from 2 to 20 carbon atoms, more preferably from 2 to 16 carbon atoms, and still more preferably from 2 to 12 carbon atoms, and examples thereof include methoxycarbonyl, ethoxycarbonyl, butoxycarbonyl and phenoxycarbonyl.

The carbamoyl group represented by X^{1c} has preferably from 1 to 20 carbon atoms, more preferably from 1 to 16 carbon atoms, and still more preferably from 1 to 12 carbon atoms, and examples thereof include carbamoyl, N,N-diethylcarbamoyl, N-dodecylcarbamoyl, N-decylcarbamoyl, N-hexadecylcarbamoyl, N-phenylcarbamoyl, N-(2-chlorophenyl)carbamoyl, N-(4-chlorophenyl) carbamoyl, N-(2,4-dichlorophenyl)carbamoyl, N-(3,4-dichlorophenyl)carbamoyl, N-pentachlorophenyl-carbamoyl, N-(2-methoxyphenyl)carbamoyl, N-(4-methoxyphenyl) carbamoyl, N-(2,4-dimethoxyphenyl) carbamoyl, N-(2-dodecyloxyphenyl) carbamoyl and N-(4-dodecyloxyphenyl)-carbamoyl.

The sulfonyl group represented by X^{1c} has preferably from 1 to 20 carbon atoms, more preferably from 1 to 16 carbon atoms, and still more preferably from 1 to 12 carbon atoms, and examples thereof include mesyl, ethanesulfonyl, cyclohexanesulfonyl, benzenesulfonyl, tosyl and 4-chlorobenzenesulfonyl.

The sulfamoyl group represented by X^{1c} has preferably from 0 to 20 carbon atoms, more preferably from 0 to 16 carbon atoms, and still more preferably from 0 to 12 carbon atoms, and examples thereof include sulfamoyl, methylsulfamoyl, dimethylsulfamoyl and phenylsulfamoyl.

X^{1c} may further have a substituent group, and preferred examples thereof include groups represented by Y¹ to Y⁵ of the compound of general formula (4), which are described later.

X^{1c} represents preferably a carbamoyl group, more preferably an alkylcarbamoyl group or an arylcarbamoyl group, and particularly preferably an arylcarbamoyl group.

Y¹ to Y5 each independently represents a hydrogen atom or a substituent group.

As the substituent groups represented by Y¹ to Y⁵, any substituent groups may be used as long as they have no adverse effect on photographic properties. The substituent groups include, for example, a halogen atom (for example, fluorine, chlorine, bromine or iodine), a straight chain, branched, cyclic or combined alkyl group (having preferably from 1 to 20 carbon atoms, more preferably from 1 to 16 carbon atoms and still more preferably from to 13 carbon atoms, for example, methyl, ethyl, n-propyl, isopropyl, sec-butyl, t-butyl, t-octyl, n-amyl, t-amyl, n-dodecyl, n-tridecyl or cyclohexyl), an alkenyl group (having preferably from 2 to 20 carbon atoms, more preferably from 2 to 16 carbon atoms and still more preferably from 2 to 12 carbon atoms, for example, vinyl, allyl, 2-butenyl or 3-pentenyl), an aryl group (having preferably from 6to 30 carbon atoms, more preferably from 6 to 20 carbon atoms, and still more preferably from 6 to 12 carbon atoms, for example, phenyl, p-methylphenyl or naphthyl), an alkoxyl group (having preferably from 1 to 20 carbon atoms, more preferably from 1 to 16 carbon atoms, and still more preferably from 1 to 12 carbon atoms, for example, methoxy, ethoxy, propoxy or butoxy), an aryloxy group(having preferably from 6 to 30 carbon atoms, more preferably from 6 to 20 carbon atoms, and still more preferably from 6 to 12 carbon atoms, for example, phenyloxy or 2-naphthyloxy), an acyloxy group (having preferably from 2 to 20 carbon atoms, more preferably from 2 to 16 carbon atoms, and still more preferably from 2 to 12 carbon atoms, for example, acetoxy or benzoyloxy), an amino group (having preferably from 0 to 20 carbon atoms, more preferably from 1 to 16 carbon atoms, and still more preferably from 1 to 12 carbon atoms, for example, dimethylamino, diethylamino, dibutylamino or anilino), an acylamino group (having preferably from 2 to 20 carbon atoms, more preferably from 2 to 16 carbon atoms, and still more preferably from 2 to 13 carbon atoms, for example, acetylamino, tridecanoylamino or benzoylamino), a sulfonylamino group (having preferably from 1 to 20 carbon atoms, more preferably from 1 to 16 carbon atoms, and still more preferably from 1 to 12 carbon atoms, for example, methanesulfonylamino, butanesulfonylamino or benzenesulfonylamino), a ureido group (having preferably from 1 to 20 carbon atoms, more preferably from 1 to 16 carbon atoms, and still more preferably from 1 to 12 carbon atoms, for example, ureido, methylureido or phenylureido), a carbamate group (having preferably from 2 to 20 carbon atoms, more preferably from 2 to 16 carbon atoms, and still more preferably from 2 to 12 carbon atoms, for example, methoxycarbonylamino or phenyloxycarbonylamino), a carboxyl group, a carbamoyl group (having preferably from 1 to 20 carbon atoms, more preferably from 1 to 16 carbon atoms, and still more preferably from to 12 carbon atoms, for example, carbamoyl, N,N-diethylcarbamoyl, N-dodecylcarbamoyl, or N-phenylcarbamoyl), an alkoxycarbonyl group (having preferably from 2 to 20 carbon atoms, more preferably from 2 to 16 carbon atoms, and still more preferably from 2 to 12 carbon atoms, for example, methoxycarbonyl, ethoxycarbonyl or buthoxycarbonyl), an acyl group (having preferably from 2 to 20 carbon atoms, more preferably from 2 to 16 carbon atoms, and still more preferably from 2 to 12 carbon atoms, for example, acetyl, benzoyl, formyl orpivaloyl), a sulfo group, a sulfonyl group (having preferably from 1 to 20 carbon atoms, more preferably from 1 to 16 carbon atoms, and still more preferably from 1 to 12 carbon atoms, for example, mesyl or tosyl), a sulfamoyl group (having preferably from 0 to 20 carbon atoms, more preferably from 0 to 16 carbon atoms, and still more preferably from 0 to 12 carbon atoms, for example, sulfamoyl, methylsulfamoyl, dimethylsulfamoyl or phenylsulfamoyl), a cyano group, a nitro group, a hydroxyl group, a mercapto group, an alkylthio group (having preferably from 1 to 20 carbon atoms, more preferably from 1 to 16 carbon atoms, and still more preferably from 1 to 12 carbon atoms, for example, methylthio or butylthio), a heterocyclic group (having preferably from 2 to 20 carbon atoms, more preferably from 2 to 16 carbon atoms, and still more preferably from 2 to 12 carbon atoms, for example, pyridyl, imidazolyl or pyrrolidyl). These substituent groups may further be substituted with different substituent groups.

Of the above, preferred as the substituent groups represented by Y¹ to Y⁵ are a halogen atom, an alkyl group, an aryl group, an alkoxyl group, an aryloxy group, an acyloxy group, an anilino group, an acylamino group, a sulfonylamino group, a carboxyl group, a carbamoyl group, an acyl group, a sulfo group, a sulfonyl group, a sulfamoyl group, a cyano group, a hydroxyl group, a mercapto group, an alkylthio group and a heterocyclic group.

As a preferred combination of R^{1c}, X^{1c} and Y¹ to Y⁵, R^{1c} is an alkyl group, X^{1c} is a carbamoyl group, and Y¹ to Y⁵ are hydrogen atoms.

Specific examples of the compounds represented by general formula (4) are enumerated below, but the compounds used in the invention are not limited by these specific examples.

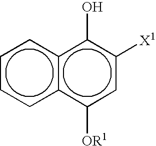

| Compound | X¹ | R¹ |
|---|---|---|
| 4-1 | CONHC₆H₅ | CH₃ |
| 4-2 | ″ | C₂H₅ |
| 4-3 | ″ | C₃H₇ |
| 4-4 | ″ | (i)C₃H₇ |
| 4-5 | ″ | C₄H₉ |
| 4-6 | ″ | C₅H₁₁ |
| 4-7 | ″ | C₆H₁₃ |
| 4-8 | ″ | C—C₆H₁₁ |
| 4-9 | ″ | C₁₀H₂₁ |
| 4-10 | ″ | C₁₂H₂₅ |
| 4-11 | ″ | C₁₆H₃₃ |
| 4-12 | ″ | CH₂C₆H₅ |
| 4-13 | ″ | (CH₂)₂C₆H₅ |
| 4-14 | ″ | (CH₂)₂NHSO₂CH₃ |
| 4-15 | ″ | (CH₂)₂OCH₂CH₃ |
| 4-16 | ″ | (CH₂)₂O(CH₂)₂OH |
| 4-17 | ″ | (CH₂)₂OCH₂CO₂H |
| 4-18 | ″ | C₈H₁₇ |
| 4-19 | ″ | (CH₂)₂SO₂CH₃ |
| 4-20 | ″ | (CH₂)₂SO₂CH₂CH₃ |
| 4-21 | ″ | (CH₂)₂O(CH₂)₂OCH₂CH₃ |
| 4-22 | ″ | 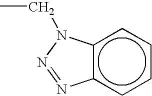 |
| 4-23 | CONHC₆H₅ | 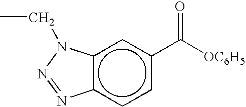 |
| 4-24 | ″ | C₆H₅ |
| 4-25 | ″ | p-CH₃—C₆H₄ |
| 4-26 | ″ | p-Cl—C₆H₄ |
| 4-27 | ″ | 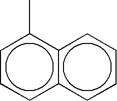 |
| 4-28 | ″ | 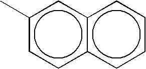 |
| 4-29 | CONH-2-Cl—C₆H₄ | CH₃ |
| 4-30 | ″ | C₄H₉ |
| 4-31 | ″ | C₆H₁₃ |
| 4-32 | ″ | CH₂CH₂C₆H₅ |
| 4-33 | ″ | C₁₂H₂₅ |
| 4-34 | CONH-4-Cl—C₆H₄ | C₄H₉ |
| 4-35 | ″ | C₆H₁₃ |
| 4-36 | ″ | C₈H₁₇ |
| 4-37 | ″ | CH₂CH₂C₆H₅ |
| 4-38 | ″ | C₁₀H₂₅ |
| 4-39 | 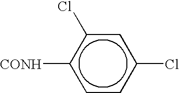 | CH₃ |
| 4-40 | ″ | C₄H₉ |
| 4-41 | ″ | C₆H₁₃ |
| 4-42 | ″ | C₈H₁₇ |
| 4-43 | ″ | CH₂CH₂C₆H₅ |
| 4-44 | ″ | C₁₀H₂₁ |
| 4-45 | 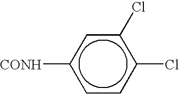 | CH—CHCH₃ |
| 4-46 | ″ | C₄H₉ |
| 4-47 | ″ | C₆H₁₃ |
| 4-48 | ″ | 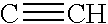 |
| 4-49 | ″ | C₈H₁₇ |
| 4-50 | ″ | CH₂CH₂C₆H₅ |
| 4-51 | ″ | CH₂C₆H₅ |
| 4-52 | ″ | C₆H₅ |
| 4-53 | ″ | CH₂CH₂SO₂CH₃ |
| 4-54 | 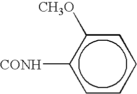 | C₆H₁₃ |
| 4-55 | ″ | CH₂CH₂C₆H₅ |
| 4-56 | ″ | C₄H₉ |
| 4-57 | CONHCH₃ | C₆H₁₃ |
| 4-58 | CONHC₄H₉ | ″ |
| 4-59 | CONHC₆H₁₃ | ″ |
| 4-60 | CONHC₁₀H₂₁ | ″ |
| 4-61 | CONHC₁₂H₂₅ | ″ |
| 4-62 | CONHC₁₆H₃₃ | ″ |
| 4-63 | 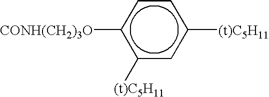 | ″ |
| 4-64 | CONH(CH₂)₃OC₁₂H₂₅ | ″ |
| 4-65 | 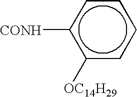 | ″ |
| 4-66 | CONHCH₂C₆H₅ | ″ |
| 4-67 | 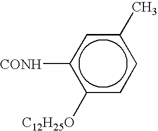 | ″ |
| 4-68 | 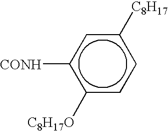 | ″ |
| 4-69 | CONH-(t)C₄H₉ | ″ |
| 4-70 | CONH-(t)C₈H₁₇ | ″ |
| 4-71 | CON(C₂H₅)₂ | C₆H₁₃ |
| 4-72 | 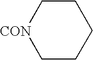 | ″ |
| 4-73 | 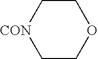 | ″ |
| 4-74 | 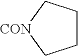 | ″ |
| 4-75 | CONHC₄H₉ | (CH₂)₂C₆H₅ |
| 4-76 | CONHC₁₀H₂₁ | ″ |
| 4-77 | CONHC₁₂H₂₅ | ″ |
| 4-78 | CONH-(t)C₄H₉ | ″ |
| 4-79 | CONH-(t)C₈H₁₇ | ″ |
| 4-80 | CONHCH₃ | ″ |
| 4-81 | 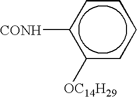 | ″ |
| 4-82 | CON(C₂H₅)₂ | ″ |
| 4-83 | 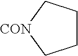 | ″ |
| 4-84 | CONHCH₂C₆H₅ | ″ |

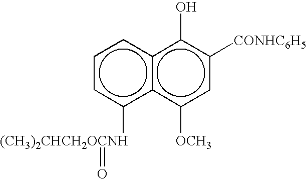

(4-85)

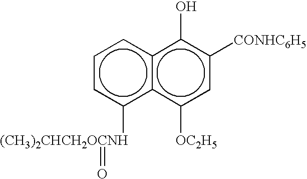

(4-86)

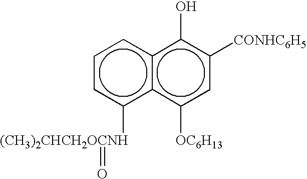

(4-87)

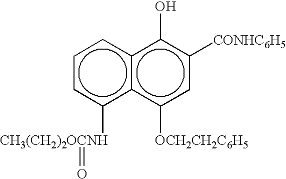

(4-88)

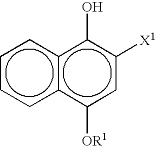

| Compound | X¹ | R¹ |
|---|---|---|
| 4-89 | COCH₃ | C₆H₁₃ |
| 4-90 | COC₂H₅ | ″ |
| 4-91 | COC₇H₁₅ | ″ |
| 4-92 | COC₁₁H₂₃ | ″ |
| 4-93 | COCH₃ | (CH₂)₂C₆H₅ |
| 4-94 | COC₂H₅ | ″ |
| 4-95 | COC₇H₁₅ | ″ |
| 4-96 | COC₁₁H₂₃ | ″ |
| 4-97 | COCH₃ | CH₃ |
| 4-98 | ″ | C₄H₉ |
| 4-99 | ″ | C₆H₅ |
| 4-100 | ″ | CH₂C₆H₅ |
| 4-101 | ″ | C₁₀H₂₁ |
| 4-102 | ″ | C₁₂H₂₅ |
| 4-103 | ″ | C₁₆H₃₃ |
| 4-104 | CO₂C₆H₅ | C₆H₅ |
| 4-105 | ″ | CH₃ |
| 4-106 | ″ | C₂H₅ |
| 4-107 | ″ | C₄H₉ |
| 4-108 | ″ | C₆H₁₃ |
| 4-109 | ″ | C₁₀H₂₁ |
| 4-110 | ″ | CH₂C₆H₅ |
| 4-111 | ″ | (CH₂)₂C₆H₅ |
| 4-112 | ″ | C₁₂H₂₅ |
| 4-113 | ″ | C₁₆H₃₃ |
| 4-114 | CO₂C₆H₅ | (CH₂)₂SO₂CH₃ |
| 4-115 | ″ | (CH₂)₂SO₂NHCH₃ |
| 4-116 | ″ | (CH₂)₂NHSO₂C₂H₅ |
| 4-117 | CO₂CH₃ | CH₃ |
| 4-118 | ″ | C₄H₉ |
| 4-119 | CO₂C₂H₅ | C₆H₁₃ |
| 4-120 | ″ | (CH₂)₂C₆H₅ |
| 4-121 | ″ | C₁₂H₂₅ |
| 4-122 | CO₂C₁₂H₂₅ | CH₃ |
| 4-123 | ″ | C₄H₉ |
| 4-124 | ″ | C₆H₁₃ |
| 4-125 | ″ | (CH₂)₂C₆H₅ |
| 4-126 | ″ | (CH₂)₂SO₂CH₃ |
| 4-127 | ″ | CH═CHCH₃ |
| 4-128 | ″ | CH₂CH═CH₂ |
| 4-129 | ″ | 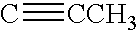 |
| 4-130 | ″ | C—C₆H₁₁ |
| 4-131 | ″ | C₆H₅ |
| 4-132 | SO₂CH₃ | C₄H₉ |
| 4-133 | ″ | C₈H₁₃ |
| 4-134 | ″ | C₆H₅ |
| 4-135 | ″ | CH₃ |
| 4-136 | ″ | (CH₂)₂C₆H₅ |
| 4-137 | ″ | CH₂C₆H₅ |
| 4-138 | SO₂C₆H₅ | C₄H₉ |
| 4-139 | ″ | C₅H₁₃ |
| 4-140 | ″ | CH₃ |
| 4-141 | ″ | (CH₂)₂C₆H₅ |
| 4-142 | ″ | C₁₂H₂₅ |
| 4-143 | SO₂NHC₆H₅ | C₆H₅ |
| 4-144 | SO₂NHCH₃ | ″ |
| 4-145 | SO₂NHC₂H₅ | ″ |
| 4-146 | SO₂NHC₈H₁₃ | ″ |
| 4-147 | SO₂NHC₄H₉ | ″ |
| 4-148 | SO₂NH-(t)C₄H₉ | ″ |
| 4-149 | SO₂NH-(t)C₈H₁₇ | ″ |
| 4-150 | SO₂NHC₆H₅ | C₆H₁₃ |
| 4-151 | SO₂NHCH₃ | ″ |
| 4-152 | SO₂NHC₂H₅ | ″ |
| 4-153 | SO₂NHC₄H₉ | ″ |
| 4-154 | SO₂NH-(t)C₄H₉ | ″ |
| 4-155 | SO₂NH-(t)C₈H₁₇ | ″ |
| 4-156 | SO₂NHC₆H₁₃ | (CH₂)₂C₆H₅ |
| 4-157 | SO₂NHC₆H₅ | ″ |
| 4-158 | SO₂NHCH₃ | ″ |
| 4-159 | SO₂NH-(t)C₈H₁₇ | ″ |

The compounds represented by general formulas (1) to (4), which are used in the invention, can be easily synthesized by methods known in the photographic industry.

The compounds of the invention represented by general formulas (1) to (4) can each be used as a solution in which each compound is dissolved in water or a suitable solvent, for example, an alcohol (such as methanol, ethanol, propanol or a fluorinated alcohol), a ketone (such as acetone or methyl ethyl ketone), dimethylformamide, dimethyl sulfoxide or methyl cellosolve.

Alternatively, these compounds can each be used as an emulsified dispersion prepared by dissolving each compound using an oil such as dibutyl phthalate, tricresyl phosphate, glyceryl triacetate or diethyl phthalate, or an auxiliary solvent such as ethyl acetate or cyclohexanone, and mechanically dispersing it by an already well-known emulsification dispersion method. They can also each be used as a dispersion in which each compound is dispersed in water with a ball mill, a colloidmill, a sand grinder mill, a Manton Gaul in homogenizer, a microfluidizer or an ultrasonic wave, according to a well-known solid dispersion method.

The compounds represented by general formulas (1) to (4), which are used in the invention, may each be added to any layer on the side of a light-sensitive silver halide and a reducible silver salt existing on a support. However, they are each preferably added to a silver halide-containing layer or a layer adjacent thereto.

The compounds represented by general formulas (1) to (4), which are used in the invention, are added preferably in an amount of 0.2 to 200 mmol, more preferably in an amount of 0.3 to 100 mmol, and more preferably in an amount of 0.5 to 30 mmol.

The compounds of the invention represented by general formulas (1) to (4) may be used either alone or as a combination of two or more of them.

The heat-developable photosensitive materials of the invention contain light-sensitive silver halides. Methods for forming the light-sensitive silver halides used on the invention are well known in the art, and, for example, methods described in Research Disclosure, No. 17029 (June, 1978) and U.S. Pat. No. 3,700,458 can be used.

As a specific method which can be used in the invention, there is used a method of adding a halogen-containing compound to an organic silver salt prepared, thereby partly converting the organic silver salt to a light-sensitive silver halide, or a method of a method of adding a silver-supplying compound and a halogen-supplying compound to gelatin or another polymer solution to prepare a light-sensitive silver halide grains, and mixing the grains with an organic silver salt. In the invention, the latter method can be preferably used.

For the purpose of reducing white turbidness after image formation, it is preferred that the light-sensitive silver halide has a small grain size. Specifically, the grain size is preferably from 0.0001 μm to 0.15 μm, and more preferably from 0.02 μm to 0.10 μm. Too small the silver halide grain size results in insufficient sensitivity, whereas too large the grain size results in the occurrence of the problem of increased haze in the photosensitive material in some cases. When the silver halide grain is a so-called normal crystal having a cubic form or an octahedral form, the term “grain size” as used herein means the length of an edge of a silver halide grain. Further, when the silver halide grain is a tabular grain, it means the diameter of a circle image to which a projected area of a main plane is converted, the circle image having the same area as the projected area. When the silver halide grain is not a normal crystal, for example, spherical or rod-like, it means the diameter at the time when a sphere having a volume equivalent to that of the silver halide grain is considered.

The shapes of the silver halide grains include cubic, octahedral, tabular, spherical, rod-like and potato-like forms. In the invention, however, cubic and tabular grains are particularly preferred. When the tabular silver halide grains are used, the average aspect ratio thereof is preferably from 100:1 to 2:1, and more preferably from 50:1 to 3:1. Silver halide grains having rounded corners can also be preferably used.

There is no particular limitation on the face index (Miller index) of an outer surface of the light-sensitive silver halide grain. However, it is preferred that {100} faces capable of giving a high spectral sensitization efficiency upon adsorption of a spectral sensitizing dye occupy a high percentage. The percentage is preferably 50% or more, more preferably 65% or more, and still more preferably 80% or more. The percentage of the {100} faces according to the Miller index can be determined by a method described in T. Tani, Imaging Sci. , 29, 165 (1985), utilizing the adsorption dependency of the {111} face and the {100} face in adsorption of a sensitizing dye.

There is no particular limitation on the halogen composition of the light-sensitive silver halide, and any of silver chloride, silver chlorobromide, silver bromide, silver iodobromide, silver iodochlorobromide and silver iodide can be used. In the invention, however, silver bromide or silver iodobromide can be preferably used. Particularly preferred is silver iodobromide, and the silver iodide content is preferably from 0.1 mol % to 40 mol %, and more preferably from 0.1 mol % to 20 mol %.

The distribution of the halogen composition in the grain may be uniform, or the halogen composition may vary stepwise or continuously. However, as a preferred example, silver iodobromide grains having high silver iodide content in the grain can be used. Further, silver halide grains having a core/shell structure can be preferably used. With respect to the structure, 2- to 5-ply structure type core/shell grains can be preferably used, and 2-to 4-ply structure type core/shell grains can be more preferably used.

It is preferred that the light-sensitive silver halide grains used in the invention contain at least one complex of a metal selected from rhodium, rhenium, ruthenium, osmium, iridium, cobalt, mercury and iron. These metal complexes may be used either alone or as a combination of two or more of complexes comprising metals of the same kind or different kinds.

The content thereof is preferably from 1 nanomol (nmol) to 10 millimols (mmol), and more preferably from 10 nanomols (nmol) to 100 micromols (μmol), per mol of silver.

With respect to the specific metal complex structure, a metal complex having the structure described in Japanese Patent Laid-Open No. 225449/1995 can be used. As for cobalt and iron compounds, hexacyano metal complexes can be preferably used.

Specific examples thereof include but are not limited to a ferricyanate ion, a ferrocyanate ion and a hexacyanocobaltate ion. There is no particular limitation on the phase containing the metal complex in the silver halide. The metal complex may be contained uniformly, in a core portion at a high concentration, or in a shell portion at a high concentration.

The light-sensitive silver halide grains can be desalted by methods known in the art, such as water washing with noodle and flocculation. However, in the invention, desalting may be either carried out or not.

In the invention, it is preferred that the light-sensitive silver halide grains are chemically sensitized. As preferred chemical sensitization, there can be used sulfur sensitization, selenium sensitization or tellurium sensitization. Further, noble metal sensitization using a noble metal such as a gold compound or a platinum, palladium or iridium compound, or reduction sensitization can be used. Although known compounds can be used as compounds preferably used in sulfur sensitization, selenium sensitization and tellurium sensitization, compounds described in Japanese Patent Laid-Open No. 128768/1995 can be used.

The amount of the light-sensitive silver halide used in the invention is preferably from 0.01 mol to 0.5 mol, more preferably from 0.02mol to 0.3mol, and particularly preferably from 0.03 mol to 025 mol, per mol of organic silver salt.

As for processes and conditions for mixing the light-sensitive silver halides and the organic silver salts which are separately prepared, there are a method of mixing the silver halide grains and the organic silver salt each after the completion of preparation, in a high-speed stirrer, a ball mill, a sand mill, a colloid mill, a vibrating mill or a homogenizer, and a method of mixing the light-sensitive silver halide of which preparation is completed, at any timing during preparation of the organic silver salt to prepare the organic silversalt. However, there is no particular limitation thereon, as long as the effects of the invention are sufficiently manifested.

As a method for preparing the silver halide used in the invention, there is preferably used a so-called halidation method in which silver of an organic silver salt is partly halogenated with an organic or inorganic halide.

The organic halide used herein may be any, as long as it is a compound which reacts with the organic silver salt to produce the silver halide. Such organic halides include an N-halogenoimide (N-bromosuccinimide), a halogenated quaternary nitrogen compound (tetrabutylammoniumbromide), and an associated product of a halogenated quaternary nitrogen compound and a halogen molecule (pyridinium perbromide bromide).

The inorganic halide may be any, as long as it is a compound which reacts with the organic silver salt to produce the silver halide. Such inorganic halides include an alkali metal or ammonium halide (such as sodium chloride, lithium bromide, potassium iodide or ammonium bromide), an alkaline earth metal halide (such as calcium bromide or magnesium chloride), a transition metal halide (such as ferric chloride or cupric bromide), a halogen ligand-containing metal complex (such as sodium bromoiridate or ammonium chlororhodiate) and a halogen atom (such as bromine, chlorine or iodine).

The amount of the halide added in halidation is preferably from 1 mmol to 500 mmol, and more preferably from 10 mmol to 250 mmol, by halogen atom per mol of organic silver salt.

As sensitizing dyes applicable to the invention, there can be selected sensitizing dyes which can spectrally sensitize the silver halide grains in a desired wavelength region when adsorbed by the silver halide grains, and which have spectral sensitivity suitable for the spectral characteristics of an exposure light source.

The sensitizing dyes and methods for adding them are described in Japanese Patent Laid-Open No. 65021/1999, paragraph numbers 0103 to 0109, Japanese Patent Laid-Open No. 186572/1998 (compounds represented by general formula (II)), Japanese Patent Laid-Open No. 119374/1999 (dyes represented by general formula (I) and paragraph number 0106), U.S. Pat. Nos. 5,510,236, 5,541,054 and 3,871,887 (dyes described in Example 5), Japanese Patent Laid-Open No. 96131/1990 and 48753/1984 (dyes described therein), EP-A-0803764, page 19, line 38 to page 20, line 35, and Japanese Patent Application Nos. 86865/2000 and 102560/2000.

These sensitizing dyes may be used either alone or as a combination of two or more of them.

In the invention, the sensitizing dyes may be used in a desired amount depending on performances such as sensitivity and fog. However, they are used preferably in an amount of 10⁻⁶ to 1 mol, and more preferably in an amount of 10⁻⁴ to 10⁻¹ mol, per mol of silver halide of the light-sensitive layer. a combination of the sensitizing dyes is often used particularly for supersenitization

A dye itself having no sensitizing function or a substance which does not substantially absorb visible light and shows supersensitization may be contained in the emulsion. Combinations of useful sensitizing dyes and dyes showing supersensitization and substances showing supersensitization are described in Research Disclosure, No. 176, 17643 (December, 1976), page 23, Item J of IV, or Japanese Patent Publication Nos. 25500/1974 and 4933/1968 and Japanese Patent Laid-Open Nos. 19032/1984 and 192242/1984.

A color toning agent is preferably added to the heat-developable photosensitive material of the invention. The color toning agents are described in Japanese Patent Laid-Open No. 62899/1998, paragraph numbers 0054 to 0055, EP-A-0803764, page 21, lines 23 to 48 and Japanese Patent Application No. 213487/1998. Particularly preferred are phthalazinone compounds (phthalazinone, phthalazinone derivatives or metal salts thereof, for example, 4-(1-naphthyl)phthalazinone, 6-chlorophthalazinone, 5,7-dimethoxyphthalazinone and 2,3-dihydro-1,4-phthalazinedione); combinations of phthalazinone compounds and phthalic acid compounds (e.g., phthalic acid, 4-methylphthalic acid, 4-nitrophthalic acid and tetrachlorophtahlic acid anhydride); phthalazine compounds (phthalazine, phthalazine derivatives or metal salts thereof, for example, 4-(l-naphthyl)phthalazine, 6-isopropylphtalazine, 6-t-butylphthalazine, 6-chlorophthalazine, 5,7-dimethoxyphthalazine and 2,3-dihydrophthalazine); and combinations of phthalazine compounds and phthalic acid compounds. In particular, combinations of phthalazine compounds and phthalic acid compounds are preferred.

The color toning agent is contained on the side having an image formation layer preferably in an amount of 0.1 to 50 mol %, and more preferably in an amount of 0.5 to 20 mol %, per mol of silver.

The heat-developable photosensitive material of the invention contains a reducing agent for the organic silver salt. The reducing agent for the organic silver salt may be any substance (preferably an organic material) capable of reducing a silver ion into metal silver. Such a reducing agent is described in Japanese Patent Laid-Open No. 65021/1999 (paragraph numbers. 0043 to 0045) and EP-A-0803764 (page 7, line 34 to page 18, line 12).

In the invention, the reducing agent is preferably a hindered phenol reducing agent or a bisphenol reducing agent, more preferably a compound represented by the following general formula (R):

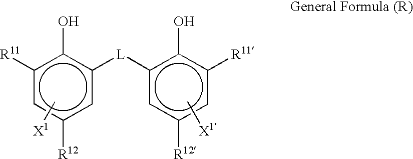

In general formula (R), R¹¹ and R¹¹′ each independently represents an alkyl group having from 1 to 20 carbon atoms; R¹² and R¹²′ each independently represents a hydrogen atom or a substituent group substitutable on a benzene ring; L represents an —S— group or a —CHR¹³— group; R¹³ represents a hydrogen atom or an alkyl group having from 1 to 20 carbon atoms; and X¹ and X¹′ each independently represents a hydrogen atom or a group substitutable on a benzene ring.

The heat-developable photosensitive material of the third embodiment of the invention includes the compound represented by the general formula (R) as the reducing agent.

General formula (R) will be described in detail.

R¹¹ and R¹¹′ each represents a substituted or unsubstituted alkyl group having from 1 to 20 carbon atoms. There is no particular limitation on the substituent group of the alkyl group, and preferred examples thereof include an aryl group, a hydroxyl group, an alkoxyl group, an aryloxy group, an alkylthio group, an arylthio group, an acylamino group, a sulfonamido group, a sulfonyl group, a phosphoryl group, an acyl group, a carbamoyl group, an ester group and a halogen atom.

R¹² and R¹²′ each independently represents a hydrogen atom or a substituent group substitutable on a benzene ring, and X¹ and X¹′ each independently represents a hydrogen atom or a group substitutable on a benzene ring. Preferred examples of the respective groups substitutable on a benzene ring include an alkyl group, an aryl group, a halogen atom, an alkoxyl group and an acylamino group.

L represents an —S— group or a —CHR¹³— group. R¹³ represents a hydrogen atom or an alkyl group having from 1 to 20 carbon atoms, and the alkyl group may have a substituent group. Specific examples of the unsubstituted alkyl groups represented by R¹³ include a methyl group, an ethyl group, a propyl group, a butyl group, a heptyl group, an undecyl group, an isopropyl group, a 1-ethylbenzyl group and a 2,4,4-trimethylpentyl group.

Examples of the substituent groups of the alkyl group are the same as the substituent groups of R¹¹, and include a halogen atom, an alkoxyl group, an alkylthio group, an aryloxy group, an arylthio group, an acylamino group, a sulfonamido group, a sulfonyl group, a phosphoryl group, an oxycarbonyl group, a carbamoyl group and a sulfamoyl group.

R¹¹ and R¹¹′ are each preferably a secondary or tertiary alkyl group having from 3 to 15 carbon atoms, and examples thereof include an isopropyl group, an isobutyl group, a t-butyl group, a t-amyl group, a t-octyl group, a cyclohexyl group, a cyclopentyl group, a 1-methylcyclohexyl group and a 1-methylcyclopropyl group.

R¹¹ and R¹¹′ are each more preferably a tertiary alkyl group having from 4 to 12 carbon atoms. Of these, more preferred are a t-butyl group, a t-amyl group and a 1-methylcyclohexyl group, and most preferred is a t-butyl group.

R¹² and R¹²′ are each preferably an alkyl group having from 1 to 20 carbon atoms, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group and a methoxyethyl group. More preferred are a methyl group, an ethyl group, a propyl group, an isopropyl group and a t-butyl group.

X¹ and X¹′ are each preferably a hydrogen atom, a halogen atom or an alkyl group, and more preferably a hydrogen atom.

L is preferably a —CHR¹³— group.

R¹³ is preferably a hydrogen atom or an alkyl group having from 1 to 15 carbon atoms, and the alkyl group is preferably a methyl group, an ethyl group, a propyl group, an isopropyl group or a 2,4,4-trimethylpentyl group. R¹³ is particularly preferably a hydrogen atom, a methyl group, a propyl group or an isopropyl group.

When R¹³ is a hydrogen atom, R¹² and R¹²′ are each preferably an alkyl group having from 2 to 5 carbon atoms, more preferably an ethyl group or a propyl group, and most preferably an ethyl group.

When R¹³ is a primary or secondary alkyl group having from 1 to 8 carbon atoms, R¹² and R¹²′ are each preferably a methyl group. The primary or secondary alkyl group having from 1 to 8 carbon atoms represented by R¹³ is more preferably a methyl group, an ethyl group, a propyl group or an isopropyl group, and still more preferably a methyl group, an ethyl group or a propyl group.

When R¹¹, R¹¹′, R¹² and R¹²′ are all methyl groups, R¹³ is preferably a secondary alkyl group. In this case, the secondary alkyl group represented by R¹³ is preferably an isopropyl group, an isobutyl group or a 1-ethylpentyl group, and more preferably an isopropyl group.

Specific examples of the reducing agents used in the invention including the compounds represented by general formula (R) of the invention are shown below, but the invention is not limited thereto.

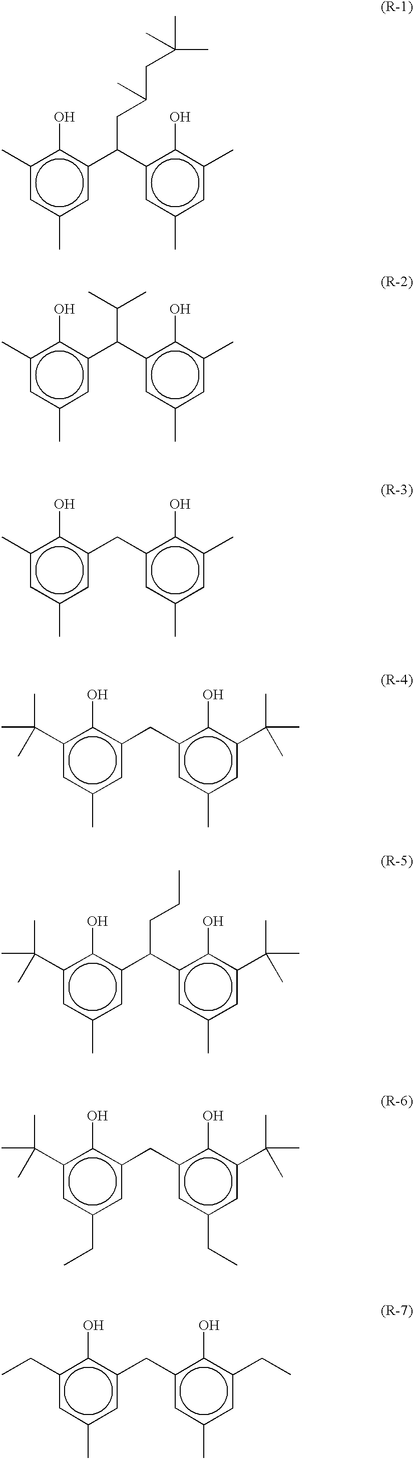

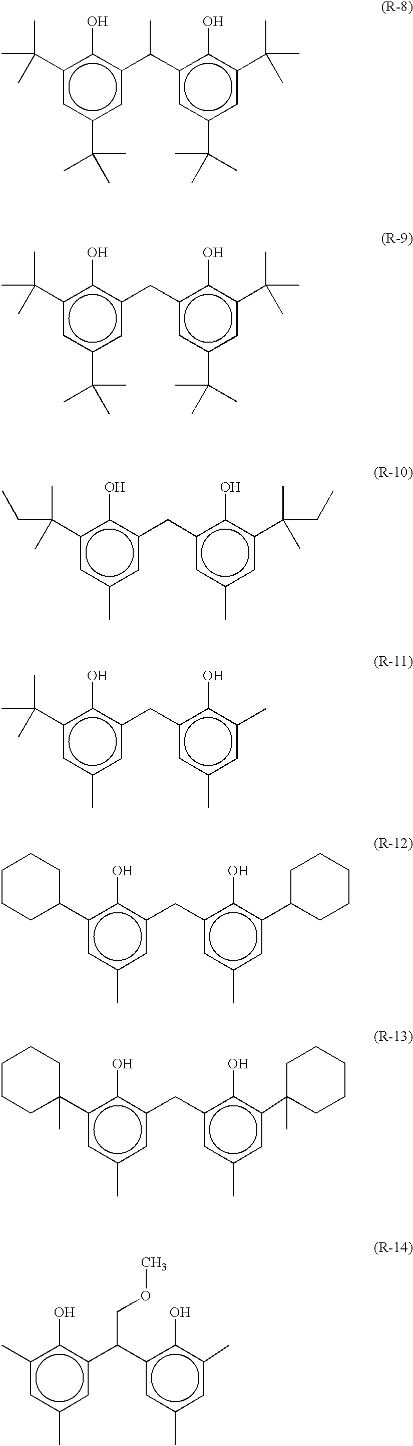

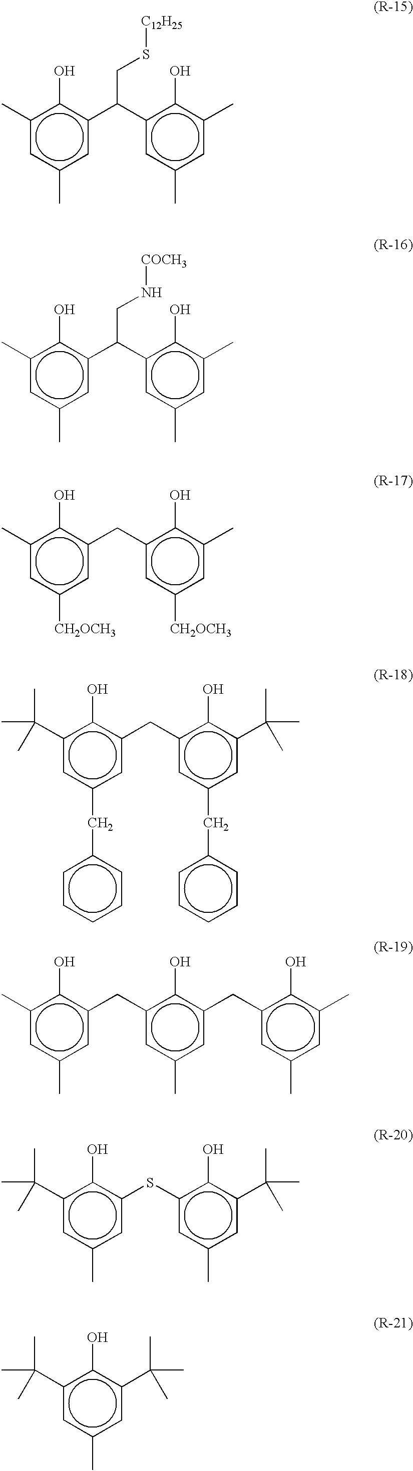

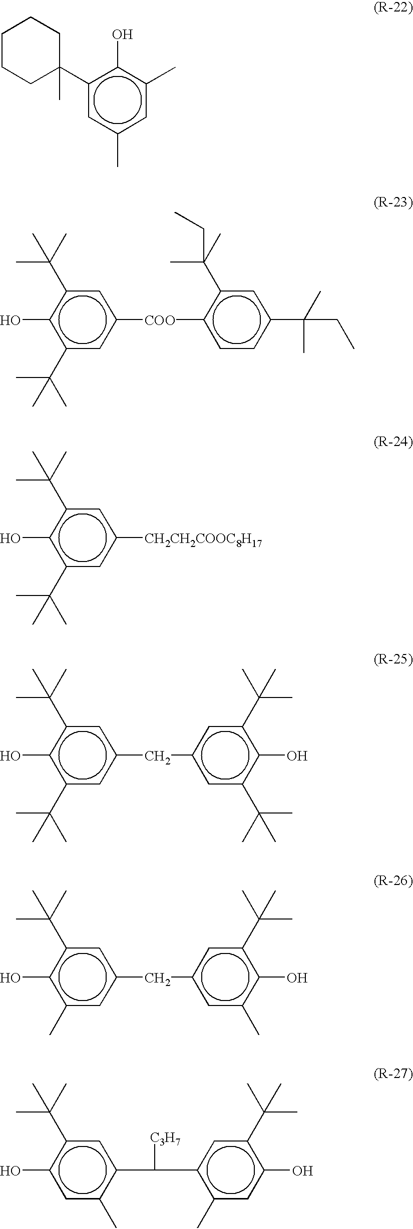

In the invention, the amount of the reducing agent added is preferably from 0.01 to 5 g/m², and more preferably from 0.1 to 3.0 g/m². The reducing agent is contained preferably in an amount of 5 to 50 mol %, and more preferably in an amount of 10 to 40 mol %, per mol of silver on the side having an image forming layer. The reducing agent is preferably contained in the image forming layer.

The reducing agent may be contained in the coating solution or incorporated into the photosensitive material in any form, for example, in the form of a solution, an emulsified dispersion or a fine solid grain dispersion.

Examples of the well-known emulsification dispersion methods include a method of dissolving the reducing agent using an oil such as dibutyl phthalate, tricresyl phosphate, glyceryl triacetate or diethyl phthalate, or an auxiliary solvent such as ethyl acetate or cyclohexanone, and mechanically preparing an emulsified dispersion.

The fine solid grain dispersion methods include a method of dispersing the reducing agent in the powder form in an appropriate solvent such as water using a ball mill, a vibrating ball mill, a sand mill, a jet mill, a roller mill or an ultrasonic wave, thereby manufacturing a solid dispersion. At this time, a protective colloid (for example, polyvinyl alcohol) or a surfactant (for example, an anionic surfactant such as sodium triisopropylnaphthalenesulfonate (a mixture of compounds in which three isopropyl groups are substituted at different positions)) may be used. In the case of an aqueous dispersion, an antiseptic (for example, benzoisothiazolinone sodium salt) can be incorporated into the aqueous dispersion.

In the invention, as the binder for the light-sensitive layer, there can be used any polymer from natural and synthetic resins such as gelatin, rubber, polyvinyl butyral, polyvinyl acetal, polyvinyl chloride, polyvinyl acetate, cellulose acetates, a polyolefin, a polyester, polystyrene, polyacrylonitrile, a polycarbonate, butylethyl celluloses, a methacrylate copolymer, a maleic anhydride ester copolymer and a butadiene-styrene copolymer. Preferably, polyvinyl butyral is used in an amount of 50% by weight or more. As a matter of course, these polymers include copolymers and terpolymers.

The amount of polyvinyl butyral as the binder is preferably from 50% to 100% by weight, and more preferably from 70% to 100% by weight. The Tg of the binder contained in the light-sensitive layer is preferably from 40° C. to 90° C., and more preferably from 50° C. to 80° C.

In the present specification, the Tg is calculated by the following equation:

1/Tg=Σ(Xi/Tgi)

wherein it is assumed that the polymer is resultant of the copolymerization of n monomer components from i=1 to i=n. Xi is the weight partial ratio (ΣXi=1) of the i-th monomer and Tgi is the glass transition temperature (absolute temperature) of a homopolymer of the i-th monomer, provided that Σ is the sum of i=1 to i=n. Incidentally, for the glass transition temperature (Tgi) of a homopolymer of each monomer, the values described in J. Brandrup and E. H. Immergut, Polymer Handbook, 3rd ed., Wiley-Interscience (1989) are employed.

The binders may be used as combination of two or more of them as needed. A polymer having a glass transition temperature of 20° C. or more and a polymer having a glass transition temperature of less than 20° C. may be used in combination. In the case of using a blend of two or more kinds of polymers different in Tg, the weight average Tg thereof is preferably within the above-described range.

In the invention, the total amount of the binder(s) used is an amount sufficient to maintain the components therein, that is to say, within the range effective to function as the binder. The effective range can be suitably determined by a person skilled in the art. As a measure at the time when at least the organic silver salt is maintained, the ratio of the binder to the organic silver salt is preferably from 15:1 to 1:3, and particularly preferably from 8:1 to 1:2.

In the heat-developable photosensitive material of the third embodiment of the invention, the compound (hindered phenol compound) represented by general formula (2) is preferably contained in a layer on the side of a face containing the light-sensitive silver halide on the support. The compounds represented by general formula (2) will be described below.

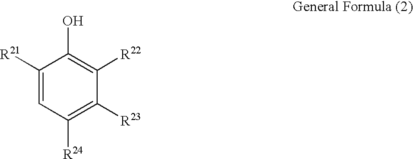

In general formula (2), R²¹ and R²² each independently represents a hydrogen atom, an alkyl group or an acylamino group, but R²¹ and R²² are not each a 2-hydroxyphenylmethyl group, and are not hydrogen atoms at the same time, R²³ represents a hydrogen atom or an alkyl group, and R²⁴ represents a substituent group substitutable on a benzene ring.

In general formula (2), when R²¹ is an alkyl group, it is preferably an alkyl group having from 1 to 30 carbon atoms, and more preferably an alkyl group having from 1 to 10 carbon atoms.

The alkyl group may have a substituent group. Specifically, the unsubstituted alkyl group is preferably methyl, ethyl, butyl, octyl, isopropyl, t-butyl, t-octyl, t-amyl, sec-butyl, cyclohexyl, 1-methylcyclohexyl or the like. A group three-dimensionally equal to or larger than the isopropyl group (for example, isopropyl, isononyl, t-butyl, t-amyl, t-octyl, cyclohexyl, 1-methylcyclohexyl or adamantly) is preferred. Of these, t-butyl, t-octyl, t-amyl or the like, a tertiary alkyl group, is particularly preferred.

When the above-mentioned alkyl groups have substituent groups, the substituent groups include a halogen atom, an aryl group, an alkoxyl group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group.

In general formula (2), when R²² is an alkyl group, it is preferably an alkyl group having from 1 to 30 carbon atoms, and more preferably an alkyl group having from 1 to 24 carbon atoms.

The alkyl group may have a substituent group. Specifically, the unsubstituted alkyl group is preferably methyl, ethyl, butyl, octyl, isopropyl, t-butyl, t-octyl, t-amyl, sec-butyl, cyclohexyl, 1-methylcyclohexyl or the like.

Examples of the alkyl groups are the same as with R²¹.

In general formula (2), when R²¹ and R²² are each an acylamino group, they are each preferably an acylamino group having from 1 to 30 carbon atoms, and more preferably an acylamino group having from 1 to 10 carbon atoms.

The acylamino group may be unsubstituted or have a substituent group. Specific examples thereof include acetylamino, alkoxyacetylamino and aryloxyacetylamino.

In general formula (2), of a hydrogen atom, an alkyl group and an acylamino group, R²¹ is preferably an alkyl group.

On the other hand, of a hydrogen atom, an alkyl group and an acylamino group, R²¹ is preferably a hydrogen atom or an unsubstituted alkyl group having from 1 to 24 carbon atoms. Specific examples thereof include methyl, isopropyl and t-butyl.

R²¹ and R²² are not each a 2-hydroxyphenylmethyl group, and are not hydrogen atoms at the same time.

In general formula (2), R²³ represents a hydrogen atom or an alkyl group. Of these, preferred is a hydrogen atom or analkyl group having from 1 to 30 carbon atoms, and more preferred is a hydrogen atom or an unsubstituted alkyl group having from 1 to 24 carbon atoms. The description of the alkyl group is the same as with R²². Specific examples thereof include methyl, isopropyl and t-butyl.

Either of R²² and R²³ is preferably a hydrogen atom.

In general formula (2), R²⁴ represents a substituent group substitutable on a benzene ring, and is the same group as described for R¹² and R¹²′ of the compound represented by general formula (R). R²⁴ preferably represents a substituted or unsubstituted alkyl group having from 1 to 30 carbon atoms, or an oxycarbonyl group having from 2 to 30 carbon atoms. More preferred is an alkyl group having from 1 to 24 carbon atoms. The substituent groups for the alkyl groups include an aryl group, an amino group, an alkoxyl group, an oxycarbonyl group, an acylamino group, an acyloxy group, an imido group and a ureido group, and more preferred are an aryl group, an amino group, an oxycarbonyl group and an acyloxy group.

In the compounds represented by general formula (2), a more preferred structure is represented by the following general formula (3).

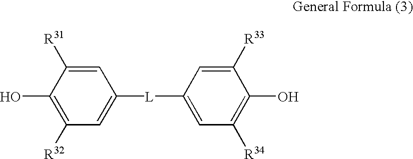

In general formula (3), R³¹, R³², R³³ and R³⁴ are each independently a substituted or unsubstituted alkyl group having from 1 to 20 carbon atoms, and preferably an alkyl group having from 1 to 10 carbon atoms. Although there is no particular limitation on the substituent group for the alkyl group, preferred examples thereof include an aryl group, a hydroxyl group, an alkoxyl group, an aryloxy group, an alkylthio group, an arylthio group, an acylamino group, a sulfonamido group, a sulfonyl group, a phosphoryl group, an acyl group, a carbamoyl group, an ester group and a halogen atom. Of these, there is preferably at least one group three-dimensionally equal to or larger than the isopropyl group (for example, isopropyl, isononyl, t-butyl, t-amyl, t-octyl, cyclohexyl, 1-methylcyclohexyl or adamantly), and more preferably two or more thereof. t-Butyl, t-octyl, t-amyl or the like, a tertiary alkyl group three-dimensionally larger than the isopropyl group, is particularly preferred. L is the same as L in the compound of general formula (R).

Specific examples of the compounds represented by general formula (2) in the invention (including the compounds represented by general formula (3)) are shown below, but the compounds used in the invention are not limited to these.

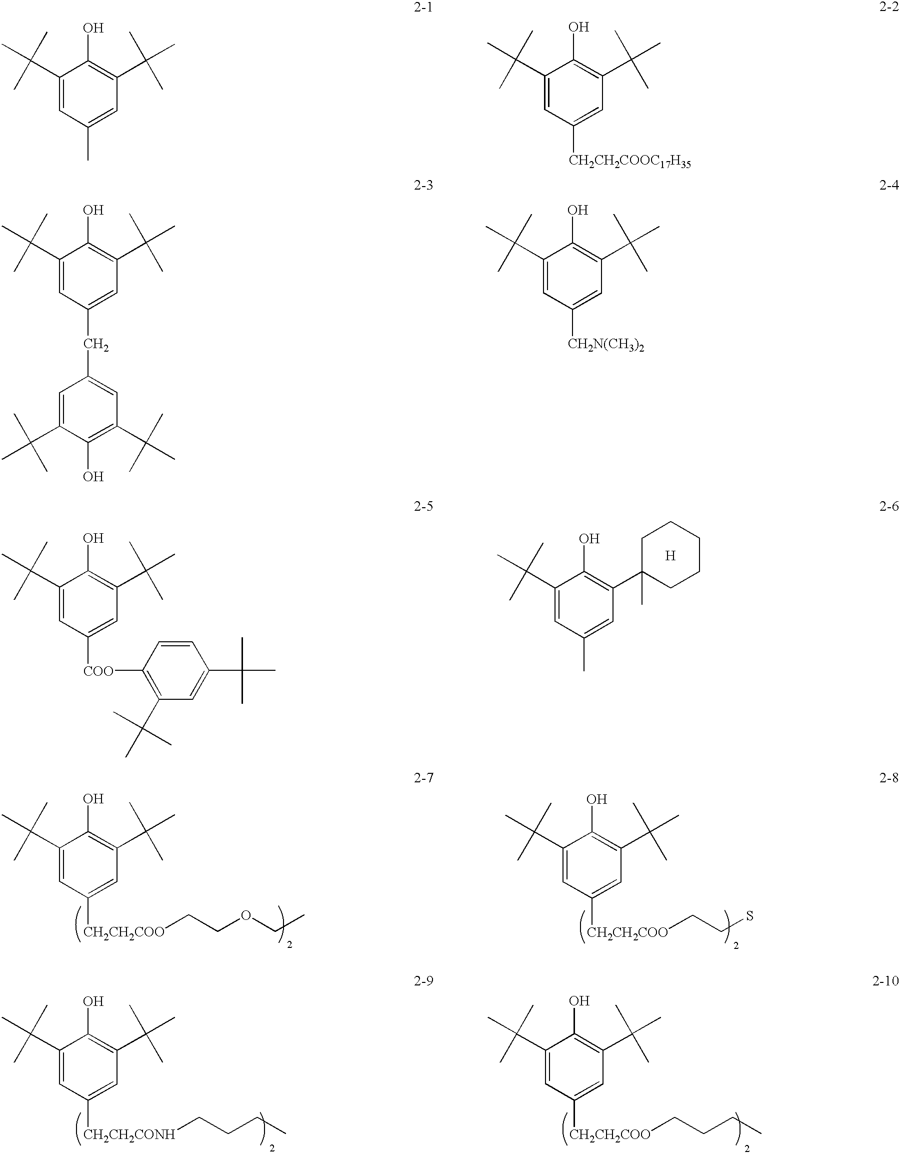

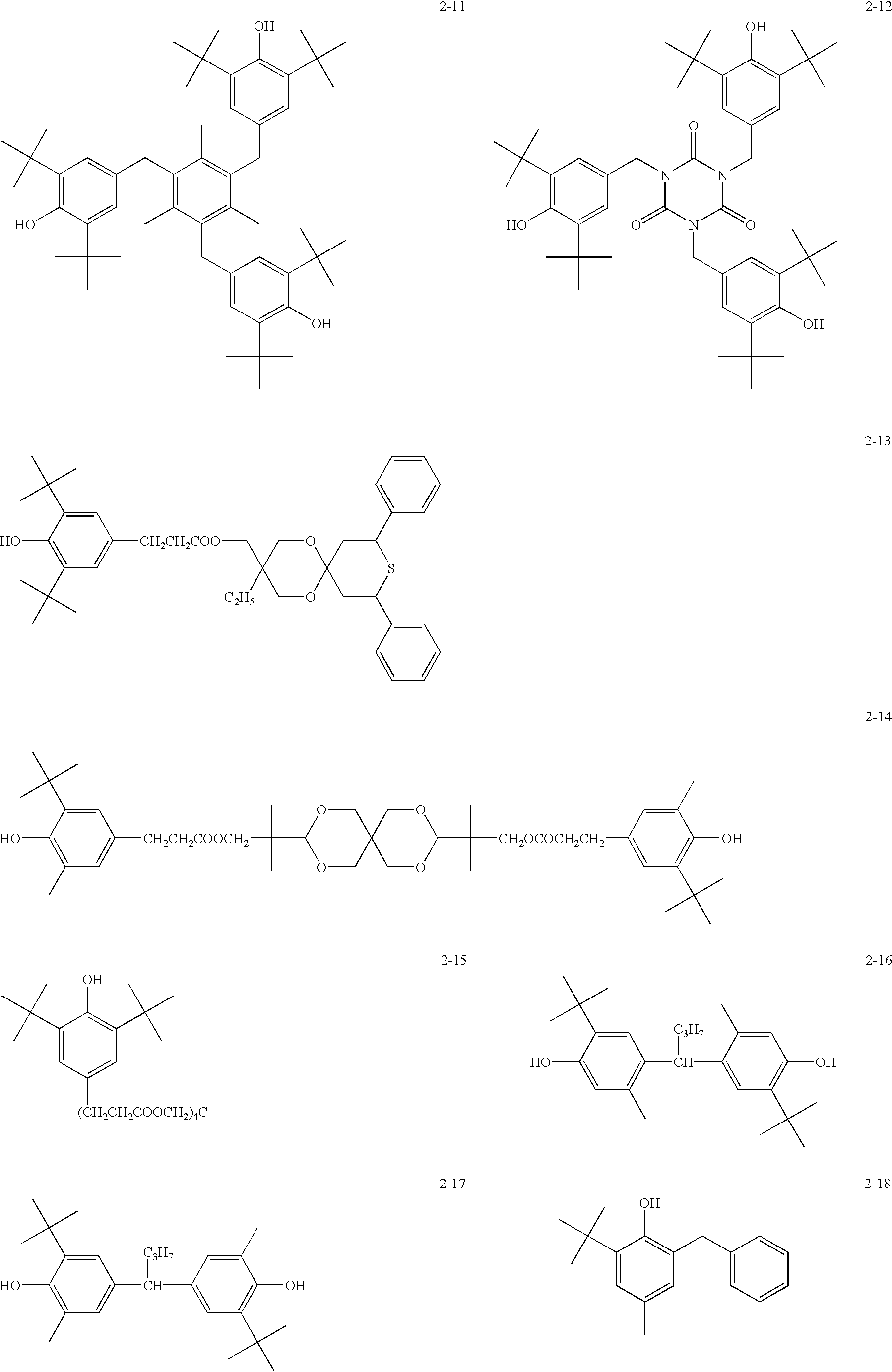

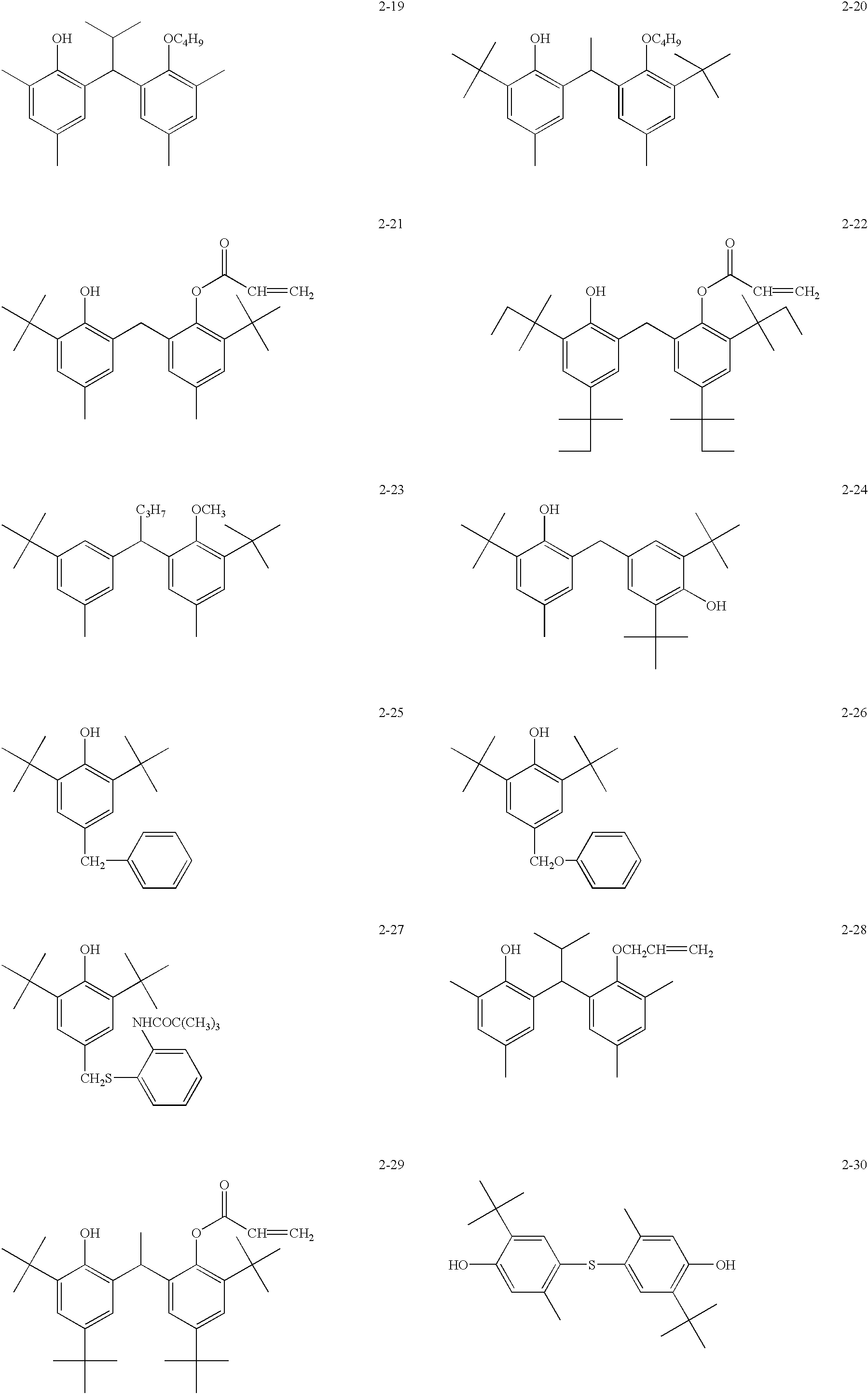

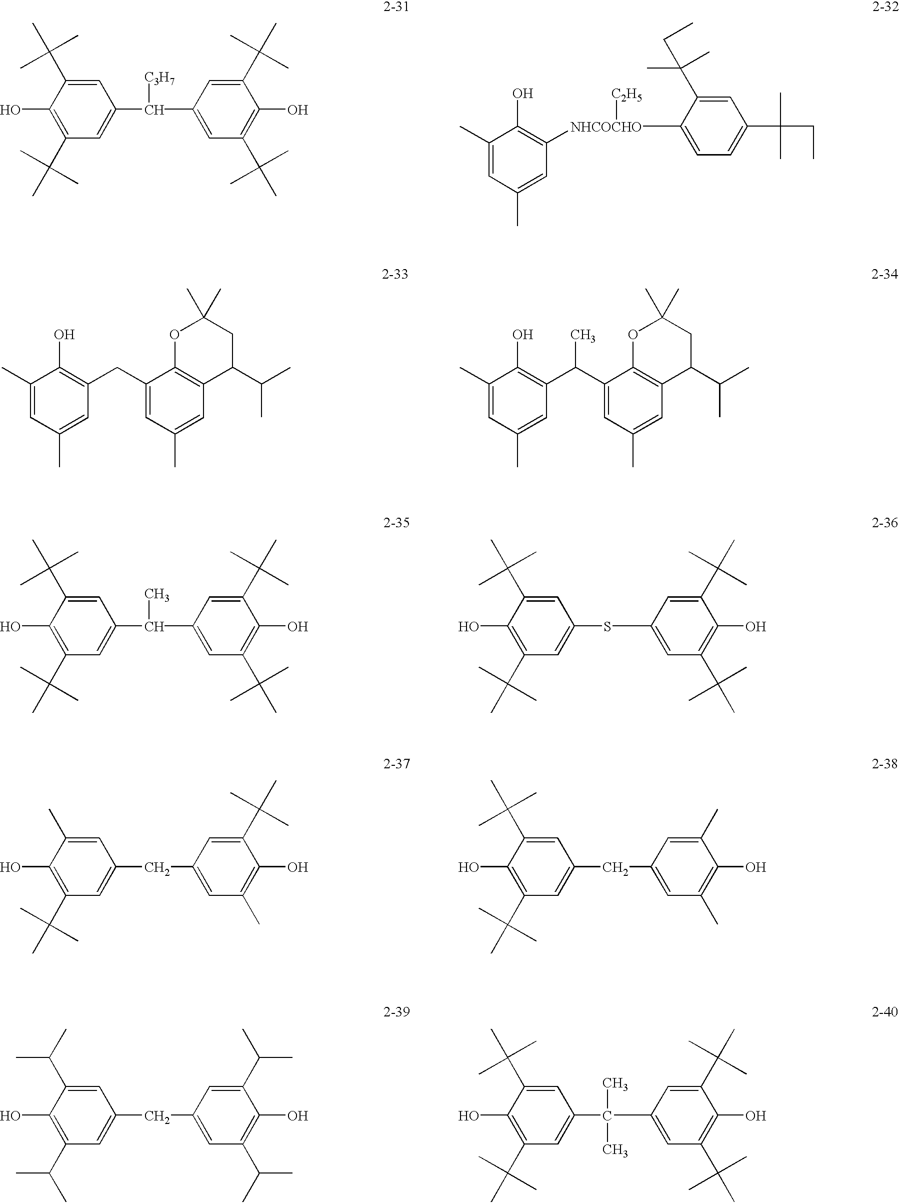

The compounds represented by general formulas (2) to (3) may each be contained in the coating solution or incorporated into the photosensitive material in any form, for example, in the form of a solution, an emulsified dispersion or a fine solid grain dispersion.

Examples of the emulsification dispersion methods include a method of dissolving the reducing agent using an oil such as dibutyl phthalate, tricresyl phosphate, glyceryl triacetate or diethyl phthalate, or an auxiliary solvent such as ethyl acetate or cyclohexanone, and mechanically preparing an emulsified dispersion.

The fine solid grain dispersion methods include a method of dispersing each of the compounds represented by general formulas (2) to (3) in the powder form in an appropriate solvent such as water using a ball mill, a vibrating ball mill, a sand mill, a jet mill, a roller mill or an ultrasonic wave, thereby manufacturing a solid dispersion. At this time, a protective colloid (for example, polyvinyl alcohol) or a surfactant (for example, an anionic surfactant such as sodium triisopropylnaphthalenesulfonate (a mixture of compounds in which three isopropyl groups are substituted at different positions)) may be used. In the case of an aqueous dispersion, an antiseptic (for example, benzoisothiazolinone sodium salt) can be incorporated into the aqueous dispersion.

It is preferred that the compounds represented by general formulas (2) to (3) are each added to an organic silver salt-containing image formation layer. However, one may be added to an image formation layer, and the other to a non-image formation layer adjacent thereto. When an image formation layer is composed of a plurality of layers, each may be added to a different layer.

The added amount ratio of the compound represented by general formula (2) (hindered phenol compound) to the compound represented by general formula (R) (polyphenol linked at the o-position)(the compound represented by general formula (2) (mol)/the compound represented by general formula (R) (mol)) is preferably from 0.001 to 0.2, more preferably from 0.005 to 0.1, and still more preferably from 0.008 to 0.05. The added amount ratio of the compound represented by general formula (3) to the compound represented by general formula (R) is also the same as this.

Then, the light-insensitive organic silver salt grain (hereinafter simply referred to as “organic silver salt”) will be described below.

The organic silver salt is preferably a silver salt which is relatively stable to light, but forms a silver image when heated at 80° C. or more in the presence of an exposed photocatalyst (such as a latent image of a light-sensitive silver halide) and a reducing agent. The organic silver salt may be an arbitrary organic substance containing a source capable of reducing a silver ion.

However, the first embodiment of the present invention is characterized by that silver behenate is contained in an amount of 53 mol % to 85 mol %, preferably 55 mol % to 75 mol %, particularly preferably 60 mol % to 75 mol %.

The second embodiment of the present invention is characterized by that silver behenate is contained in an amount of40 mol % to 90 mol %, preferably 50 mol % to 85 mol %, particularly preferably 53 mol % to 85 mol %.

The third embodiment of the present invention is characterized by that silver behenate is contained in an amount of 53 mol % to 80 mol %, preferably 55 mol % to 75 mol %, particularly preferably 60 mol % to 75 mol %.

As silver salts of organic acids other than that, a silver salt of a long chain aliphatic carboxylic acid (having from 10 to 30 carbon atoms, preferably from 15 to 28 carbon atoms) is particularly preferred. A complex of an organic or inorganic silver salt in which a ligand has a complex stability constant of 4.0 to 10.0 is also preferred. Such light-insensitive organic silver salts are described in Japanese Patent Laid-Open No. 62899/1998 (paragraph numbers. 0048to 0049), EP-A-0803764 (page 18, line 24 to page 19, line 37), EP-A-0962812, Japanese Patent Laid-Open Nos. 349591/1999, 7683/2000 and 72711/2000. Preferred examples of the organic silver salts include silver salts of carboxyl group-containing organic compounds. Examples thereof include but are not limited to silver salts of aliphatic carboxylic acids and silver salts of aromatic carboxylic acids. Preferred examples of the silver salts of aliphatic carboxylic acids include silver arachidate, silver stearate, silver oleate, silver laurate, silver caproate, silver myristate, silver palmitate, silver maleate, silver fumarate, silver tartrate, silver linoleate, silver butyrate, silver camphorate and mixtures thereof, as well as silver behenate. The organic silver salt as a silver-supplying substance can constitute preferably about 5% to about 30% by weight of the image formation layer.

There is no particular limitation on the form of the organic silversalt, and it maybe cubic, rectangular, rod-like, acicular, tabular or scaly. Above all, cubic, rectangular, rod-like, and acicular organic silver salts are relatively preferred. The cubic, rectangular, rod-like, and acicular organic silver salts are defined as follows. The organic acid silver salt is observed under an electron microscope, and the form of an organic silver salt grain is approximated to a rectangular parallelepiped. The sides of this rectangular parallelepiped are taken as a, b and c from the shortest one (a≦b≦c). The cubic grain means a grain within the range of 0.9≦a/c≦1.0. The rectangular grain means a grain within the range of 0.2≦a/c<0.9 and 0.2≦b/c<1.0. The rod-like grain means a grain within the range of 0.1≦a/c<0.2 and 0.1≦b/c<0.3. The acicular grain means a grain within the range of a/c<0.1 and b/c<0.1. As for the form of the organic silver salt in the invention, the acicular or rod-like grain is preferred, and the acicular grain is most preferred.

It is preferred that the grain size of the organic silver salt is small. This is because the relationship of reverse proportion between the size of a silver salt crystal grain and covering power is well known in the field of silver halide photographic materials, this relationship holds also in the heat-developable photosensitive material of the invention, and an increase in size of the organic silver salt grains, an image formation portion of the heat-developable photosensitive material, means low covering power and a reduction in image density. Specifically, the grain size of the organic silver salt is preferably from 0.01 μm to 0.20 μm for the short axis, and from 0.10 μm to 5.0 μm for the long axis, and more preferably from 0.01 μm to 0.15 μm for the short axis, and from 0.10 μm to 4.0 μm for the long axis. It is preferred that the organic silver salt has monodisperse particle size distribution. The term “monodisperse” means that the percentage of a value of the standard deviation of each length of the short and long axes divided by each the short and long axes is preferably 100% or less, more preferably 80% or less, and still more preferably 50% or less.

The form of the organic silver salt can be determined from an image of an organic silver salt dispersion observed under a transmission electron microscope. As another method for measuring the monodispersibility, there is a method of determining the standard deviation of volume weighted average diameters of the organic silver salt. The percentage (the coefficient of variation) of values divided by volume weighted average diameters is preferably 100% or less, more preferably 80% or less, and still more preferably 50% or less. This can be determined, for example, from particle sizes (volume weighted average diameters) determined by irradiating laser light to the organic silver salt dispersed in a solution and determining the autocorrelation function to changes in fluctuation of its scattered light with time.

The grain formation of the organic silver salt is performed in a water solvent, and then, the grains are dried and dispersed in a solvent such as MEK. Drying is conducted in an air flow type flash jet dryer preferably at an oxygen partial pressure of 15 vol % or less, more preferably from 0.01 vol % to 15 vol %, still more preferably from 0.01 vol % to 10 vol %.

The organic silver salts can be used in a desired amount. However, they are used preferably in an amount of 0.1 to 5 g/m², and more preferably in an amount of 1 to 3 g/m², as an amount of silver coated.

In the third embodiment of the invention, the light-sensitive silver halide is subjected to infrared sensitization. This means that the light-sensitive silver halide is spectrally sensitized with a sensitizing dye in a wavelength region of 750 to 1400 nm. As the sensitizing dye used, a known compound can be used. For example, the light-sensitive silver halide can be spectrally advantageously sensitized with various known dyes including cyanine, merocyanine, styryl, hemicyanine, oxonol, hemioxonol and xanthene dyes. The useful cyanine dyes are, for example, dyes having basic nuclei such as a thiazoline nucleus, an oxazoline nucleus, a pyrroline nucleus, a pyridine nucleus, an oxazole nucleus, a thiazole nucleus, a selenazole nucleus and an imidazole nucleus. Preferred examples of the useful merocyanine dyes include merocyanine dyes having acidic nuclei such as a thiohydantoin nucleus, a rhodanine nucleus, an oxazolidinedione nucleus, a thiazolinedione nucleus, a barbituric acid nucleus, a thiazolinone nucleus, a malononitrile nucleus and a pyrazolone nucleus, in addition to the above-mentioned basic nuclei. In the above-mentioned cyanine and merocyanine dyes, ones having imino groups or carboxyl groups are particularly effective. They may be appropriately selected from known dyes described in U.S. Pat. Nos. 3,761,279, 3,719,495, 3,877,943 and 5,541,054, British Patents 1,466,201, 1,469,117 and 1,422,057, Japanese Patent Publication Nos. 10391/1991 and 52387/1994, Japanese Patent Laid-Open Nos. 341432/1993, 194781/1994, 301141/1994, 166844/1997, 95958/2000, 171938/2000, 227642/2000, 250166/2000, 258870/2000, 83655/2001 and 316437/1999.

The sensitizing dyes used for spectrally sensitizing the light-sensitive silver halide may be used either alone or as a combination of two or more of them. In the invention, the sensitizing dyes are added to the silver halide emulsions preferably from after desalting to coating, and more preferably from after desalting to before the start of chemical ripening. The sensitizing dyes can be used in a desired amount depending on performances such as sensitivity and fog. However, they are used preferably in an amount of 10⁻⁶ to 1 mol, and more preferably in an amount of 10⁻⁴ to 10⁻¹ mol, per mol of silver halide of the light-sensitive layer.

For improving spectral sensitization efficiency, supersensitizing agents can be used in the light-sensitive silver halides. The supersensitizing agents used in the invention include compounds described in EP-A-587,338, U.S. Pat. Nos. 3,877,943 and 4,873,184, Japanese Patent Laid-Open Nos. 341432/1993, 109547/1999 and 111543/1998.

Specific examples of the infrared sensitizing dyes for infrared sensitizing the light-sensitive silver halides are shown below, but the invention is not limited to these specific examples. In the specific examples, P-Ts⁻indicates a paratoluenesulfonic acid ion.

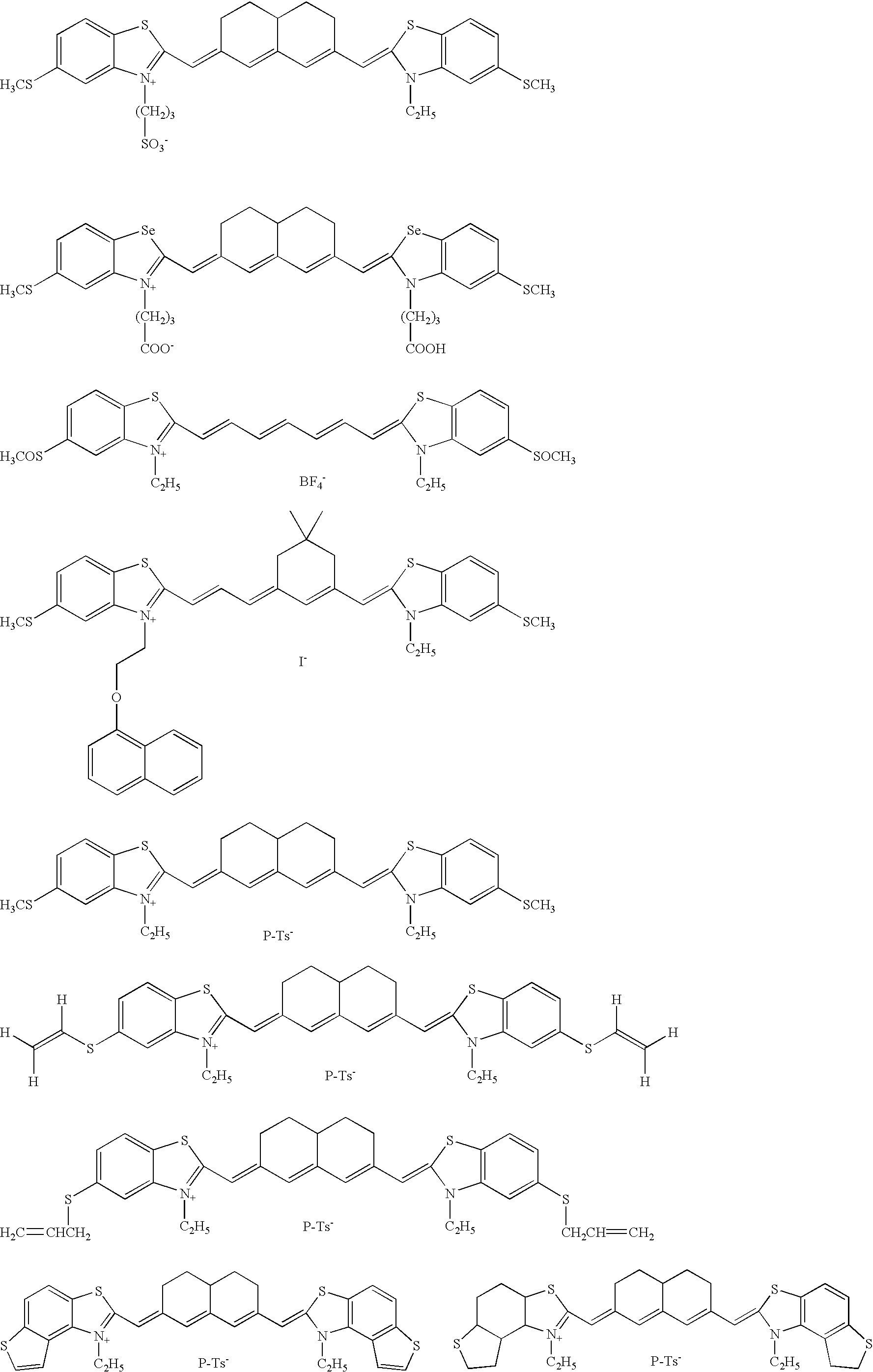

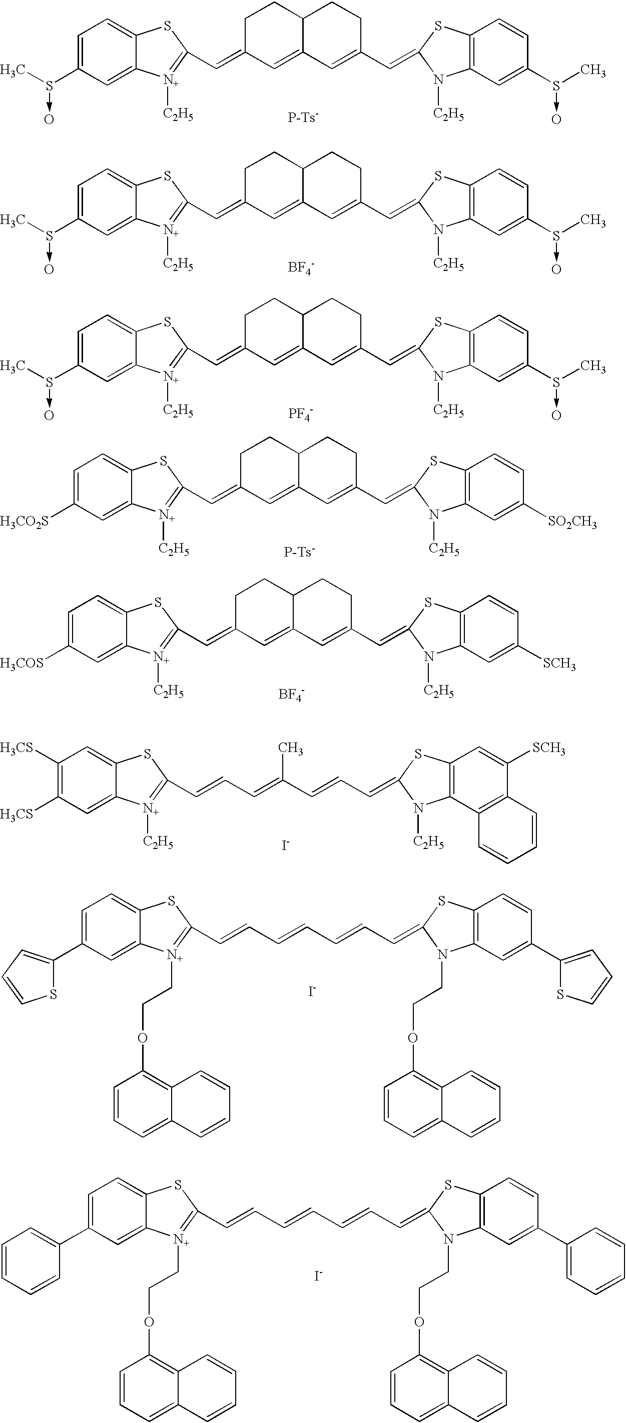

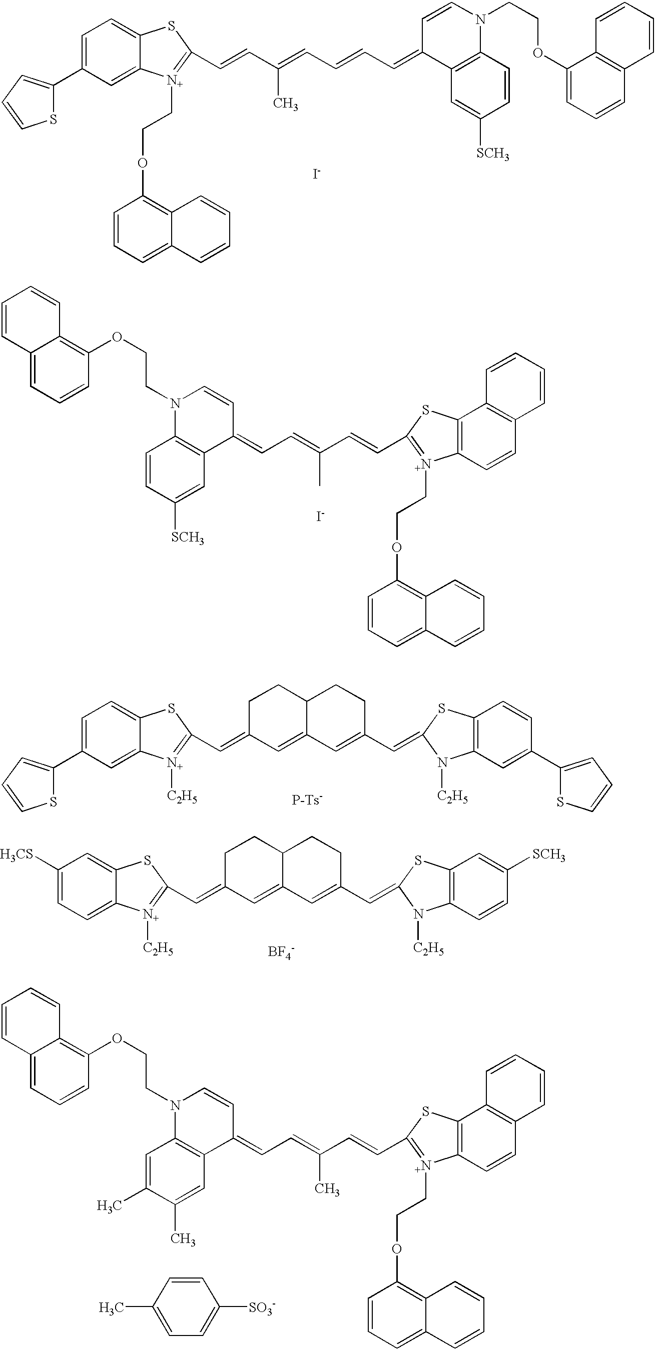

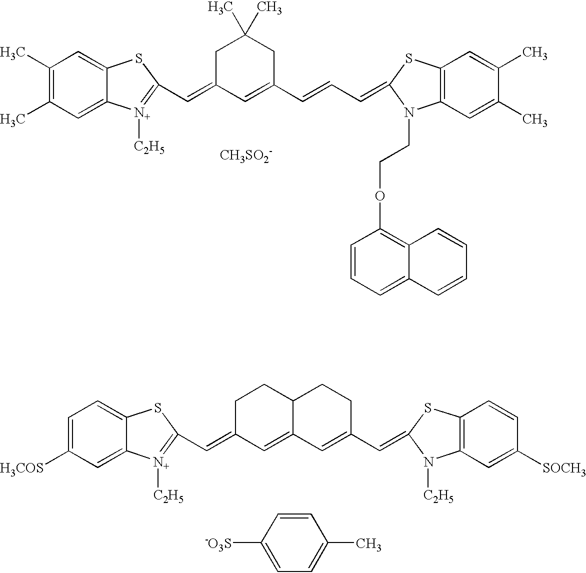

In addition, suitable additives, layer constitution of the photosensitive materials and the like will be described below.

In the heat-developable photosensitive material of the invention, a phenol derivative represented by formula (A) described in Japanese Patent Application No. 73951 /1999 also is preferably used as a development accelerator.

In the heat-developable photosensitive material of the invention, when the reducing agent has an aromatic hydroxyl group (—OH), particularly, in the case of a bisphenol, a non-reducing compound having a group capable of forming a hydrogen bond with the hydroxyl group is preferably used in combination therewith. In case that the polyphenol compound represented by formula (R), a nonreducing compound is preferably combined. Examples of the groups each capable of forming a hydrogen bond with the hydroxyl group (or an amino group) include a phosphoryl group, a sulfoxide group, a sulfonyl group, a carbonyl group, an amido group, an ester group, aurethane group, a ureido group, a tertiary amino group and a nitrogen-containing aromatic group. Of these, preferred is a compound having a phosphoryl group, a sulfoxide group, an amido group (provided that this has no >N-H group but is blocked as >N-Ra (wherein Ra is a substituent group excluding H)), a urethane group (provided that this has no>N-H group but is blocked as —N-Ra (wherein Ra is a substituent group excluding H)) or a ureido group (provided that this has no >N-H group but is blocked as —N-Ra (wherein Ra is a substituent group excluding H)).

In the invention, the hydrogen bond-forming compound is particularly preferably a compound represented by the following general formula (4):

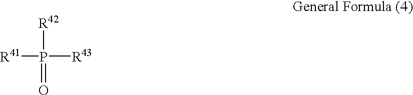

In general formula (4), R⁴¹ to R⁴³ each independently represents an alkyl group, an aryl group, an alkoxyl group, an aryloxy group, an amino group or a heterocyclic group, and these groups may each be unsubstituted or may each have a substituent group. When R⁴¹ to R⁴³ have substituent groups, examples of the substituent groups include a halogen atom, an alkyl group, an aryl group, an alkoxyl group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group, and preferred are an alkyl group and an aryl group. Examples thereof include methyl, ethyl, isopropyl, t-butyl, t-octyl, phenyl, 4-alkoxyphenyl and 4-acyloxyphenyl.

Specific examples of the alkyl groups represented by R⁴¹ to R⁴³ in general formula (4) include methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl.

Examples of the aryl groups represented by R⁴¹ to R⁴³ in general formula (4) include phenyl, cresyl, xylyl, naphthyl, 4-t-butylphenyl, 4-t-octylphenyl, 4-anisidyl and 3,5-dichlorophenyl. Preferred are phenyl and 4-t-butylphenyl, and particularly preferred is 4-t-butylphenyl.

Examples of the alkoxyl groups represented by R⁴¹ to R⁴³ in general formula (4) include methoxy, ethoxy, butoxy, octyloxy, 2-ethylhexyloxy, 3,5, 5-trimethylhexyloxy, dodecyloxy, cyclohexyloxy, 4-methylcyclohexyloxy and benzyloxy.

Examples of the aryloxy groups represented by R⁴¹ to R⁴³ in general formula (4) include phenoxy, cresyloxy, isopropylphenoxy, 4-t-butylphenoxy, naphthoxy and biphenyloxy.

Examples of the amino groups represented by R⁴¹ to R⁴³ in general formula (4) include dimethylamino, diethylamino, dibutylamino, dioctylamino, N-methyl-N-hexylamino, dicyclohexylamino, diphenylamino and N-methyl-N-phenylamino.

Examples of the heterocyclic groups represented by R⁴¹ to R⁴³ in general formula (4) include pyridyl, pyrimidyl and triaridyl.

In general formula (4), R⁴¹ to R⁴³ are each preferably an alkyl group, an aryl group, an alkoxyl group or an aryloxy group. In view of the effect of the invention, at least one of R⁴¹ to R⁴³ is preferably an alkyl group or an aryl group, and more preferably, two or more thereof are alkyl groups or aryl groups. In respect to the availability at low cost, R⁴¹ to R⁴³ are all the same group.

Specific examples of the hydrogen bond-forming compounds including the compounds represented by formula (4) are set forth below, but the invention is not limited thereto.

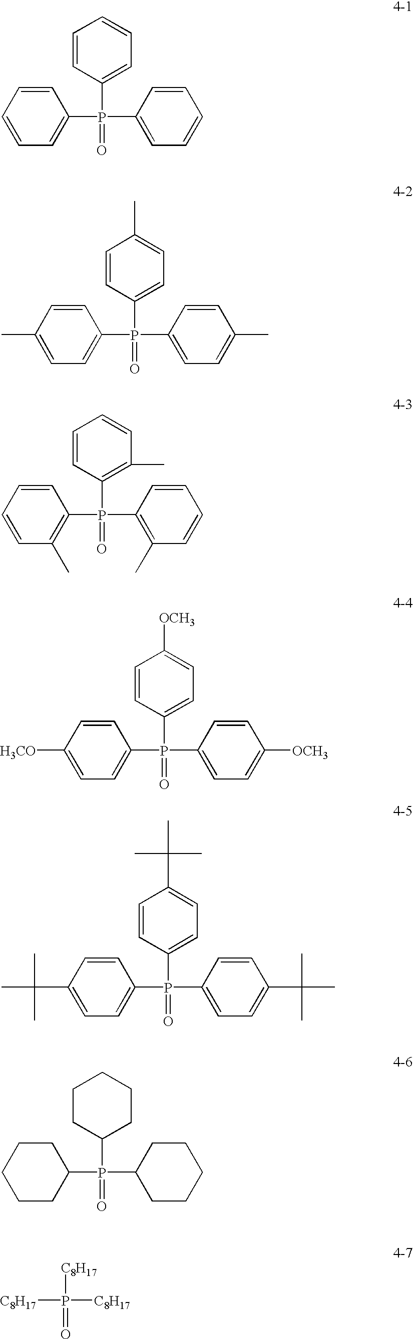

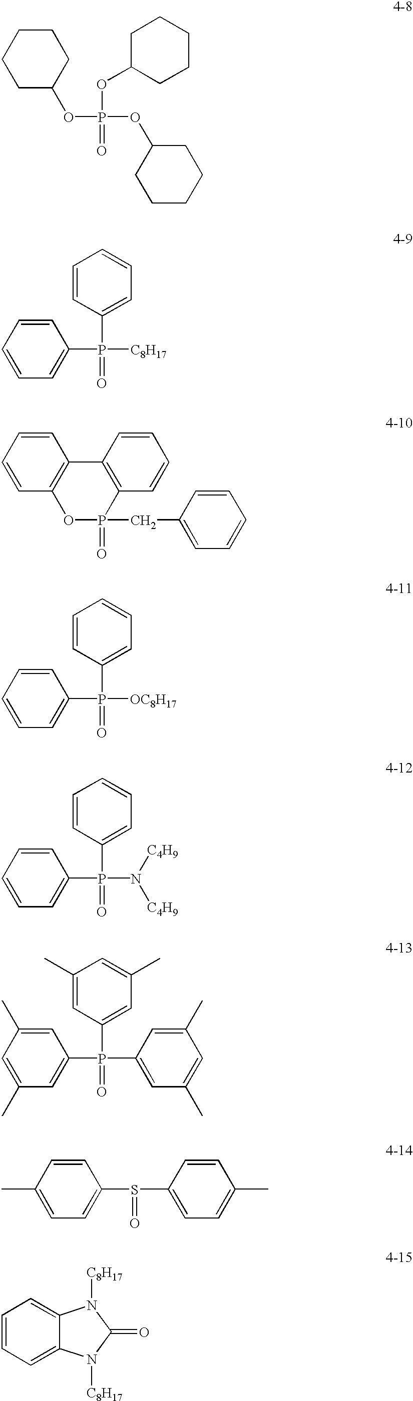

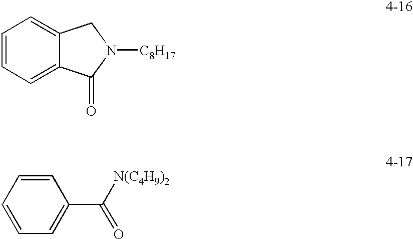

In addition to these compounds, specific examples of the hydrogen bond-forming compounds include those described in Japanese Patent Application Nos. 192191/2000 and 194811/2000.

The hydrogen bond-forming compound (compound represented by general formula (4)) is incorporated into a coating solution and used in the photosensitive material, similarly to the reducing agent, in the form of a solution, an emulsified dispersion or a solid fine grain dispersion. In the solution state, the hydrogen bond-forming compound forms a hydrogen bond-forming complex with a compound having a phenolic hydroxyl group or an amino group, and depending on the combination of the reducing agent and the hydrogen bond-forming compound, the complex can be isolated in the crystal state. Use of the thus-isolated crystal powder as a fine solid grain dispersion is particularly preferred for attaining stable performance. Furthermore, a method of mixing the reducing agent and the hydrogen bond-forming compound in the powder form, and forming a complex in dispersing in a sand grinder mill or the like using an appropriate dispersing agent is also preferably used.

The hydrogen bond-forming compound (compound represented by general formula (4)) is preferably used in the range from 1 to 200 mol %, more preferably from 10 to 150 mol %, and still more preferably from 30 to 100 mol %, based on the reducing agent.

From the viewpoint of inhibiting or accelerating development to control the development, it is preferred that at least one compound selected from the group consisting of a heteroaromatic mercapto compound and a heteroaromatic disulfide compound is contained in a layer on the side of a face containing the light-sensitive silver halide on the support.

As the heteroaromatic mercapto compound, preferred is a compound represented by Ar-SM, wherein M is a hydrogen atom or an alkali metal atom, and Ar is an aromatic ring or a condensed aromatic ring containing at least one nitrogen atom, sulfur atom, selenium atom or tellurium atom. The heteroaromatic ring is preferably benzimidazole, naphthimidazole, benzothiazole, naphthothiazole, benzoxazole, naphthoxazole, benzoselenazole, benzotetrazole, imidazole, oxazole, pyrazole, triazole, thiadiazole, tetrazole, triazine, pyrimidine, pyridazine, pyrazine, pyridine, purine, quinoline or quinazolinone, and more preferably benzimidazole, benzothiazole, benzoxazole or benzotetrazole. Further, the heteroaromatic ring may have, for example, a substituent group selected from the group consisting of halogen (for example, Br or Cl), hydroxyl, amino, carboxyl, alkyl (for example, one having 1 or more carbon atoms, preferably from 1 to 4 carbon atoms), alkoxyl (for example, one having 1 or more carbon atoms, preferably from 1 to 4 carbon atoms) and aryl (which may have a substituent group).

The heteroaromatic mercapto compounds include but are not limited to 2-mercaptobenzimidazole, 2-mercaptobenzoxazole, 2-mercaptobenzothiazole, 2-mercapto-5-methylbenzimidazole, 6-ethoxy-2-mercaptobenzothiazole, 2,2′-dithiobis(benzothiazole), 3-mercapto-1,2,4-triazole, 4,5-diphenyl-2-imidazolethiol, 2-mercaptoimidazole, 1-ethyl-2-mercaptobenzimidazole, 2-mercaptoquinoline, 8-mercaptopurine, 2-mercapto-4(3H)-quinazolinone, 7-trifluoromethyl-4-quinolinethiol, 2,3,5,6-tetrachloro-4-pyridinethiol, 4-amino-6-hydroxy-2-mercaptopyrimidine monohydrate, 2-amino-5-mercapto-1,3,4-thiadiazole, 3-amino-5-mercapto-1,2,4-triazole, 4-hydroxy-2-mercaptopyrimidine, 2-mercaptopyrimidine, 4,6-diamino-2-mercaptopyrimidine, 2-mercapto-4-methylpyrimidine hydrochloride, 3-mercapto-5-phenyl-1,2,4-triazole, 1-phenyl-5-mercaptotetrazole, sodium 3-(5-mercaptotetrazole)benzenesulfonate, N-methyl-N′-[3-(5-mercaptotetrazolyl)phenyl]urea and 2-mercapto-4-phenyl-oxazole.

The amount of the heteroaromatic mercapto compound added is preferably from 0.001 to 1 mol, and more preferably from 0.003 to 0.1 mol, per mol of silver in an emulsion layer. The term “mol of silver” as used herein means “mol of silver halide”.

As the heteroaromatic disulfide compound, preferred is a compound represented by Ar-S-S-Ar, wherein Ar is an aromatic ring or a condensed aromatic ring containing at least one nitrogen atom, sulfur atom, selenium atom or tellurium atom.

The heteroaromatic ring is preferably benzimidazole, naphthimidazole, benzothiazole, naphthothiazole, benzoxazole, naphthoxazole, benzoselenazole, benzotetrazole, imidazole, oxazole, pyrazole, triazole, thiadiazole, tetrazole, triazine, pyrimidine, pyridazine, pyrazine, pyridine, purine, quinoline or quinazolinone, and more preferably benzimidazole, benzothiazole, benzoxazole or benzotetrazole.

The heteroaromatic ring may have, for example, a substituent group selected from the group consisting of halogen (for example, Br or Cl), hydroxyl, amino, carboxyl, alkyl (for example, one having 1 or more carbon atoms, preferably from 1 to 4 carbon atoms), alkoxyl (for example, one having 1 or more carbon atoms, preferably from 1 to 4 carbon atoms) and aryl (which may have a substituent group).

The amount of the heteroaromatic disulfide compound added is preferably from 0.001 to 1 mol, and more preferably from 0.003 to 0.1 mol, per mol of silver in an emulsion layer. The term “mol of silver” as used herein means “mol of silver halide”.

It is preferred that the heat-developable light-sensitive material of the invention contains a color toning agent. The color toning agents are described in Japanese Patent Laid-Open No. 62899/1998, paragraph numbers 0054 to 0055, EP-A-0803764, page 21, lines 23 to 48 and Japanese Patent Application No.213487/2000. Preferred are phthalazinone compounds (phthalazinone, phthalazinone derivatives or metal salts thereof, for example, 4-(1-naphthyl)phthalazinone, 6-chlorophthalazinone, 5,7-dimethoxyphthalazinone and 2,3-dihydro-1,4-phthalazinedione); combinations of phthalazinone compounds and phthalic acid compounds (for example, phthalic acid, 4-methylphthalic acid, 4-nitrophthalic acid and tetrachlorophthalic acid anhydride); phthalazine compounds (phthalazine, phthalazine derivatives or metal salts thereof, for example, 4-(1-naphthyl)phthalazine, 6-isopropyl-phthalazine, 6-t-butylphthalazine, 6-chlorophthalazine, 5, 7-dimethoxyphthalazine and 2,3-dihydrophthalazine); and combinations of phthalazine compounds and phthalic acid compounds. In particular, combinations of phthalazine compounds and phthalic acid compounds are preferred. The color toning agent is contained in a layer on the side of a face having the image formation layer preferably in an amount of 0.1 to 50 mol %, and more preferably in an amount of 0.5 to 20 mol %, per mol of silver.

In the heat-developable light-sensitive material of the invention, the silver halide emulsion and/or the organic silver salt is further protected from the additional development of fog by an antifoggant, a stabilizer and a stabilizer precursor and can be stabilized against a reduction in sensitivity during stock storage. The suitable antifoggants, stabilizers and stabilizer precursors, which can be used either alone or in combination, include thiazonium salts described in U.S. Pat. Nos. 2,131,038 and 2,694,716, azaindene described in U.S. Pat. Nos. 2,886,487 and 2,444,605, compounds described in Japanese Patent Laid-Open No. 329865/1997 and U.S. Pat. No. 6,083,681, mercury salts described in U.S. Pat. No. 2,728,663, urazole described in U.S. Pat. No. 3,287,135, sulfocatechol described in U.S. Pat. No. 3,235,652, oximes, nitrones and nitroindazoles described in British Patent 623,448, multivalent metal salts described in U.S. Pat. No. 2,839,405, thiuronium salts described in U.S. Pat. No. 3,220,839, palladium, platinum and gold salts described in U.S. Pat. Nos. 2,566,263 and 2,597,915, halogen-substituted organic compounds described in U.S. Pat. Nos. 4,108,665 and 4,442,202, triazine described in U.S. Pat. Nos. 4,128,557, 4,137,079, 4,138,365 and 4,459,350, and phosphorus compounds described in U.S. Pat. No. 4,411,985.

As the antifoggants, organic halogen compounds are suitable. A polyhalomethyl compound, particularly a trihalomethylsulfone is preferred among others. The organic halogen compounds include, for example, compounds disclosed in Japanese Patent Laid-Open Nos. 119624/1975, 120328/1975, 121332/1976, 58022/1979, 70543/1981, 99335/1981, 90842/1984, 129642/1986, 129845/1987, 208191/1994, 5621/1995, 2781/1995, 15809/1996, 160167/1997, 244177/1997, 244178/1997, 258367/1997, 265150/1997, 319022/1997, 171063/1998, 212211/1999, 231460/1999, 242304/1999, U.S. Pat. Nos. 5,340,712, 5,369,000 and 5,464,737, and specific examples thereof include 2-(tribromomethylsulfone)quinoline, 2-(tribromomethylsulfone)pyridine, tribromomethylphenylsulfone and tribromomethylnaphthylsulfone.

In the heat-developable photosensitive material of the invention, a mercury (II) salt is advantageously added to the light-sensitive layer as an antifoggant in some cases. The mercury (II) salt suitable for this purpose is mercury acetate or mercury bromide. Mercury used in the invention is added preferably in an amount of 1 nanomol (nmol) to 1 millimol (mmol), and more preferably in an amount of 10 nanomols (nmol) to 100 micromols (μmol), per mol of silver.

The heat-developable photosensitive material of the invention may contain a benzoic acid compound for increasing sensitivity and preventing fog. As the benzoic acid compound, there can be used any benzoic acid derivative. Preferred structural examples thereof include compounds described in U.S. Pat. Nos. 4,784,939and4,152,160, Japanese Patent Laid-Open Nos. 281687/1997, 329864/1997 and 329865/1997. Although the benzoic acid compound used in the invention may be added to any site of the photosensitive material, it is preferably added to a layer on the side of a face having the light-sensitive layer, and more preferably to the organic silver salt-containing layer. The benzoic acid compound may be added in any stage in the preparation of the coating solution. When added to the organic silver salt-containing layer, the benzoic acid compound may be added in any stage from the preparation of the organic silver salt to the preparation of the coating solution. However, it is preferably added from after the preparation of the organic silver salt to immediately before coating. The benzoic acid compound may be added in any form, for example, in the form of a powder, a solution or a fine grain dispersion. Further, it may be added as a solution in which it is mixed with another additive such as a sensitizing dye, a reducing agent or a color toning agent. Although the amount of the benzoic acid compound added may be any, it is preferably from 1 micromol (μmol) to 2 mols )mol), and more preferably from 1 millimol (mmol) to 0.5 mol (mol), per mol of silver.

The heat-developable photosensitive material can contain a plasticizer and a lubricant. The plasticizers and lubricants which can be used in the light-sensitive layer are described in Japanese Patent Laid-Open No. 65021/1999 (paragraph number 0117); ultrahigh contrast-providing agents for the formation of ultrahigh contrast images, methods for adding the same and the amount thereof are described in Japanese Patent Laid-Open No. 65021/1999 (paragraph number 0118), Japanese Patent Laid-Open No. 223898/1999 (paragraph numbers 0136 to 0193), compounds represented by formula (H), formulas (1) to (3) and formulas (A) and (B) of Japanese Patent Application No. 87297/1999, and compounds represented by formulas (III) to (V) (specific compounds: KA (Chem.) 21 to KA (Chem.) 24) of Japanese Patent Application No. 91652/1999; and contrast-promoting agents are described in Japanese Patent Laid-Open No. 654021/1999 (paragraph number 0102) and Japanese Patent Laid-Open No. 223898/1999 (paragraph numbers 0194 to 0195).

In the heat-developable photosensitive material of the invention, the absorption at the exposure wavelength of the light-sensitive silver halide grain-containing layer is preferably from 0.1 to 0.6, and more preferably from 0.2 to 0.5. Higher absorption results in an increase in Dmin to cause difficulty in distinguishing an image, whereas lower absorption results in impaired sharpness in some cases. In the invention, the absorption may be given to the light-sensitive silver halide layer by any method. However, a dye is preferably used. The dye may be any as long as it meets the above-mentioned absorption requirements. Examples thereof include a pyrazoloazole dye, an anthraquinone dye, an azo dye, an azomethine dye, an oxonol dye, a carbocyanine dye, a styryl dye, a triphenylmethane dye, an indoaniline dye, an indophenol dye and a squalirium dye. Preferred examples of the dyes used in the invention are anthraquinone dyes (for example, compounds 1 to 9 described in Japanese Patent Laid-Open No. 341441/1993, and compounds 3-6 to 18 and 8-23 to 38 described in Japanese Patent Laid-Open No. 165147/1993), azomethine dyes (compounds 17 to 47 described in Japanese Patent Laid-Open No. 341441/1993), indoaniline dyes (for example, compounds 11 to 19 described in Japanese Patent Laid-Open No. 289227/1993, compound 47 described in Japanese Patent Laid-Open No. 341441/1993, and compounds 2-10 to 11 described in Japanese Patent Laid-Open No. 165147/1993), azo dyes (compounds 10 to 16 described in Japanese Patent Laid-Open No.341441/1993) and squalirium dyes (compounds 1 to 20 described in Japanese Patent Laid-Open No. 104779/1998, and compounds 1a to 3d described in U.S. Pat. No. 5,380,635). These dyes may be added in any form, for example, in the form of a solution, emulsion or a fine solid grain dispersion, or in the state mordanted with a polymer mordant. The amount of these compounds used is determined depending on the desired absorbed amount thereof. However, it is preferred that the compound is generally used within the range from 1 μg to 1 g per m².

In the heat-developable photosensitive material of the invention, the absorption at the exposure wavelength of any portion other than the light-sensitive silver halide grain-containing layer is preferably from 0.1 to 3.0, and more preferably from 0.3 to 2.0 in respect to halation prevention. The portion having absorption at the exposure wavelength is preferably a layer opposite to the light-sensitive silver halide grain-containing layer across the support (a back layer, an undercoat or underlayer on a back layer, or a protective layer for the back layer), or between the light-sensitive silver halide grain-containing layer and the support (an undercoat or underlayer).

In the invention, a portion other than the light-sensitive silver halide grain-containing layer may be allowed to have absorption by any method, and the absorption maximum in the visible region is preferably 0.3 or less. Dyes used for coloring are the same as the dyes which can be used for giving the absorption to the light-sensitive silver halide layer, and may be identical to or different from the dyes used in the light-sensitive silver halide layer.

When light-sensitive silver halide grains are spectrally sensitized in the visible region, a portion other than the light-sensitive silver halide grain-containing layer may be allowed to have absorption by any method. However, a dye decolorizable by heat treatment or a combination of a compound decolorizing a dye and the dye decolorized by heat treatment is preferably used. Examples of the colored layers to be decolorized are described in Japanese Patent Laid-Open Nos. 139136/1977, 132334/1978, 501480/1981, 16060/1982, 68831/1982, 101835/1982, 182436/1984, 36145/1995 and 199409/1995, Japanese Patent Publication Nos. 38692/1973, 16648/1975 and 41734/1990, U.S. Pat. Nos. 4,088,497, 4,283,487, 4,548,896 and 5,187,049. However, the invention is not limited to these. The amount of these compounds used is determined depending on the desired absorbed amount thereof. However, it is preferred that the compound is generally used within the range from 1 μg to 1 g per m².

In the heat-developable photosensitive material of the invention, the light-sensitive layers can contain various kinds of dyes and pigments (for example, C.I. Pigment Blue 60, C.I. Pigment Blue 64 and C.I. Pigment Blue 15:6) from the viewpoints of improvement in a color tone, prevention of the occurrence of interference fringes in laser exposure and prevention of irradiation. These are described in detail in W098/36322, Japanese Patent Laid-Open Nos. 268465/1998 and 338098/1999.

The heat-developable photosensitive materials have light-insensitive layers (image formation layers), in addition to the light-sensitive layers (non-image formation layers). The light-insensitive layers can be classified into four types: (1) a protective layer provided on the light-sensitive layer (on the side far away from the support), (2) an intermediate layer provided between the plurality of light-sensitive layers or between the light-sensitive layer and the protective layer, (3) an undercoat layer provided between the light-sensitive layer and the support, and (4) a back layer provided on the side opposite to the light-sensitive layer. The light-sensitive layer is provided with a filter layer as the layer of (1) or (2), and with an antihalation layer as the layer of (3) or (4). It is suitable to provide the antihalation layer to the light-sensitive layer on the side far away from a light source.

The antihalation layers are described in Japanese Patent Laid-Open Nos. 65021/1999, paragraph numbers 0123 to 0124, 223898/1999, 230531/1997, 36695/1998, 104779/1998, 231457/1999, 352625/1999 and 352626/1999.

The antihalation layer contains an antihalation dye having absorption at an exposure wavelength. When the exposure wavelength is in the infrared region, an infrared absorption dye is used, and in that case, a dye having no absorption in the visible region is preferably used.

When halation is prevented by using a dye having absorption in the visible region, it is preferred that the color of the dye does not substantially remain after image formation. For that purpose, a means of decolorizing the dye by heat of heat development is preferably used, and particularly, it is preferred that a heat decolorizing agent and a base precursor are added to the light-insensitive layer to allow it to act as an antihalation layer. These techniques are described in Japanese Patent Laid-Open No. 231457/1999.

The amount of the decolorizing dye added is determined depending on its purpose. In general, it is used in such an amount that an optical density (absorbance) exceeding 0.1 is given when measured at a desired wavelength. The optical density is preferably from 0.2 to 2. The amount of the dyes used for obtaining such optical density is generally from about 0.001 to about 1 g/m².

Such decolorization of the dyes allows the optical density after heat development to decrease to 0.1 or less. Two or more kinds of decolorizing dyes may be used together in a heat decolorization type recording material or the heat-developable photosensitive material. Similarly, two or more kinds of base precursors may be used together.

In heat decolorization using such decolorizing dyes and base precursors, it is preferred in terms of heat decolorizing properties that they are used in combination with substances (for example, diphenylsulfone and 4-chlorophenyl(phenyl)-sulfone) decreasing the melting point by 3° C. or more by mixing with the base precursors as described in Japanese Patent Laid-Open No. 352626/1999.

In the heat-developable photosensitive material of the invention, for improving the variation of silver tone images with the elapse of time, a coloring agent having the absorption maximum at 300 to 450 nm can be added. Such coloring agents are described in Japanese Patent Laid-Open Nos. 210458/1987, 104046/1988, 103235/1988, 208846/1988, 306436/1988, -314535/1988 and 61745/1989, and Japanese Patent Application No. 276751/1999.

Such a coloring agent is usually added in an amount ranging from 0.1 mg/m² to 1 g/m², and preferably added to a back layer provided on the side opposite to the light-sensitive layer.

The heat-developable photosensitive material of the invention can be provided with a surface protective layer for preventing adhesion of the light-sensitive layer (image formation layer). As a binder for the surface protective layer, there may be used any polymer. Although examples of the binders include a polyester, gelatin, polyvinyl alcohol and a cellulose derivative, the cellulose derivative is preferred. Examples of the cellulose derivatives include but are not limited to cellulose acetate, cellulose acetate butyrate, cellulose propionate, hydroxypropyl cellulose, hydroxypropylmethyl cellulose, methyl cellulose, hydroxyethyl cellulose, carboxymethyl cellulose and a mixture thereof. The thickness of the surface protective layer is preferably from 0.1 to 10 μm, and particularly preferably from 1 to 5 μm.

Any adhesion preventing material may be used in the surface protective layer. Examples of the adhesion preventing materials include wax, liquid paraffin, silica particles, a stylene-containing elastomeric block copolymer (for example, styrene-butadiene-styrene or styrene-isoprene-styrene), cellulose acetate, cellulose acetate butyrate, cellulose propionate and a mixture thereof.

In the heat-developable photosensitive material of the invention, the light-sensitive layer or the protective layer (surface protective layer) for the light-sensitive layer can contain a light absorbing substance and a filter dye as described in U.S. Pat. Nos. 3,253,921, 2,274,782, 2,527,583 and 2,956,879. Further, the dye can be mordanted as described in U.S. Pat. No. 3,282,699. The amount of the filter dye is preferably from 0.1 to 3, and particularly preferably from 0.2 to 1.5, by the absorbance at the exposure wavelength.

In the heat-developable photosensitive material of the invention, the light-sensitive layer or the protective layer (surface protective layer) for the light-sensitive layer can contain a delustering agent such as starch, titanium dioxide, zinc oxide, silica and bead-containing polymer beads as described in U.S. Pat. Nos. 2,992,101 and 2,701,245. The matte degree of an emulsion surface may be any, as long as no stardust trouble occurs. However, the Beck smoothness is preferably from 200 seconds to 10,000 seconds, and particularly preferably from 300 seconds to 10,000 seconds.

In the heat-developable photosensitive material of the invention, the image formation layer is constituted on the support as one or more layers. When constituted by one layer, the layer can contain the organic silver salt, the light-sensitive silver halide, the reducing agent and the binder, and optionally, additional materials such as the other auxiliary agents described above. When constituted by two or more layers, a first image formation layer (usually, a layer adjacent to the substrate) contains the organic silver salt and the light-sensitive silver halide, and a second image formation layer or both layers can contain some other components. A single light-sensitive layer containing all components and a two-layer structure containing a protective top coat (surface protective layer) are also considered. The structure of a multicolor-sensitive heat-developable photographic material may contain a combination of these two layers for each color, or all components in a single layer as described in U.S. Pat. No. 4,708,928. In the case of a multi-dye multicolor-sensitive heat-developable photographic material, respective emulsion layers are generally kept distinguished from each other by using a functional or nonfunctional barrier layer between respective light-sensitive layers, as described in U.S. Pat. No. 4,460,681.

It is preferred that the heat-developable photosensitive material of the invention is a so-called single-sided photosensitive material having at least one silver halide emulsion-containing light-sensitive layer on one side of the support and the back layer on the other side.

For improving the transferring properties, a matte agent is preferably added to the heat-developable photosensitive material of the invention. The matte agent is generally fine particles of a water-insoluble organic or inorganic compound. As the matte agent, there can be used any matte agent. For example, there can be used matte agents well known in the art, such as organic matte agents described in U.S. Pat. Nos. 1,939,213, 2,701,245, 2,322,037, 3,262,782, 3,539,344 and 3,767,448, and inorganic matte agents described in U.S. Pat. Nos. 1,260,772, 2,192,241, 3,257,206, 3,370,951, 3,523,022 and 3,769,020. Specific examples of the organic compounds which can be preferably used as the matte agents include water-dispersible vinyl polymers such as polymethyl acrylate, polymethyl methacrylate, polyacrylonitrile, an acrylonitrile-α-methylstyrene copolymer, polystyrene, a styrene-divinyl-benzene copolymer, polyvinyl acetate, polyethylene carbonate and polytetrafluoroethylene, cellulose derivatives such as methyl cellulose, cellulose acetate and cellulose acetate propionate, starch derivatives such as carboxy starch, carboxynitrophenyl starch and a urea-formaldehyde-starch reaction product, gelatin hardened with a known hardening agent, and fine capsule hollow granules of hardened gelatin obtained by coacervate hardening. Examples of the inorganic compounds which can be preferably used include silicon dioxide, titanium dioxide, magnesium dioxide, aluminum oxide, barium sulfate, calcium carbonate, silver chloride desensitized by a known method, silver bromide desensitized by a known method, glass and diatomaceous earth. The above-mentioned matte agents can be used as a mixture of different kinds of materials as needed. There is no particular limitation on the size and form of matte agent, and the matte agent having any particle size can be used. In carrying out the invention, the matte agent having a particle size of 0.1 μm to 30 μm is preferably used. Further, the particle size distribution of the matte agent may be either narrow or wide. On the other hand, the matte agent greatly affects the haze and surface luster of the photosensitive material, so that the particle size, form and particle size distribution are preferably adjusted to a desired state in preparing the matte agent or by mixing of a plurality of matte agents.

Layers which can contain the matte agent include an outermost layer on the light-sensitive layer side or on the back side (which may be a light-sensitive layer or a back layer in some cases) or a protective layer and an undercoat layer it is preferably contained in the outermost surface layer or a layer acting as the outermost surface layer, or in a layer close to the outer surface. Further, it is preferably contained in a layer acting as the protective layer. The matte degree of the back surface is preferably from 10 seconds to 250 seconds, and more preferably from 50 seconds to 180 seconds, by the Beck smoothness.

Binders suitable for the back layers are transparent or translucent, and generally colorless. Examples thereof include natural polymers, synthetic resins, polymers and copolymers, and other film-forming media such as gelatin, gum Arabic, polyvinyl alcohol, hydroxyethyl cellulose, cellulose acetate, cellulose acetate butyrate, polyvinyl pyrrolidone, casein, starch, polyacrylic acid, polymethyl methacrylate, polyvinyl chloride, polymethacrylic acid, copoly(styrene-maleic anhydride), copoly(styrene-acrylonitrile), copoly-(styrene-butadiene), a polyvinyl acetal (for example, polyvinyl formal or polyvinyl butyral), a polyester, a polyurethane, a phenoxy resin, polyvinylidene chloride, a polyepoxide, a polycarbonate, polyvinyl acetate, a cellulose ester and a polyamide. The binder may be formed from water, an organic solvent or an emulsion by coating.

In the heat-developable photosensitive material of the invention, a backside resistive heating layer as shown in U.S. Pat. Nos. 4,460,681 and 4,374,921 can also be used.

In the heat-developable photosensitive material of the invention, a hardener may be used in each layer of the light-sensitive layer, the protective layer and the back layer. Examples of the hardeners used include polyisocyanates described in U.S. Pat. No. 4,281,060 and Japanese Patent Laid-Open No. 208193/1994, epoxy compounds described in U.S. Pat. No. 4,791,042 and vinyl sulfone compounds described in Japanese Patent Laid-Open No. 89048/1987.

In the heat-developable photosensitive material of the invention, a surfactant may be used for improving coating properties and static electrification. Any surfactants such as nonionic, anionic cationic and fluorine surfactants are appropriately used. Specific examples thereof include fluorine polymer surfactants described in Japanese Patent Laid-Open No. 170950/1987 and U.S. Pat. No. 5,380,644, fluorine surfactants described in Japanese Patent Laid-Open Nos. 244945/1985 and 188135/1988, polysiloxane surfactants described in U.S. Pat. No. 3,885,965, polyalkylene oxides described in Japanese Patent Laid-Open No. 301140/1994 and anionic surfactants.

Examples of solvents are described in Shinpan Yozai Pocket Book (published by Ohm, 1994) and the like. However, the invention is not limited to these. Further, the solvents used in the invention preferably have a boiling point of 40° C. to 180° C.

Specific examples of the solvents include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholino, propanesultone, perfluorotributylamine and water.

The heat-developable photosensitive material of the invention may have an antistatic or conductive layer, for example, a soluble salt (such as a chloride or a nitrate), a deposited metal layer or a layer containing an ionic polymer as described in U.S. Pat. Nos. 2,861,056 and 3,206,312 or an insoluble inorganic salt as described in U.S. Pat. No. 3,428,451.

As a method for obtaining a color image using heat-developable photosensitive material of the invention, there is a method described in Japanese Patent Laid-Open No. 13295/1995, page 10, left column, line 48 to page 11, left column, line 40.

Further, as stabilizers for color dye images, there can be used stabilizers illustrated in British Patent 1,326,889, U.S. Pat. Nos. 3,432,300, 3,698,909, 3,574,627, 3,573,050, 3,764,337 and 4,042,394.

In the heat-developable photosensitive material of the invention, the heat-developable photographic emulsions can be applied by dip coating, air knife coating, flow coating or various coating operations including extrusion coating using a hopper described in U.S. Pat. No. 2,381,294. Two or more layers can be concurrently formed by methods described in U.S. Pat. No. 2,761,791 and British Patent 837,095 as desired.

The heat-developable photosensitive material of the invention can contain an additional layer, for example, a dye receiving layer for receiving a transfer dye image, a layer for making opaque at the time when reflection printing is desired, a protective top coat layer or a primer layer already known in the photothermal photographic technique. It is preferred that the heat-developable photosensitive material of the invention can form an image only by one sheet of the photosensitive material, without using as another photosensitive material a functional layer necessary for image formation such as an image receiving layer.

Although the heat-developable photosensitive material of the invention may be developed by any methods, it is usually developed by elevating the temperature of the photosensitive material imagewise exposed. The developing temperature is preferably from 80° C. to 250° C., and more preferably from 100° C. to 140° C. The developing time is preferably from 1 to 180 seconds, and more preferably from 10 to 90 seconds. As the developing method, development using a heat drum is preferably carried out.

Although the heat-developable photosensitive material of the invention may be exposed by any methods, a laser beam is preferably used as an exposure light source. As the laser beams used in the invention, a gas laser beam, dye laser beam, a semiconductor laser beam and the like are preferred. Further, a semiconductor laser or a YAG laser and a second harmonic generating element can also be used. In the invention, a laser beam having an exposure wavelength of 750 to 1400 nm is preferably used.

### EXAMPLES

### Example 1

<Preparation of Light-Sensitive Silver Halide Emulsion>

Phenylcarbamoyl gelatin (88.3 g) 10 ml of a 10% solution of a PAO compound (HO (CH₂CH₂O)ₙ—(CH(CH₃)CH₂O)₁₇—(CH₂CH₂O)ₘ—H; m+n =5 to 7) in aqueous methanol and 0.32 g of potassium bromide were dissolved in 5429 ml of water, and 659 ml of a 0.67 mol/l aqueous solution of silver nitrate and a solution in which 0.703 mol/l of KBr and 0.013 mol/l of KI were dissolved were added to the resulting solution maintained at 45° C., using a mixing stirrer shown in Japanese Patent Publication Nos. 58288/1983 and 58289/1983, for 4 minutes and 45 seconds by a double jet method while adjusting the pAg to 8.09, thus achieving nucleation. After one minute, 20 ml of a 0.63 N solution of potassium hydroxide was added thereto. After an elapse of 6 minutes, 1976 ml of a 0.67 mol/l aqueous solution of silver nitrate and a solution in which 0.657 mol/l of KBr, 0.013 mol/l of KI and 30 μmol/l of dipotassium hexachloroiridate were dissolved were added for 14 minutes and 15 seconds by a double jet method while adjusting the temperature to 45° C. and the pAg to 8.09. After stirring for 5 minutes, the temperature was lowered to 40° C.

Then, 18 ml of a 56% aqueous solution of acetic acid was added thereto to sediment a silver halide emulsion. A supernatant was removed, leaving 2 liters of the sedimented portion, and 10 liters of water was added. After stirring, the silver halide emulsion was sedimented again. A supernatant was further removed, leaving 1.5 liters of the sedimented portion, and 10 liters of water was further added. After stirring, the silver halide emulsion was sedimented. After a supernatant was removed, leaving 1.5 liters of the sedimented portion, a solution in which 1.72 g of anhydrous sodium carbonate was dissolved in 151 ml of water was added, followed by elevation of the temperature to 60° C. The resulting solution was further stirred for 120 minutes. Finally, the pH was adjusted to 5.0, and water was added in an amount of 1161 g per mol of silver. This emulsion comprised monodisperse cubic silver iodobromide grains having an average grain size of 0.058 μm, a coefficient of grain size variation of 12% and a percentage of {100} faces of 92%.

<Preparation of Powdered Organic Silver Salts A to G>

Behenic acid, arachidic acid and stearic acid were added to 4720 ml of pure water in a total amount of 0.7552 mol at a ratio shown in Table 1, and dissolved at 80° C. Then, 540.2 ml of a 1.5 N aqueous solution of sodium hydroxide was added, and 6.9 ml of concentrated nitric acid was added, followed by cooling to 55° C. to obtain a solution of sodium salts of the organic acids. While keeping the temperature of the above-mentioned solution of the sodium salts of the organic acids at 55° C., 45.3 g of the above-mentioned silver halide emulsion and 450 ml of pure water were added, followed by stirring with a homogenizer (ULTRA-TURRAXT-25) manufactured by IKA JAPAN at 13,200 rpm (21.1 KHz as the mechanical oscillation frequency) for 5 minutes. Then, 702.6 ml of a 1 mol/l solution of silver nitrate was added for 2 minutes, followed by stirring to obtain an organic silver salt dispersion. Then, the resulting organic silver salt dispersion was transferred to a water washing vessel, and deionized water was added thereto. After stirring, the resulting dispersion was allowed to stand to separate the organic silver salt dispersion by surfacing, and water-soluble salts in a lower phase were removed. Then, washing with deionized water and draining were repeated until the electric conductance of drained water reached 2 μS/cm. After centrifugation, the resulting product was dried with a circulating dryer at 40° C. until the weight loss became unobserved. Thus, each of powdered organic silver salts A to G was prepared.

TABLE 1

| Organic | Behenic | Arachidic | Stearic | Oxygen Partial |
|---|---|---|---|---|
| Silver | Acid | Acid | Acid | Pressure |
| Salt | (mol %) | (mol %) | (mol %) | (vol %) |
| A | 50 | 30 | 20 | 10 |
| B | 54 | 29 | 17 | 10 |
| C | 60 | 28 | 12 | 10 |
| D | 70 | 22 | 8 | 10 |
| E | 83 | 15 | 2 | 10 |
| F | 90 | 10 | 0 | 10 |
| G | 60 | 28 | 12 | 20 |

<Preparation of Light-Sensitive Emulsion Dispersion>

Polyvinyl butyral powder (Butvar B-79, manufactured by Monsanto Co.) (14.57 g) was dissolved in 1457 g of methyl ethyl ketone (MEK), and 500 g of the powdered organic silver salt was gradually added with stirring by means of a DISPERMAT CA-40M type dissolver manufactured by VMA-GETZMANN to obtain a sufficiently mixed slurry. The above-mentioned slurry was subjected to 2-bath dispersion with a GM-2 type pressure homogenizer manufactured by MST, thereby preparing a light-sensitive emulsion dispersion. In this case, the treating pressure in one bath was 280 kg/cm², and that in two baths was 560 kg/cm².

<Preparation of Coating Solutions 1 to 20 for Light-Sensitive Layers>

MEK (15.1 g) was added to 50 g of the above-mentioned light-sensitive emulsion dispersion, and the temperature was maintained at 21° C. while stirring at 1,000 rpm with a dissolver type homogenizer. Then, 390 μl of a 10 wt % solution of an associated product of two molecules of N,N-dimethyl-acetamide/one molecule of bromic acid/one molecule of bromine in methanol was added, followed by stirring for one hour. Further, 494 μl of a 10 wt % solution of calcium bromide in methanol was added, followed by stirring for 20 minutes. Subsequently, 167 mg of a methanol solution containing 15.9% by weight of dibenzo-18-crown-6 and 4.9% by weight of potassium acetate was added, followed by stirring for 10 minutes. Then, 2.6 g of a solution of 0.24% by weight of coloring matter A or B, 18.3% by weight of 2-chlorobenzoic acid, 34.2% by weight of salicylic acid-p-toluenesulfonate and 4.5% by weight of 5-methyl-2-mercaptobenzimidazole in MEK was added, followed by stirring for one hour. Then, the temperature was lowered to 13° C., followed further stirring for 30 minutes. While maintaining the temperature at 13° C., 13.31 g of polyvinyl butyral (Butvar B-79, manufactured by Monsanto Co.) was added, followed by stirring for 30 minutes. Then, 1.08 g of a 9.4 wt % tetrachlorophthalic acid solution was added, followed by stirring for 15 minutes. With stirring, a 20wt % reducing agent described in Table 2 was added in an amount shown in Table 2, and 12.4 g of a solution of 1.1% by weight of 4-methylphthalic acid and dye 1 in MEK was added. Subsequently, 1.5 g of 10 wt % Desmodur N3300 (an aliphatic isocyanate, manufactured by Mobey) was added, and 4.27 g of a solution of 7.4% by weight of tribromomethyl-2-azaphenylsulfone and 7.2% by weight of phthalazine in MEK was further added. Thus, each of coating solutions 1 to 20 for light-sensitive layers was obtained.

TABLE 2

| Light- | Organic | | | Amount of |
|---|---|---|---|---|
| Sensitive Coating | Silver | Coloring | Reducing | Reducing Agent |
| Solution | Salt | Matter | Agent | Added |
| 1 | A | A | I-5 | 9.2 g |
| 2 | B | A | I-5 | 9.5 g |
| 3 | C | A | I-5 | 9.7 g |
| 4 | D | A | I-5 | 9.9 g |
| 5 | E | A | I-5 | 10 g |
| 6 | F | A | I-5 | 11 g |
| 7 | G | A | I-5 | 9.7 g |
| 8 | A | A | I-6 | 8.7 g |
| 9 | C | A | I-6 | 9.1 g |
| 10 | D | A | I-6 | 9.4 g |
| 11 | F | A | I-6 | 10 g |
| 12 | A | A | I-2 | 12.4 g |
| 13 | C | A | I-2 | 13 g |
| 14 | D | A | I-2 | 13.5 g |
| 15 | F | A | I-2 | 14 g |
| 16 | A | A | I-1 | 15 g |
| 17 | C | A | I-1 | 15.5 g |
| 18 | D | A | I-1 | 15.9 g |
| 19 | F | A | I-1 | 16.4 g |
| 20 | C | B | I-5 | 9.7 g |

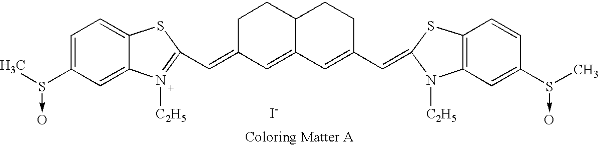

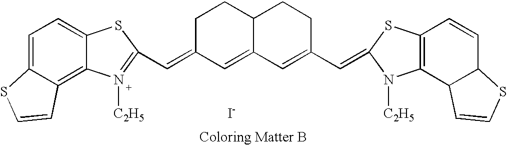

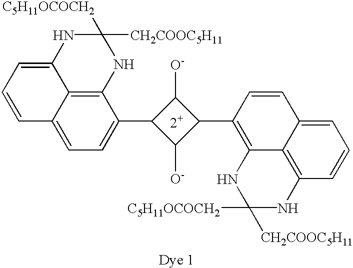

<Preparation of Coating Solution for Surface Protective Layer>

Cellulose acetate butyrate (CAB171-15, manufactured by Eastman Chemical) (96 g), 4.5 g of polymethyl methacrylate (Paraloid A-21, manufactured by Rohm & Haas Inc.), 1.5 g of 1,3-di(vinylsulfonyl)-2-propanol, 1.0 g of benzotriazole and a fluorine surfactant (Surflon KH40, manufactured by Asahi Glass Co., Ltd.) were added to and dissolved in 865 g of MEK with stirring. Then, 30 g of a dispersion in which 13.6% by weight of cellulose acetate butyrate (CAB171-15, manufactured by Eastman Chemical) and 9% by weight of calcium carbonate (Super-Pflex 200, manufactured by Speciality Minerals) were dispersed in MEK with a dissolver type homogenizer at 8,000 rpm for 30 hours was added, followed by stirring to prepare a coating solution for a surface protective layer.

<Preparation of Support>

Corona discharge treatment of 8 W/m²·min was applied to both faces of a 175-μm thick PET film colored blue to a density of 0.170 (measured with a densitometer (PDA-65) manufactured by Konica Corp.).

<Coating of Back Face Side>

Cellulose acetate butyrate (CAB381-20, manufactured by Eastman Chemical) (84.2 g) and 4.5 g of a polyester resin (Vitel PE 2200B, manufactured by Bostic) were added to and dissolved in 830 g of MEK. To this solution, 0.30 g of dye B was added, and 4.5 g of a fluorine surfactant (Surflon KH40, manufactured by Asahi Glass Co., Ltd.) dissolved in 43.2 g of methanol and 2.3 g of a fluorine surfactant (Megafac F120K, manufactured by Dainippon Ink & Chemicals, Inc.) were further added. Then, stirring was sufficiently accomplished, until they were dissolved. Finally, 75 g of silica (Siloid 64×6000, manufactured by W. R. Grace) dispersed in methyl ethyl ketone at a concentration of 1% by weight with a dissolver type homogenizer was added, followed by stirring to prepare a coating solution for a back face.

The back face coating solution thus prepared was extruded onto the support so as to give a dry film thickness of 3.5 μm, coated with a coater, and dried at a drying temperature of 100° C. using a drying air having a dew-point temperature of 10° C.

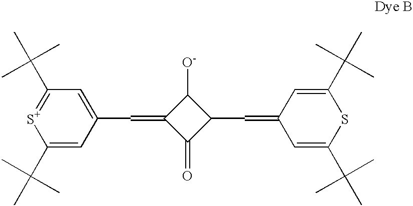

<Preparation of Photosensitive Materials>

Each of the above-mentioned coating solutions 1 to 20 for the light-sensitive layers and the coating solution for the surface protective layer were simultaneously applied in multiple layers onto the support coated with the back face coating solution, thereby preparing each of photosensitive materials 1 to 20. Coating was carried out so as to give an amount of silver coated of 1.9 g/m2 for the light-sensitive layer and a dry film thickness of 2.5 μm for the surface protective layer. Then, drying was carried out at a drying temperature of 75° C. for 10 minutes using a drying air having a dew-point temperature of 10° C.

For each photosensitive material thus obtained, the sum of the MEK content and the methanol content determined under the following conditions was taken as the solvent content. As the film area, 46.3 cm² was cut out. This was cut fine to about 5 mm, and placed in its own vial, which was sealed with a septum and an aluminum cap. Then, the vial was set in a head space sampler, type HP7694, of a gas chromatography (GC), type 5971, manufactured by Hewlett-Packard Co. A flame ionization detector (FID) was used as a detector of the GC, and a DB-624 column manufactured by J & W was used as the column. As for the main measuring conditions, the head space sampler heating conditions were 120° C. and 20 minutes, the GC introduction temperature was 150° C., and the temperature was elevated from 45° C. for 3 minutes to 100° C. at 8° C./minute. The calibration curve was prepared using the peak area of a chromatogram obtained by placing a definite amount of a solution of the above-mentioned respective solvent diluted with butanol in its own vial, and then measuring it in the same manner as described above. The solvent content of each photosensitive material was 40 mg/m².

The photosensitive material was cut out by 100 cm², and the light-sensitive layer was separated in MEK. Decomposition with sulfuric acid and nitric acid was conducted with a Microdigest Type A300 microwave wet decomposer manufactured by Prolabo, and analysis was made by the calibration curve method with a PQ-Ω type ICP-MS (inductively coupled plasma mass spectrometer) manufactured by VG Elemental. As a result, the Zr content in the photosensitive material was 10 μg or less per mg of Ag.

<Exposure and Development Processing>

A prototype exposing device using as an exposure source a semiconductor laser converted to vertical multiple modes having a wavelength of 800 nm to 820 nm by high frequency superposition, and exposure according to laser scanning was given to the photosensitive material prepared as described above, with this exposing device from the emulsion face side of the photosensitive material. In this case, the scanning laser beam was irradiated to an exposure face of the photosensitive material at an incident angle of 75 degrees to record an image. Then, using an automatic processor having a heat drum, the protective layer of the photosensitive material was brought into contact with a surface of the drum, and heat development was conducted at 124 ° C. for 15 seconds. The resulting image was evaluated with a densitometer. In that case, the temperature and humidity of a camber in which exposure and development were conducted were 23° C. and 50% RH. Compared to the case that an ordinary scanning laser beam was irradiated to the exposure face of the photosensitive material at an incident angle of 90 degrees to record an image, deterioration in image quality caused by interference unevenness was less developed, and the image having unexpectedly good sharpness and contrast was obtained.

<Evaluation of Photographic Performance>

Each sample obtained above was exposed to the laser beam, and heat development was conducted by the above-mentioned method. Then, the relative sensitivity and the minimum density (Dmin) of each sample were measured. In that case, the sensitivity of photosensitive material 3 was taken as 100.

Results thereof are shown in Table 3.

Photosensitive materials 1 to 6 were developed with four panel heaters set at 124° C., for 15 seconds in total, and the photographic performance thereof was similarly evaluated.

<Evaluation of Image Keeping Quality>

After each photographic material was exposed and heat developed by the above-mentioned exposing method, the material was thoroughly irradiated with light, subjected to humidity conditioning at 70% RH for 3 hours, sealed in a bag capable of shielding light and allowed to stand in an environment of 60° C. for 72 hours. The rate of change in Dmin at this time is shown in Table 3.

TABLE 3

| | | | Image | | |
|---|---|---|---|---|---|
| | | | Keeping | | |
| | | | Quality | | |
| Photosen- | Relative | | (rate of | Develop- | |
| sitive | Sensi- | | change | ment | |
| Material | tivity | Dmin | in Dmin) | System | |
| 1 | 100 | 0.25 | 27 | Heat drum | Comparison |
| 2 | 100 | 0.2 | 11 | Heat drum | Invention |
| 3 | 100 | 0.19 | 2 | Heat drum | Invention |
| 4 | 100 | 0.19 | 1 | Heat drum | Invention |
| 5 | 100 | 0.2 | 8 | Heat drum | Invention |
| 6 | 83 | 0.22 | 13 | Heat drum | Comparison |
| 7 | 100 | 0.2 | 7 | Heat drum | Invention |
| 8 | 100 | 0.27 | 33 | Heat drum | Comparison |
| 9 | 100 | 0.19 | 4 | Heat drum | Invention |
| 10 | 100 | 0.19 | 3 | Heat drum | Invention |
| 11 | 87 | 0.24 | 15 | Heat drum | Comparison |
| 12 | 100 | 0.22 | 22 | Heat drum | Comparison |
| 13 | 98 | 0.2 | 8 | Heat drum | Invention |
| 14 | 97 | 0.2 | 7 | Heat drum | Invention |
| 15 | 75 | 0.22 | 20 | Heat drum | Comparison |
| 16 | 100 | 0.21 | 23 | Heat drum | Comparison |
| 17 | 97 | 0.2 | 8 | Heat drum | Invention |
| 18 | 96 | 0.2 | 8 | Heat drum | Invention |
| 19 | 65 | 0.23 | 21 | Heat drum | Comparison |
| 20 | 99 | 0.19 | 3 | Heat drum | Invention |
| 1 | 96 | 0.25 | 27 | Panel | Comparison |
| | | | | heater | |
| 2 | 96 | 0.2 | 11 | Panel | Invention |
| | | | | heater | |
| 3 | 96 | 0.19 | 2 | Panel | Invention |
| | | | | heater | |
| 4 | 96 | 0.19 | 1 | Panel | Invention |
| | | | | heater | |
| 5 | 96 | 0.2 | 8 | Panel | Invention |
| | | | | heater | |
| 6 | 79 | 0.22 | 13 | Panel | Comparison |
| | | | | heater | |

The results show that the photosensitive materials of the invention are higher in sensitivity, and lower in Dmin, that is to say, lower in fog, than the photosensitive materials for comparison. The photosensitive materials of the invention are also more excellent in image keeping quality than the photosensitive materials for comparison. A comparison between photosensitive material 3 and photosensitive material 7 also reveals that an oxygen partial pressure of 15 vol % or less in the drying step in preparing the organic silver salt results in improvement in image keeping quality, and further that the use of the heat drum as the heating system results in a further increase in sensitivity.

### Example 2

<Preparation of Light-Sensitive Silver Halide Emulsion>

Phenylcarbamoyl gelatin (88.3 g) 10 ml of a 10% solution of a PAO compound (HO (CH₂CH₂O)ₙ—(CH(CH₃) CH₂O )₁₇—(CH₂CH₂O)ₘ—H; m+n =5 to 7) in aqueous methanol and 0. 32 g of potassium bromide were dissolved in 5429 ml of water, and 659 ml of a 0.67 mol/l aqueous solution of silver nitrate and a solution in which 0.703 mol/l of KBr and 0.013 mol/l of KI were dissolved were added to the resulting solution maintained at 45° C., using a mixing stirrer shown in Japanese Patent Publication Nos. 58288/1983 and 58289/1983, for 4 minutes and 45 seconds by a double jet method while adjusting the pAg to 8.09, thus achieving nucleation.

After one minute, 20 ml of a 0.63 N solution of potassium hydroxide was added thereto. After an elapse of 6 minutes, 1976 ml of a 0.67 mol/l aqueous solution of silver nitrate and a solution in which 0.657 mol/l of KBr, 0.013 mol/l of KI and 30 μmol/l of dipotassium hexachloroiridate were dissolved were added for 14 minutes and 15 seconds by a double jet method while adjusting the temperature to 45° C. and the pAg to 8.09. After stirring for 5 minutes, the temperature was lowered to 40° C.

Then, 18 ml of a 56% aqueous solution of acetic acid was added thereto to sediment a silver halide emulsion. A supernatant was removed, leaving 2 liters of the sedimented portion, and 10 liters of water was added. After stirring, the silver halide emulsion was sedimented again. A supernatant was further removed, leaving 1.5 liters of the sedimented portion, and 10 liters of water was further added. After stirring, the silver halide emulsion was sedimented. After a supernatant was removed, leaving 1.5 liters of the sedimented portion, a solution in which 1.72 g of anhydrous sodium carbonate was dissolved in 151 ml of water was added, followed by elevation of the temperature to 60° C. The resulting solution was further stirred for 120 minutes. Finally, the pH was adjusted to 5.0, and water was added in an amount of 1161 g per mol of silver.

This emulsion comprised monodisperse cubic silver iodobromide grains having an average grain size of 0.058 μm, a coefficient of grain size variation of 12% and a percentage of {100} faces of 92%.

<Preparation of Powdered Organic Silver Salts A to F>

Behenic acid, arachidic acid and stearic acid were added to 4720 ml of pure water in a total amount of 0.7552 mol at a ratio shown in Table 4, and dissolved at 80° C. Then, 540.2 ml of a 1.5 N aqueous solution of sodium hydroxide was added, and 6.9 ml of concentrated nitric acid was added, followed by cooling to 55° C. to obtain a solution of sodium salts of the organic acids.

While keeping the temperature of the above-mentioned solution of the sodium salts of the organic acids at 55° C., 45.3 g of the above-mentioned silver halide emulsion and 450 ml of pure water were added, followed by stirring with a homogenizer (ULTRA-TURRAXT-25) manufactured by IKA JAPAN at 13,200 rpm (21.1 KHz as the mechanical oscillation frequency) for 5 minutes. Then, 702.6 ml of a 1 mol/l solution of silver nitrate was added for 2 minutes, followed by stirring to obtain an organic silver salt dispersion.

Then, the resulting organic silver salt dispersion was transferred to a water washing vessel, and deionized water was added thereto. After stirring, the resulting dispersion was allowed to stand to separate the organic silver salt dispersion by surfacing, and water-soluble salts in a lower phase were removed. Then, washing with deionized water and draining were repeated until the electric conductance of drained water reached 2 μS/cm. After centrifugation, the resulting product was dried with a circulating dryer at 40° C. until the weight loss became unobserved. Thus, each of powdered organic silver salts A to F was prepared.

<Preparation of Light-Sensitive Emulsion Dispersion>

Polyvinyl butyral powder (Butvar B-79, manufactured by Monsanto Co.) (14.57 g) was dissolved in 1457 g of methyl ethyl ketone (MEK), and 500 g of the powdered organic silver salt was gradually added with stirring by means of a DISPERMAT CA-40M type dissolver manufactured by VMA-GETZMANN to obtain a sufficiently mixed slurry.

The above-mentioned slurry was subjected to 2-bath dispersion with a GM-2 type pressure homogenizer manufactured by MST, thereby preparing a light-sensitive emulsion dispersion. In this case, the treating pressure in one bath was 280 kg/cm², and that in two baths was 560 kg/cm².

<Preparation of Coating Solutions 1 to 22 for Light-Sensitive Layers>

MEK (15.1 g) was added to 50 g of the above-mentioned light-sensitive emulsion dispersion, and the temperature was maintained at 21° C. while stirring at 1,000 rpm with a dissolver type homogenizer. Then, 390 μl of a 10 wt % solution of an associated product of two molecules of N,N-dimethyl-acetamide/one molecule of bromic acid/one molecule of bromine in methanol was added, followed by stirring for one hour. Further, 494 μl of a 10 wt % solution of calcium bromide in methanol was added, followed by stirring for 20 minutes. Subsequently, 167 mg of a methanol solution containing 15.9% by weight of dibenzo-18-crown-6 and 4.9% by weight of potassium acetate was added, followed by stirring for 10 minutes. Then, 2.6 g of a solution of 0.24% by weight of coloring matter A, 18.3% by weight of 2-chlorobenzoic acid, 34.2% by weight of salicylic acid-p-toluenesulfonate and 4.5% by weight of 5-methyl-2-mercaptobenzimidazole in MEK was added, followed by stirring for one hour. Then, the temperature was lowered to 13° C., followed further stirring for 30 minutes.

While maintaining the temperature at 13° C., 13.31 g of polyvinyl butyral (Butvar B-79, manufactured by Monsanto Co.) was added, followed by stirring for 30 minutes. Then, 1.08 g of a 9.4 wt % tetrachlorophthalic acid solution was added, followed by stirring for 15 minutes.

With stirring, 10.0 g of 20 wt % reducing agent R-2 and a development accelerator described in Table 2 were added, and 12.4 g of a solution of 1.1% by weight of 4-methylphthalic acid and dye A in MEK was added. Subsequently, 1.5 g of 10 wt % Desmodur N3300 (an aliphatic isocyanate, manufactured by Mobey) was added, and 4.27 g of a solution of 7.4% by weight of tribromomethyl-2-azaphenylsulfone and 7.2% by weight of phthalazine in MEK was further added. Thus, each of coating solutions 1 to 22 for light-sensitive layers was obtained.

<Preparation of Coating Solution for Surface Protective Layer>

Cellulose acetate butyrate (CAB171-15, manufactured by Eastman Chemical) (96 g), 4.5 g of polymethyl methacrylate (Paraloid A-21, manufactured by Rohm & Haas Inc.), 1.5 g of 1,3-di(vinylsulfonyl)-2-propanol, 1.0 g of benzotriazole and a fluorine surfactant (Surflon KH40, manufactured by Asahi Glass Co., Ltd.) were added to and dissolved in 865 g of MEK with stirring. Then, 30 g of a dispersion in which 13.6% by weight of cellulose acetate butyrate (CAB171-15, manufactured by Eastman Chemical) and 9% by weight of calcium carbonate (Super-Pflex 200, manufactured by Speciality Minerals) were dispersed in MEK with a dissolver type homogenizer at 8,000 rpm for 30 hours was added, followed by stirring to prepare a coating solution for a surface protective layer.

<Preparation of Support>

Corona discharge treatment of 8 W/m²·min was applied to both faces of a 175-μm thick PET film colored blue to a density of 0.170 (measured with a Macbeth densitometer (TD-904)).

<Coating of Back Face Side>

Cellulose acetate butyrate (CAB381-20, manufactured by Eastman Chemical) (84.2 g) and 4.5 g of a polyester resin (Vitel PE 2200B, manufactured by Bostic) were added to and dissolved in 830 g of MEK. To this solution, 0.30 g of dye B was added, and 4.5 g of a fluorine surfactant (Surflon KH40, manufactured by Asahi Glass Co., Ltd.) dissolved in 43.2 g of methanol and 2.3 g of a fluorine surfactant (Megafac F120K, manufactured by Dainippon Ink & Chemicals, Inc.) were further added. Then, stirring was sufficiently accomplished, until they were dissolved. Finally, 75 g of silica (Siloid 64×6000, manufactured by W. R. Grace) dispersed in methyl ethyl ketone at a concentration of 1% by weight with a dissolver type homogenizer was added, followed by stirring to prepare a coating solution for a back face.

The back face coating solution thus prepared was extruded so as to give a dry film thickness of 3.5 μm, coated with a coater, and dried at a drying temperature of 100° C. using a drying air having a dew-point temperature of 10° C.

<Preparation of Photosensitive Materials>

As shown in Table 5, each of the above-mentioned coating solutions 1 to 22 for the light-sensitive layers and the coating solution for the surface protective layer were simultaneously applied in multiple layers onto the support coated with the back face coating solution, thereby preparing each of photosensitive materials 1 to 22. Coating was carried out so as to give an amount of silver coated of 1.9 g/m2 for the light-sensitive layer and a dry film thickness of 2.5 μm for the surface protective layer. Then, drying was carried out at a drying temperature of 75° C. for 10 minutes using a drying air having a dew-point temperature of 10° C.

For each photosensitive material thus obtained, the sum of the MEK content and the methanol content determined under the following conditions was taken as the solvent content. As the film area, 46.3 cm² was cut out. This was cut fine to about 5 mm, and placed in its own vial, which was sealed with a septum and an aluminum cap. Then, the vial was set in a head space sampler, type HP7694, of a gas chromatography (GC), type 5971, manufactured by Hewlett-Packard Co. A flame ionization detector (FID) was used as a detector of the GC, and a DB-624 column manufactured by J & W was used as the column. As for the main measuring conditions, the head space sampler heating conditions were 120° C. and 20 minutes, the GC introduction temperature was 150° C., and the temperature was elevated from 45° C. for 3minutes to 100° C. at 8° C./minute. The calibration curve was prepared using the peak area of a chromatogram obtained by placing a definite amount of a solution of the above-mentioned respective solvent diluted with butanol in its own vial, and then measuring it in the same manner as described above. The solvent content of each photosensitive material was 40 mg/m².

The photosensitive material was cut out by 100 cm², and the light-sensitive layer was separated in MEK. Decomposition with sulfuric acid and nitric acid was conducted with a Microdigest Type A300 microwave wet decomposer manufactured by Prolabo, and analysis was made by the calibration curve method with a PQ-Ω type ICP-MS (inductively coupled plasma mass spectrometer) manufactured by VG Elemental. As a result, the Zr content in the photosensitive material was 10 μg or less per mg of Ag.

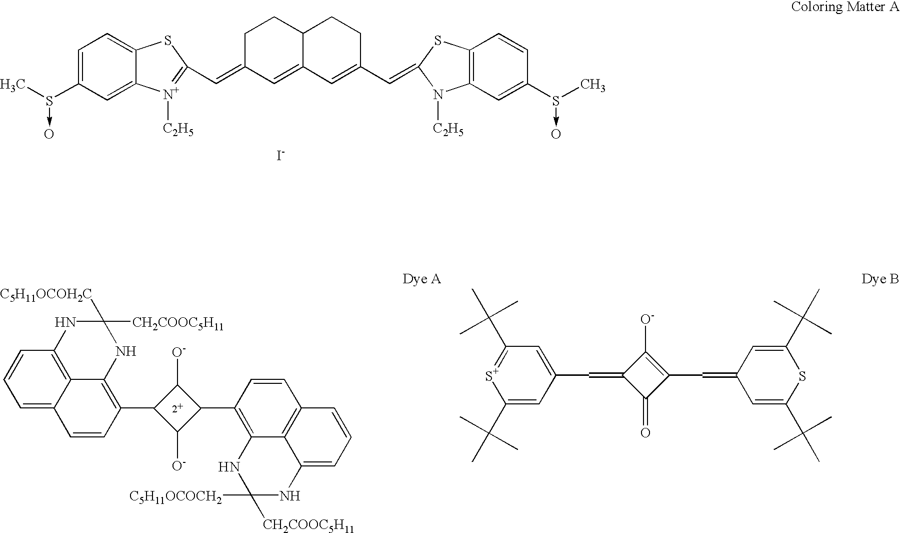

<Exposure and Development Processing>

A prototype exposing device using as an exposure source a semiconductor laser converted to vertical multiple modes having a wavelength of 800 nm to 820 nm by high frequency superposition, and exposure according to laser scanning was given to the photosensitive material prepared as described above, with this exposing device from the emulsion face side of the photosensitive material. In this case, the scanning laser beam was irradiated to an exposure face of the photosensitive material at an incident angle of 75 degrees to record an image.

Then, using an automatic processor having a heat drum, the protective layer of the photosensitive material was brought into contact with a surface of the drum, and heat development was conducted at 124 ° C. for 15 seconds. The resulting image was evaluated with a densitometer. In that case, the temperature and humidity of a camber in which exposure and development were conducted were 23° C. and 50% RH.

Compared to the case that an ordinary scanning laser beam was irradiated to the exposure face of the photosensitive material at an incident angle of 90 degrees to record an image, deterioration in image quality caused by interference unevenness was less developed, and the image having unexpectedly good sharpness and contrast was obtained.

<Evaluation of Photographic Performance>

Each sample obtained above was exposed to the laser beam, and heat development was conducted by the above-mentioned method. Then, the relative sensitivity and the minimum density (Dmin) of each sample were measured. In that case, the sensitivity was evaluated by the reciprocal of the ratio of exposure giving a density 1.0 higher than the fog density, and indicated by the relative sensitivity, taking the sensitivity of photosensitive material 3 as 100. The result was shown in Table 6.

<Evaluation of Image Keeping Quality>

After each photographic material was exposed and heat developed by the above-mentioned exposing method, the material was thoroughly irradiated with light, subjected to humidity conditioning at 70% RH for 3 hours, sealed in a bag capable of shielding light and allowed to stand in an environment of 60° C. for 72 hours. The rate of change in Dmin at this time is shown in Table 6.

TABLE 4

| Organic Silver | Behenic Acid | Arachidic Acid | Stearic Acid |
|---|---|---|---|
| Salt | (mol %) | (mol %) | (mol %) |
| A | 35 | 35 | 30 |
| B | 45 | 33 | 22 |
| C | 60 | 26 | 14 |
| D | 75 | 17 | 8 |
| E | 87 | 11 | 2 |
| F | 92 | 8 | 0 |

TABLE 5

| | | | | Develop- | |
|---|---|---|---|---|---|
| | | | | ment | |
| | | | | Accele- | |
| | Light- | | | rator | |
| | Sensi- | | Develop- | (amount | |
| Photosen- | tive | Organic | ment | added) | |
| sitive | Coating | Silver | Accele- | (mol/mol | |
| Material | Solution | Salt | rator | Ag) | |
| 1 | 1 | A | 1-68 | 1.2 × 10⁻² | Comparison |
| 2 | 2 | B | 1-68 | 1.2 × 10⁻² | Invention |
| 3 | 3 | C | 1-68 | 1.2 × 10⁻² | Invention |
| 4 | 4 | D | 1-68 | 1.2 × 10⁻² | Invention |
| 5 | 5 | E | 1-68 | 1.2 × 10⁻² | Invention |
| 6 | 6 | F | 1-68 | 1.2 × 10⁻² | Comparison |
| 7 | 7 | B | Not used | — | Comparison |
| 8 | 8 | B | 2-60 | 1.2 × 10⁻² | Invention |
| 9 | 9 | B | 3-41 | 1.2 × 10⁻² | Invention |
| 10 | 10 | B | 4-7 | 1.2 × 10⁻² | Invention |
| 11 | 11 | C | Not used | — | Comparison |
| 12 | 12 | C | 2-60 | 1.2 × 10⁻² | Invention |
| 13 | 13 | C | 3-41 | 1.2 × 10⁻² | Invention |
| 14 | 14 | C | 4-7 | 1.2 × 10⁻² | Invention |
| 15 | 15 | D | Not used | — | Comparison |
| 16 | 16 | D | 2-60 | 1.2 × 10⁻² | Invention |
| 17 | 17 | D | 3-41 | 1.2 × 10⁻² | Invention |
| 18 | 18 | D | 4-41 | 1.2 × 10⁻² | Invention |
| 19 | 19 | E | Not used | — | Comparison |
| 20 | 20 | E | 2-60 | 1.2 × 10⁻² | Invention |
| 21 | 21 | E | 3-41 | 1.2 × 10⁻² | Invention |
| 22 | 22 | E | 4-7 | 1.2 × 10⁻² | Invention |

TABLE 6

| | | | Image | | |
|---|---|---|---|---|---|
| | | | Keeping | | |
| | | | Quality | | |
| Photosen- | Relative | | (rate of | Develop- | |
| sitive | Sensi- | | change | ment | |
| Material | tivity | Dmin | in Dmin) | System | |
| 1 | 120 | 0.25 | 27% | Heat drum | Comparison |
| 2 | 105 | 0.20 | 11% | Heat drum | Invention |
| 3 | 100 | 0.19 | 2% | Heat drum | Invention |
| 4 | 98 | 0.19 | 1% | Heat drum | Invention |
| 5 | 95 | 0.18 | 2% | Heat drum | Invention |
| 6 | 80 | 0.17 | 1% | Heat drum | Comparison |
| 7 | 55 | 0.20 | 12% | Heat drum | Comparison |
| 8 | 105 | 0.20 | 12% | Heat drum | Invention |
| 9 | 105 | 0.20 | 12% | Heat drum | Invention |
| 10 | 105 | 0.20 | 13% | Heat drum | Invention |
| 11 | 50 | 0.19 | 3% | Heat drum | Comparison |
| 12 | 100 | 0.19 | 3% | Heat drum | Invention |
| 13 | 100 | 0.19 | 3% | Heat drum | Invention |
| 14 | 100 | 0.19 | 3% | Heat drum | Invention |
| 15 | 48 | 0.19 | 2% | Heat drum | Comparison |
| 16 | 98 | 0.19 | 2% | Heat drum | Invention |
| 17 | 98 | 0.19 | 2% | Heat drum | Invention |
| 18 | 98 | 0.19 | 2% | Heat drum | Invention |
| 19 | 45 | 0.18 | 5% | Heat drum | Comparison |
| 20 | 95 | 0.18 | 6% | Heat drum | Invention |
| 21 | 95 | 0.18 | 5% | Heat drum | Invention |
| 22 | 95 | 0.18 | 5% | Heat drum | Invention |

The results show that the photosensitive materials of the invention are high in sensitivity, low in Dmin and excellent in image keeping quality.

### Example 3

<Preparation of PET Support>

PET having an intrinsic viscosity IV=0.66 (measured in phenol/tetrachloroethane=6/4 (by weight) at 25° C.) was obtained by an ordinary method using terephthalic acid and ethylene glycol. The PET was pelletized, dried at 130° C. for 4 hours, melted at 300° C., extruded through a T-die and rapidly cooled to prepare an unstretched film having a thickness sufficiently large to give a thickness of 175 μm after the heat setting.

This film was vertically stretched 3.3 times using rolls different in the peripheral speed and then horizontally stretched 4.5 times with a tenter. At this time, the temperatures were 110° C. and 130° C., respectively. Subsequently, the film was heat set at 240° C. for 20 seconds and horizontally relaxed by 4% at the same temperature. Then, after portions chucked with the tenter were slit off, the knurl treatment was applied to both edges. The film was taken up at 4 kg/cm² (4×10⁴ Pa) to obtain a roll having a thickness of 175 μm.

Both surfaces of the support were treated with a Model 6KVA solid state corona treating device manufactured by PILLAR at room temperature at 20 m/min. Readings of current and voltage at this time revealed that the support was treated at 0.375 kV·A·min./m². The treatment frequency at this time was 9.6 kHz, and the gap clearance between an electrode and a dielectric roll was 1.6 mm.

<Preparation of Light-Sensitive Silver Halide Emulsion>

Phenylcarbamoyl gelatin (88.3 g) 10 ml of a 10% solution of a PAO compound (HO(CH₂CH₂O)ₙ—(CH(CH₃)CH₂O)₁₇—(CH₂CH₂O)ₘ—H; m+n =5 to 7) in aqueous methanol and 0.32 g of potassium bromide were dissolved in 5429 ml of water, and 659 ml of a 0.67 mol/l aqueous solution of silver nitrate and a solution in which 0.703 mol/l of KBr and 0.013 mol/l of KI were dissolved were added to the resulting solution maintained at 45° C., using a mixing stirrer shown in Japanese Patent Publication Nos. 58288/1983 and 58289/1983, for 4 minutes and 45 seconds by a double jet method while adjusting the pAg to 8.09, thus achieving nucleation. After one minute, 20 ml of a 0.63N solution of potassium hydroxide was added thereto. After an elapse of 6 minutes, 1976 ml of a 0.67 mol/l aqueous solution of silver nitrate and a solution in which 0.657 mol/l of KBr, 0.013 mol/l of KI and 30 μmol/l of dipotassium hexachloroiridate were dissolved were added for 14 minutes and 15 seconds by a double jet method while adjusting the temperature to 45° C. and the pAg to 8.09. After stirring for 5 minutes, the temperature was lowered to 40° C.

Then, 18 ml of a 56% aqueous solution of acetic acid was added thereto to sediment a silver halide emulsion. A supernatant was removed, leaving 2 liters of the sedimented portion, and 10 liters of water was added. After stirring, the silver halide emulsion was sedimented again. A supernatant was further removed, leaving 1.5 liters of the sedimented portion, and 10 liters of water was further added. After stirring, the silver halide emulsion was sedimented. After a supernatant was removed, leaving 1.5 liters of the sedimented portion, a solution in which 1.72 g of anhydrous sodium carbonate was dissolved in 151 ml of water was added, followed by elevation of the temperature to 60° C. The resulting solution was further stirred for 120 minutes. Finally, the pH was adjusted to 5.0, and water was added in an amount of 1161 g per mol of silver.

This emulsion comprised monodisperse cubic silver iodobromide grains having an average grain size of 0.058 μm, a coefficient of grain size variation of 12% and a percentage of {100} faces of 92%.

<Preparation of Powdered Organic Silver Salts A to C>

Behenic acid, arachidic acid and stearic acid were added to 4720 ml of pure water in a total amount of 0.7552 mol at a ratio according to Table 7, and dissolvedat 80° C. Then, 540.2 ml of a 1.5 N aqueous solution of sodium hydroxide was added, and 6.9 ml of concentrated nitric acid was added, followed by cooling to 55° C. to obtain a solution of sodium salts of the organic acids. While keeping the temperature of the above-mentioned solution of the sodium salts of the organic acids at 55° C., 45.3 g of the above-mentioned silver halide emulsion and 450 ml of pure water were added, followed by stirring with a homogenizer (ULTRA-TURRAXT-25) manufactured by IKA JAPAN at 13,200 rpm (21.1 KHz as the mechanical oscillation frequency) for 5 minutes. Then, 702. 6 ml of a 1 mol/l solution of silver nitrate was added for 2 minutes, followed by stirring to obtain an organic silver salt dispersion. Then, the resulting organic silver salt dispersion was transferred to a water washing vessel, and deionized water was added thereto. After stirring, the resulting dispersionwas allowed to stand to separate the organic silver salt dispersion by surfacing, and water-soluble salts in a lower phase were removed. Then, washing with deionized water and draining were repeated until the electric conductance of drained water reached 2 μS/cm. After centrifugation, the resulting product was dried with a circulating dryer at 40° C. until the weight loss became unobserved. Thus, each of powdered organic silver salts A to C was prepared.

TABLE 7

| Organic | Behenic | Arachidic | Stearic | Oxygen Partial |
|---|---|---|---|---|
| Silver | Acid | Acid | Acid | Pressure |
| Salt | (mol %) | (mol %) | (mol %) | (vol %) |
| A | 50 | 30 | 20 | 10 |
| B | 70 | 22 | 8 | 10 |
| C | 90 | 10 | 0 | 10 |

<Preparation of Light-Sensitive Emulsion Dispersion>

Polyvinyl butyral powder (Butvar B-79, manufactured by Monsanto Co.) (14.57 g) was dissolved in 1457 g of methyl ethyl ketone (MEK), and 500 g of the powdered organic silver salt was gradually added with stirring by means of a DISPERMAT CA-40M type dissolver manufactured by VMA-GETZMANN to obtain a sufficiently-mixed slurry. The above-mentioned slurry was subjected to 2-bath dispersion with a GM-2 type pressure homogenizer manufactured by MST, thereby preparing a light-sensitive emulsion dispersion. In this case, the treating pressure in one bath was 280 kg/cm², and that in two baths was 560 kg/cm².

<Preparation of Coating Solutions 1 to 24 for Light-Sensitive Layers>

MEK (15.1 g) was added to 50 g of a light-sensitive emulsion dispersion containing an organic silver salt according to Table 8, and the temperature was maintained at 21° C. while stirring at 1,000 rpm with a dissolver type homogenizer. Then, 390 μl of a 10 wt % solution of an associated product of two molecules of N,N-dimethylacetamide/one molecule of bromic acid/one molecule of bromine in methanol was added, followed by stirring for one hour. Further, 494 μl of a 10 wt % solution of calcium bromide in methanol was added, followed by stirring for 20 minutes. Subsequently, 167 mg of a methanol solution containing 15.9% by weight of dibenzo-18-crown-6 and 4.9% by weight of potassium acetate was added, followed by stirring for 10 minutes. Then, 2.6 g of a solution of 0.12% by weight of infrared sensitizing dye A, 0.12% by weight of infrared sensitizing dye B, 18.3% by weight of 2-chlorobenzoic acid, 34.2% by weight of salicylic acid-p-toluenesulfonate and 4.5% by weight of 5-methyl-2-mercaptobenzimidazole in MEK was added, followed by stirring for one hour. Then, the temperature was lowered to 13° C., followed further stirring for 30 minutes. While maintaining the temperature at 13° C., 13.31 g of polyvinyl butyral (Butvar B-79, manufactured by Monsanto Co.) was added, followed by stirring for 30 minutes. Then, 1.08 g of a 9.4 wt % tetrachlorophthalic acid solution was added, followed by stirring for 15 minutes. With stirring, a compound of general formula (1), a compound of general formula (2) or (3) and a heteroaromatic mercapto compound were added according to Table 8.

Then, 12.4 g of a solution of 1.1% by weight of 4-methylphthalic acid and dye 1 in MEK was added. Subsequently, 1.5 g of 10 wt % Desmodur N3300 (an aliphatic isocyanate, manufactured by Mobey) was added, and 4.27 g of a solution of 7.4% by weight of tribromomethyl-2-azaphenylsulfone and 7.2% by weight of phthalazine in MEK was further added. Thus, each of coating solutions 1 to 24 for light-sensitive layers was obtained.

TABLE 8

| Photosen- | Organic | Compound of General | | Compound of General | | Mercapto |
|---|---|---|---|---|---|---|
| sitive | Silver | Formula (1) | | Formula (2) or (3) | | Compound |
| Material | Salt | Kind | mol/mol · Ag | Kind | mol/mol · Ag | mol/mol · Ag |
| 1 | A | 1-1 | 4 × 10⁻¹ | — | — | — |
| 2 | A | 1-1 | 4 × 10⁻¹ | — | — | 1 × 10⁻² |
| 3 | A | 1-1 | 4 × 10⁻¹ | 2-3 | 1.6 × 10⁻² | — |
| 4 | A | 1-1 | 4 × 10⁻¹ | 2-3 | 1.6 × 10⁻² | 1 × 10⁻² |
| 5 | B | 1-1 | 4 × 10⁻¹ | — | — | — |
| 6 | B | 1-1 | 4 × 10⁻¹ | — | — | 1 × 10⁻² |
| 7 | B | 1-1 | 4 × 10⁻¹ | 2-3 | 1.6 × 10⁻² | — |
| 8 | B | 1-1 | 4 × 10⁻¹ | 2-3 | 1.6 × 10⁻² | 1 × 10⁻² |
| 9 | C | 1-1 | 4 × 10⁻¹ | — | — | — |
| 10 | C | 1-1 | 4 × 10⁻¹ | — | — | 1 × 10⁻² |
| 11 | C | 1-1 | 4 × 10⁻¹ | 2-3 | 1.6 × 10⁻² | — |
| 12 | C | 1-1 | 4 × 10⁻¹ | 2-3 | 1.6 × 10⁻² | 1 × 10⁻² |
| 13 | A | 1-5 | 3 × 10⁻¹ | — | — | — |
| 14 | A | 1-5 | 3 × 10⁻¹ | — | — | 1 × 10⁻² |
| 15 | A | 1-5 | 3 × 10⁻¹ | 2-35 | 1.6 × 10⁻² | — |
| 16 | A | 1-5 | 3 × 10⁻¹ | 2-35 | 1.6 × 10⁻² | 1 × 10⁻² |
| 17 | B | 1-5 | 3 × 10⁻¹ | — | — | — |
| 18 | B | 1-5 | 3 × 10⁻¹ | — | — | 1 × 10⁻² |
| 19 | B | 1-5 | 3 × 10⁻¹ | 2-35 | 1.6 × 10⁻² | — |
| 20 | B | 1-5 | 3 × 10⁻¹ | 2-35 | 1.6 × 10⁻² | 1 × 10⁻² |
| 21 | C | 1-5 | 3 × 10⁻¹ | — | — | — |
| 22 | C | 1-5 | 3 × 10⁻¹ | — | — | 1 × 10⁻² |
| 23 | C | 1-5 | 3 × 10⁻¹ | 2-35 | 1.6 × 10⁻² | — |
| 24 | C | 1-5 | 3 × 10⁻¹ | 2-35 | 1.6 × 10⁻² | 1 × 10⁻² |

<Preparation of Coating Solution for Surface Protective Layer>

Cellulose acetate butyrate (CAB171-15, manufactured by Eastman Chemical) (96 g), 4.5 g of polymethyl methacrylate (Paraloid A-21, manufactured by Rohm & Haas Inc.), 1.5 g of 1,3-di(vinylsulfonyl)-2-propanol, 1.0 g of benzotriazole and a fluorine surfactant (Surflon KH40, manufactured by Asahi Glass Co., Ltd.) were added to and dissolved in 865 g of MEK with stirring. Then, 30 g of a dispersion in which 13.6% by weight of cellulose acetate butyrate (CAB171-15, manufactured by Eastman Chemical) and 9% by weight of calcium carbonate (Super-Pflex 200, manufactured by Speciality Minerals) were dispersed in MEK with a dissolver type homogenizer at 8,000 rpm for 30 hours was added, followed by stirring to prepare a coating solution for a surface protective layer.

<Preparation of Coating Solution for Protective Layer on Back Face and Coating>

Cellulose acetate butyrate (CAB381-20, manufactured by Eastman Chemical) (84.2 g) and 4.5 g of a polyester resin (Vitel PE 2200B, manufactured by Bostic) were added to and dissolved in 830 g of MEK. To this solution, 0.30 g of dye B was added, and 4.5 g of a fluorine surfactant (Surflon KH40, manufactured by Asahi Glass Co., Ltd.) dissolved in 43.2 g of methanol and 2.3 g of a fluorine surfactant (Megafac F120K, manufactured by Dainippon Ink & Chemicals, Inc.) were further added. Then, stirring was sufficiently accomplished, until they were dissolved. Finally, 75 g of silica (Siloid 64×6000, manufactured by W. R. Grace) dispersed in methyl ethyl ketone at a concentration of 1% by weight with a dissolver type homogenizer was added, followed by stirring to prepare a coating solution for a back face.

The coating solution for the back face protective layer thus prepared was extruded onto the support so as to give a dry film thickness of 3.5 μm, coated with a coater, and dried at a drying temperature of 100° C. using a drying air having a dew-point temperature of 10° C.

<Preparation of Photosensitive Materials>

According to Table 9, each of the above-mentioned coating solutions 1 to 24 for the light-sensitive layers and the coating solution for the surface protective layer were simultaneously applied in multiple layers onto the support (on the face opposite to the back face protective layer) coated with the back face protective layer, thereby preparing each of photosensitive materials 1 to 24. Coating was carried out so as to give an amount of silver coated of 1.9 g/m2 for the light-sensitive layer and a dry film thickness of 2.5 μm for the surface protective layer. Then, drying was carried out at a drying temperature of 75° C. for 10 minutes using a drying air having a dew-point temperature of 10° C.

For each photosensitive material thus obtained, the sum of the MEK content and the methanol content determined under the following conditions was taken as the solvent content. As the film area, 46.3 cm²was cut out. This was cut fine to about 5 mm, and placed in its own vial, which was sealed with a septum and an aluminum cap. Then, the vial was set in a head space sampler, type HP7694, of a gas chromatography (GC), type 5971, manufactured by Hewlett-Packard Co. A flame ionization detector (FID) was used as a detector of the GC, and a DB-624 column manufactured by J & W was used as the column. As for the main measuring conditions, the head space sampler heating conditions were 120° C. and 20 minutes, the GC introduction temperature was 150° C., and the temperature was elevated from 45° C. for 3 minutes to 100° C. at 8° C./minute. The calibration curve was prepared using the peak area of a chromatogram obtained by placing a definite amount of a solution of the above-mentioned respective solvent diluted with butanol in its own vial, and then measuring it in the same manner as described above. The solvent content of each photosensitive material was 40 mg/m².

The photosensitive material was cut out by 100 cm², and the light-sensitive layer was separated in MEK. Decomposition with sulfuric acid and nitric acid was conducted with a Microdigest Type A300 microwave wet decomposer manufactured by Prolabo, and analysis was made by the calibration curve method with a PQ-Ω type ICP-MS (inductively coupled plasma mass spectrometer) manufactured by VG Elemental. As a result, the Zr content in the photosensitive material was 10 μg or less per mg of Ag.

The compound used in the example shown below:

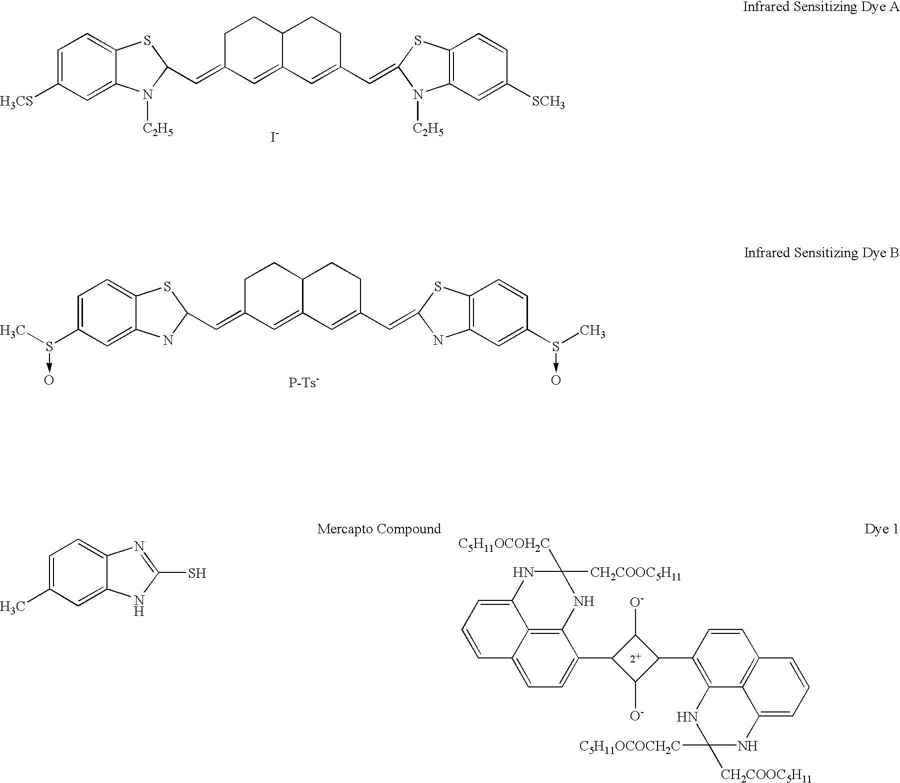

<Evaluation>

For each sample thus obtained, the following evaluations were made. Results thereof are shown in Table 9.

<Exposure and Development Processing>

A prototype exposing device using as an exposure source a semiconductor laser converted to vertical multiple modes having a wavelength of 800 nm to 820 nm by high frequency superposition, and exposure according to laser scanning was given to the photosensitive material prepared as described above, with this exposing device from the emulsion face side of the photosensitive material. In this case, the scanning laser beam was irradiated to an exposure face of the photosensitive material at an incident angle of 75 degrees to record an image. Then, using an automatic processor having a heat drum, the protective layer of the photosensitive material was brought into contact with a surface of the drum, and heat development was conducted at 124° C. for 15 seconds. The resulting image was evaluated with a densitometer. In that case, the temperature and humidity of a camber in which exposure and development were conducted were 23° C. and 50% RH.

Compared to the case that an ordinary scanning laser beam was irradiated to the exposure face of the photosensitive material at an incident angle of 90 degrees to record an image, deterioration in image quality caused by interference unevenness was less developed, and the image having unexpectedly good sharpness and contrast was obtained.

<Evaluation of Photographic Properties>

Fog

Each sample was exposed to the laser beam, and heat developed by the above-mentioned method. Then, the fog density of a non-image area was measured with a Macbeth densitometer.

Relative Sensitivity

Each sample was exposed to the laser beam, and heat developed by the above-mentioned method. The sensitivity was indicated by a relative value, taking as 100 the reciprocal of exposure giving a density of fog +1.0 for photosensitive material 5

Image Color Tone

Each sample was exposed to the laser beam, and heat developed by the above-mentioned method. A color tone of an image obtained was evaluated by sensory testing. The most preferred color tone is a pure black tone, which is ranked as 0. The case where a tincture of magenta is strongest is ranked as −3, and ranking is made as −1, −2 and −3, as a tincture of magenta becomes stronger from the pure black tone. Conversely, the case where a yellowish tint is strongest is ranked as +3, and ranking is made as +1, +2 and +3, as a yellowish tint becomes stronger from the pure black tone. Practically, it is suitable to be within the range of −1, 0 and +1.

Evaluation of Image Keeping Quality

After each sample was exposed to the laser beam and heat developed by the above-mentioned method, the sample was thoroughly irradiated with light, subjected to humidity conditioning at 70% RH for 3 hours, sealed in a bag capable of shielding light and allowed to stand in an environment of 60° C. for 72 hours. The image keeping quality was indicated by the rate of change in Dmin at this time.

TABLE 9

| | | | | | Image Keep- |
|---|---|---|---|---|---|
| | | | | | ing Quality |
| Photosen- | | | Relative | | (rate of |
| sitive | | | Sensitiv- | Color | change in |
| Material | Remark | Fog | ity | Tone | Dmin) |
| 1 | Comparison | 0.27 | 110 | 0 | 30 |
| 2 | Comparison | 0.27 | 113 | −2 | 30 |
| 3 | Comparison | 0.27 | 115 | +2 | 30 |
| 4 | Comparison | 0.27 | 118 | 0 | 30 |
| 5 | Invention | 0.19 | 100 | 0 | 8 |
| 6 | Invention | 0.19 | 103 | −1 | 8 |
| 7 | Invention | 0.19 | 105 | +1 | 8 |
| 8 | Invention | 0.19 | 108 | 0 | 8 |
| 9 | Comparison | 0.17 | 80 | 0 | 6 |
| 10 | Comparison | 0.17 | 83 | −1 | 6 |
| 11 | Comparison | 0.17 | 85 | +1 | 6 |
| 12 | Comparison | 0.17 | 88 | 0 | 6 |
| 13 | Comparison | 0.29 | 112 | 0 | 38 |
| 14 | Comparison | 0.29 | 115 | −2 | 38 |
| 15 | Comparison | 0.29 | 117 | +2 | 38 |
| 16 | Comparison | 0.29 | 120 | 0 | 38 |
| 17 | Invention | 0.20 | 102 | 0 | 10 |
| 18 | Invention | 0.20 | 106 | −1 | 10 |
| 19 | Invention | 0.20 | 108 | +1 | 10 |
| 20 | Invention | 0.20 | 110 | 0 | 10 |
| 21 | Comparison | 0.18 | 82 | 0 | 8 |
| 22 | Comparison | 0.18 | 85 | +1 | 8 |
| 23 | Comparison | 0.18 | 87 | −1 | 8 |
| 24 | Comparison | 0.18 | 90 | 0 | 8 |

The results of Table 9 show that in Examples, the relative sensitivity is within the range of 100to 110, which is considered to be desirable from the practical viewpoint, and the image color tone is within the range of −1, 0and +1, which is considered to be preferred from the practical viewpoint, even when the photographic materials are subjected to infrared sensitization. Also in the image keeping quality, the rate of change in Dmin is low, showing a good result.

On the other hand, the results also show that in Comparative Examples, any one of the photographic properties, the image color tone and the image keeping quality is out of the range considered to be preferred from the practical viewpoint.

According to the invention, there can be provided the heat-developable photosensitive materials having high sensitivity, low fog and also excellent image keeping quality.

According to the invention, there can be provided the heat-developable photosensitive material high in sensitivity, excellent in development processing stability and excellent in photo image keeping quality.

According to the invention, there can be provided the heat-developable photosensitive materials giving images good in image keeping quality and good in the color tone (approaching a pure black tone), even when subjected to infrared sensitization, and image formation methods using the same.

The entire disclosure of each and every foreign patent application from which the benefit of foreign priority has been claimed in the present application is incorporated herein by reference, as if fully set forth.

What is claimed is:

1. A heat-developable photosensitive material comprising:
a support;
a light-sensitive silver halide;
a reducing agent for a silver ion;
a binder; and
a light-insensitive organic silver salt grain,
wherein the light-insensitive organic silver salt grain contains a silver behenate in an amount of 53 mol % to 85 mol %, and the reducing agent is a compound represented by the following general formula (R): 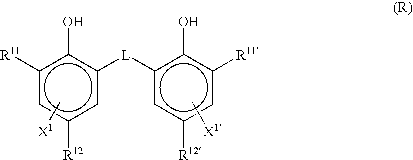
wherein R¹¹ and R¹¹′ each independently represents an alkyl group having from 1 to 20 carbon atoms; R¹² and R¹²′ each independently represents a hydrogen atom or a substituent group that can substitute on a benzenen ring; L represents an —S— group or a —CHF¹³— group; R¹³ represents a hydrogen atom or an alkyl group having from 1 to 20 carbon atoms; and X¹ and X¹′ each independently represents a hydrogen atom or a group that can substitute on a benzene ring.

2. The heat-developable photosensitive material according to claim 1, wherein in the general formula (R), R¹¹ and R¹¹′ are each independently a secondary or tertiary alkyl group having from 3 to 8 carbon atoms, R¹² and R¹²′ are each independently a an alkyl group, L is a —CHR¹³— group, R¹³ is a hydrogen atom or an alkyl group having from 1 to 12 carbon atoms, and X¹ and X¹′ are each a hydrogen atom.

3. The heat-developable photosensitive material according to claim 1, wherein in the general formula (R), R¹¹, R¹¹′, R¹² and R¹²′ are each a methyl group, L is a —CHR¹³— group, R¹³ is a secondary alkyl group having from 3 to 12 carbon atoms, and X¹ and X¹′ are each a hydrogen atom.

4. The heat-developable photosensitive material according to claim 1, wherein the light-insensitive organic silver salt grain contains a silver behenate in an amount of 55 mol % to 75 mol %.

5. The heat-developable photosensitive material according to claim 1, wherein the light-insensitive organic silver salt grain includes a light-insensitive organic silver salt grain prepared by drying in an atmosphere of an oxygen partial pressure of 15 vol % or less.

6. The heat-developable photosensitive material according to claim 1, wherein the binder includes a polyvinyl butyral in an amount of from 50% to 100% by weight.

7. A method for developing a heat-developable photosensitive material, comprising developing the heat-developable photosensitive material according to claim 1 with a heat drum type developing apparatus.

8. A method for preparing an organic silver salt, comprising preparing the light-insensitive organic silver salt grain according to claim 1 by drying in an atmosphere of an oxygen partial pressure of 15 vol % or less.

9. A heat-developable photosensitive material comprising:
a support;
a light-sensitive silver halide;
a reducing agent for a silver ion;
a binder;
a light-insensitive organic silver salt grain; and
a development accelerator,
wherein the light-insensitive organic silver salt grain contains a silver behenate in an amount of 40 mol % to 90 mol %.

10. The heat-developable photosensitive material according to claim 9, wherein the development accelerator includes at least one of compounds represented by the following general formulae (1), (2), (3) and (4):
Q¹—NHNH—R¹ General Formula (1)
wherein Q¹ represents a 5-, 6- or 7-membered unsaturated ring combining with NHNH—R¹; and R¹ represents a carbamoyl group, an acyl group, an alkoxycarbonyl group, anaryloxycarbonyl group, a sulfonyl group or a sulfamoyl group, 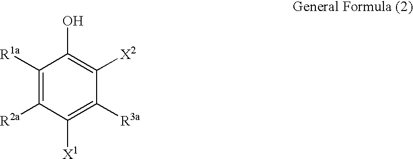
wherein R^{1a}, R^{2a}, R^{3a}, X¹ and X² each independently represents a hydrogen atom, a halogen atom or a substituent group linked by a carbon atom, an oxygen atom, a nitrogen atom, a sulfur atom or a phosphorus atom to the benzene ring, at least one of X¹ and X² is a group represented by —NR⁴R⁵, R⁴ and R⁵ are each independently a hydrogen atom, an alkyl group, an alkenyl group, an alkynyl group, an aryl group, a heterocyclic group or a group represented by —C(═O)—R, —C(═O)—C(═O)—R, —SO₂—R, —SO—R, —P(═O)(R)₂ or —C(═NR′)—R, R and R′ are each independently a group selected from the group consisting of a hydrogen atom, an alkyl group, an aryl group, a heterocyclic group, an amino group, an alkoxyl group and an aryloxy group, and these substituent groups may each combine with an adjacent group to form a ring, 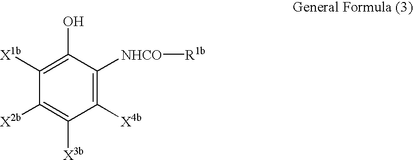
wherein X^{1b} represents a substituent group, and X^{2b} to X^{4b} each independently represents a hydrogen atom or a substituent group, X^{1b} to X^{4b} do not represent a hydroxyl group, and X^{3b} does not represent a sulfonamido group, the substituent groups represented by X^{1b} to X^{4b} may combine with each other to form a ring, R^{1b} represents a hydrogen atom, an alkyl group, an aryl group, a heterocyclic group, an amino group or an alkoxyl group, 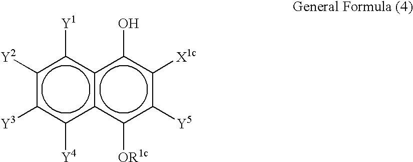
wherein R^{1c} represents an alkyl group, an aryl group, an alkenyl group or an alkynyl group, and X^{1c} represents an alkoxycarbornyl group, a carbamoyl group, a sulfonyl group or a sulfamoyl group Y¹ to Y⁵ each independently represents a hydrogen atom or a substituent group.

11. The heat-developable photosensitive material according to claim 9, wherein the binder includes a polyvinyl butyral in an amount of from 50% to 100% by weight.

12. The heat-developable photosensitive material according to claim 9, wherein the binder has the Tg of from 40° C. to 90° C.

13. A heat-developable photosensitive material comprising:
a support;
a light-sensitive silver halide;
a light-insensitive organic silver salt grain;
a reducing agent for a silver ion; and
a binder,
wherein the light-insensitive organic silver salt grain contains a silver behenate in an amount of 53 mol % to 80 mol % the reducing agent contains at least one polyphenol compound represented by the following general formula (R), and the light-sensitive silver halide is subjected to an infrared sensitization: 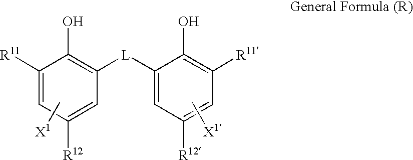
wherein R¹¹ and R¹¹′ each independently represents an alkyl group having from 1 to 20 carbon atoms; R¹² and R¹²′ each independently represents a hydrogen atom or a substituent group that can substitute on a benzene ring; L represents an —S— group or a —CHR¹³— group; R¹³ represents a hydrogen atom or an alkyl group having from 1 to 20 carbon atoms; and X¹ and X¹′ each independently represents a hydrogen atom or a group that can substitute on a benzene ring.

14. The heat-developable photosensitive material according to claim 13, wherein in the general formula (R), R¹¹ and R¹¹′ are each independently a secondary or tertiary alkyl group having from 3 to 8 carbon atoms, R¹² and R¹²′ are each independently a an alkyl group, L is a —CHR¹³— group, R¹³ is a hydrogen atom or an alkyl group having from 1 to 12 carbon atoms, and X¹ and X¹′ are each a hydrogen atom.

15. The heat-developable photosensitive material according to claim 13, wherein in the general formula (R), R¹¹, R¹¹′, R¹² and R¹²′ are each a methyl group, L is a —CHR¹³— group, R¹³ is a secondary alkyl group having from 3 to 12 carbon atoms, and X¹ and X¹′ are each a hydrogen atom.

16. The heat-developable photosensitive material according to claim 13, which comprises at least one hindered phenol compound represented by the following general formula (2) on the side containing the light-sensitive silver halide on the support, wherein the added amount ratio of the compound represented by general formula (2) to the compound represented by general formula (R): the compound represented by general formula (2) (mol)/the compound represented by general formula (R) (mol) is from 0.001 to 0.2. 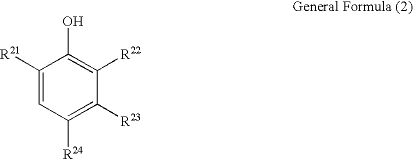
wherein R²¹ and R²² each independently represents a hydrogen atom, an alkyl group or an acylamino group, R²¹ and R²² each do not represent a 2-hydroxyphenylmethyl group, and do not represent a hydrogen atom at the same time, R²³ represents a hydrogenatom or an alkyl group, and R²⁴ represents a substituent group that can substitute on a benzene ring.

17. The heat-developable photosensitive material according to claim 13, wherein the light-insensitive organic silver salt grain contains a silver behenate in an amount of 55 mol % to 75 mol %.

18. The heat-developable photosensitive material according to claim 13, wherein the light-insensitive organic silver salt grain is a light-insensitive organic silver salt grain prepared by drying in an atmosphere of an oxygen partial pressure of 15 vol % or less.

19. The heat-developable photosensitive material according to claim 13, which comprises a light-sensitive layer containing the light-sensitive silver halide, the light-insensitive organic silver salt grain, the reducing agent for a silver ion and the binder.

20. The heat-developable photosensitive material according to claim 19, wherein the light-sensitive layer contains a polyvinyl butyral in an amount of 50% to 100% by weight based on the total content of the binder in the light-sensitive layer.

21. The heat-developable photosensitive material according to claim 13, which comprises at least one compound selected from the group consisting of a heteroaromatic mercapto compound and a heteroaromatic disulfide compound on the side containing the light-sensitive silver halide on the support.

22. An image formation method comprising: exposing the heat-developable photosensitive material according to claim 13 to a laser beam having an exposure wavelength of 750 nm to 1400 nm; and heat-developing the exposed material.

23. The image formation method according to claim 22, wherein the heat development is conducted with a heat drum.
